(19) United States
(12) Patent Application Publication
(10) Pub. No.: US 2025/0112743 A1
(43) Pub. Date: Apr. 3, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Zhihua SHI, Dongguan (CN); Zhe LIU, Dongguan (CN); Jianfei CAO, Dongguan (CN); Yun FANG, Dongguan (CN)

(21) Appl. No.: 18/981,119

(22) Filed: Dec. 13, 2024

Related U.S. Application Data
(63) Continuation of application No. PCT/CN2022/110843, filed on Aug. 8, 2023.

(51) Int. Cl. H04L 5/00; H04W 72/231; H04W 76/20

(52) U.S. Cl. CPC H04L 5/0044; H04L 5/0051; H04W 72/231; H04W 76/20

(57) ABSTRACT

A wireless communication method includes: receiving, by the terminal device, first indication information. The first indication information is used to indicate a first SRS resource set and a second SRS resource set, both the first SRS resource set and the second SRS resource set are used for a codebook based or non-codebook based PUSCH; where the first SRS resource set is associated with one of K1 TCI states, and the second SRS resource set is associated with one of the K1 TCI states; where the K1 TCI states are currently activated TCI states corresponding to uplink transmission, and K1 is a positive integer.

### CROSS-REFERENCE TO RELATED APPLICATION

This application is a Continuation Application of PCT/CN2022/110843 filed Aug. 8, 2022, which is incorporated herein by reference in its entirety.

### TECHNICAL FIELD

Embodiments of the present application relate to the field of communications, and more particular, to a wireless communication method, a terminal device, and a network device.

### BACKGROUND

In some scenarios, physical uplink shared channel (PUSCH) repeated transmission under multiple antenna panels is introduced. In this scenario, how to configure and indicate a transmission configuration indicator (TCI) is a problem to be solved.

### SUMMARY

In a first aspect, a wireless communication method is provided, which is applied to a terminal device and includes:
receiving first indication information, where the first indication information is used to indicate a first SRS resource set and a second SRS resource set, and both the first SRS resource set and the second SRS resource set are used for a codebook based or non-codebook based PUSCH;
where the first SRS resource set is associated with one of K1 TCI states, and the second SRS resource set is associated with one of the K1 TCI states;
where the K1 TCI states are currently activated TCI states corresponding to uplink transmission, and K1 is a positive integer;
in a case where K1 is greater than 1, the first SRS resource set is associated with a first TCI state of the K1 TCI states, and the second SRS resource set is associated with a second TCI state of the K1 TCI states; and/or
in a case where the K1 TCI states only include a first TCI state, the first SRS resource set and the second SRS resource set are associated with the first TCI state.

In a second aspect, a wireless communication method is provided, which is applied to a network device and includes:
transmitting first indication information, where the first indication information is used to indicate a first SRS resource set and a second SRS resource set, both the first SRS resource set and the second SRS resource set are used for a codebook based or non-codebook based PUSCH;
where the first SRS resource set is associated with one of K1 TCI states, and the second SRS resource set is associated with one of the K1 TCI states;
where the K1 TCI states are currently activated TCI states corresponding to uplink transmission, and K1 is a positive integer;
in a case where K1 is greater than 1, the first SRS resource set is associated with a first TCI state of the K1 TCI states, and the second SRS resource set is associated with a second TCI state of the K1 TCI states; and/or
in a case where the K1 TCI states only include a first TCI state, the first SRS resource set and the second SRS resource set are associated with the first TCI state.

In a third aspect, a terminal device is provided, which is configured to perform the method in the above first aspect.

Specifically, the terminal device includes a functional module configured to perform the method in the above first aspect.

In a fourth aspect, a network device is provided, which is configured to perform the method in the above second aspect.

Specifically, the network device includes a functional module configured to perform the method in the above second aspect.

In a fifth aspect, a terminal device is provided, which includes a processor and a memory. The memory is configured to store a computer program. The processor is configured to call the computer program stored in the memory and run the computer program to cause the terminal device to perform the method in the above first aspect.

In a sixth aspect, a network device is provided, which includes a processor and a memory. The memory is configured to store a computer program, and the processor is configured to call the computer program stored in the memory and run the computer program to cause the terminal device to perform the method in the above second aspect.

In a seventh aspect, an apparatus is provided, which is configured to perform the method in any one of the above first and second aspects.

Specifically, the apparatus includes a processor that is configured to call and run a computer program from the memory to cause a device equipped with the apparatus to perform the method in any one of the above first and second aspects.

In an eighth aspect, a non-transitory computer-readable storage medium is provided, which is configured to store a computer program that, when executed on a device, causes a computer to perform the method in any one of the above first and second aspects.

In a ninth aspect, a computer program product is provided, which includes computer program instructions. The computer program instructions cause a computer to perform the method in any one of the above first and second aspects.

In a tenth aspect, a computer program is provided, and the computer program instructions cause a computer to perform the method in any one of the above first and second aspects.

### BRIEF DESCRIPTION OF THE DRAWINGS

FIG. 1 is a schematic diagram illustrating a communication system architecture to which the embodiments of the present application are applied.

FIG. 2 is a schematic diagram illustrating multi-TRP transmission to which the embodiments of the present application are applied.

FIG. 3 is a schematic diagram illustrating multi-beam transmission to which the embodiments of the present application are applied.

FIG. 4 is a schematic diagram of a TCI state configuration method for PDSCH applied to the embodiments of the present application.

FIG. 5 is a schematic interaction flowchart of a wireless communication method provided according to the embodiments of the present application.

FIG. 6 is a schematic block diagram of a terminal device provided according to the embodiments of the present application.

FIG. 7 is a schematic block diagram of a network device provided according to the embodiments of the present application.

FIG. 8 is a schematic block diagram of a communication device provided according to the embodiments of the present application.

FIG. 9 is a schematic block diagram of an apparatus provided according to the embodiments of the present application.

FIG. 10 is a schematic block diagram of a communication system provided according to the embodiments of the present application.

### DETAILED DESCRIPTION

Technical solutions in the embodiments of the present application will be described below with reference to the accompanying drawings in the embodiments of the present application. Obviously, the described embodiments are only portion of the embodiments of the present application, rather than all of the embodiments. With respect to the embodiments in the present application, all other embodiments obtained by one with ordinary skills in the art shall fall within the protection scope of the present application.

The technical solutions in the embodiments of the present application may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial networks (NTN) system, a universal mobile telecommunications system (UMTS), wireless local area networks (WLAN), Internet of Things (IoT), wireless fidelity (WiFi), a 5th-generation (5G) communication system, a 6th-generation (6G) communication system, and other communication systems.

Generally speaking, traditional communication systems support a limited quantity of connections, which is easy to be implemented. However, with the development of the communication technology, mobile communication systems will not only support traditional communication, but also support, for example, device to device (D2D) communication, machine to machine (M2M) communication, machine type communication (MTC), vehicle to vehicle (V2V) communication, sidelink (SL) communication, vehicle to everything (V2X) communication or the like. The embodiments of the present application may be applied to these communication systems as well.

In some embodiments, the communication system in the embodiments of the present application may be applied to a carrier aggregation (CA) scenario, a dual connectivity (DC) scenario, and may also be applied to a standalone (SA) network deployment scenario or a non-standalone (NSA) network deployment scenario.

In some embodiments, the communication system in the embodiments of the present application may be applied to an unlicensed spectrum, which may also be considered as a shared spectrum. Alternatively, the communication system in the embodiments of the present application may be applied to a licensed spectrum, which may be considered as an unshared spectrum.

In some embodiments, the communication system in the embodiments of the present application may be applied to a FR1 band (corresponding to a frequency range of 410 MHz to 7.125 GHz), and may also be applied to a FR2 band (corresponding to a frequency range of 24.25 GHz to 52.6 GHz), and may also be applied to a new band such as a high-frequency band corresponding to a frequency range of 52.6 GHz to 71 GHz or 71 GHz to 114.25 GHz.

In the embodiments of the present application, each embodiment will be described in the perspective of a network device and a terminal device. The terminal device may be referred to as a user equipment (UE), an access terminal, a user unit, a user station, a mobile station, a mobile console, a remote station, a remote terminal, a mobile device, a user terminal, a terminal, a wireless communication device, a user agent, a user apparatus, or the like.

The terminal device may be a station (ST) in the WLAN, or may be a cellular phone, a cordless phone, a session initiation protocol (SIP) phone, a wireless local loop (WLL) station, a personal digital assistant (PDA) device, a handheld device with wireless communication functions, a computing device or another processing device connected to a wireless modem, an in-vehicle device, a wearable device, a terminal device in a next generation communication system (e.g., an NR network), a terminal device in a future evolved public land mobile network (PLMN) network, or the like.

In the embodiments of the present application, the terminal device may be deployed on land including indoor or outdoor, handheld, wearable, or in-vehicle; alternatively, the terminal device may be deployed on water (e.g., on a steamship); alternatively, the terminal device may be deployed in air (e.g., on an airplane, on a balloons, or on a satellite).

In the embodiments of the present application, the terminal device may be a mobile phone, a pad, a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, an in-vehicle communication device, a wireless communication chip/application specific integrated circuit (ASIC)/system on chip (SoC), or the like.

As an example but not a limitation, in the embodiments of the present application, the terminal device may be a wearable device. The wearable device may be referred to as a wearable smart device, which is a general term of wearable devices developed by intelligent design and development on daily wear by applying wearable technology, such as glasses, gloves, watches, clothing and shoes. The wearable device is a portable device that is worn directly on a body, or integrated into clothes or accessories of users. The wearable device not only is a hardware device, but also implements powerful functions through software supporting as well as data interaction or cloud interaction. Generalized wearable smart devices includes devices that are fully functional, large in size, and may implement full or partial functions without relying on smart phones, such as a smart watch or smart glasses, as well as devices that only focus on a certain type of application functions and need to be used in conjunction with other devices (e.g., smart phones), such as various smart bracelets and smart jewelry that are used for monitoring physical signs.

In the embodiments of the present application, the network device may be a device used for communicating with a mobile device. The network device may be an access point (AP) in WLAN, a base transceiver station (BTS) in GSM or CDMA, or may also be a NodeB (NB) in WCDMA, or may also be an evolutional Node B (eNB or eNodeB) in LTE, a relay station or an access point, a in-vehicle device, a wearable device, a network device or a base station (gNB) or a transmission reception point (TRP) in an NR network, a network device in a future evolved public land mobile network (PLMN) network, a network device in an NTN network, or the like.

As an example but not a limitation, in the embodiments of the present application, the network device may have mobile characteristics. For example, the network device may be a mobile device. In some embodiments, the network device may be a satellite, or a balloon station. For example, the satellite may be a low earth orbit (LEO) satellite, a medium earth orbit (MEO) satellite, a geostationary earth orbit (GEO) satellite, or a high elliptical orbit (HEO) satellite. In some embodiments, the network device may also be a base station deployed on land, water, or other places.

In the embodiments of the present application, the network device can provide services for a cell, and the terminal device communicates with the network device through a transmission resource (e.g., a frequency-domain resource, or in other words, a spectrum resource) used by the cell. The cell may be a cell corresponding to the network device (e.g., a base station), and the cell may belong to a macro base station, or may belong to a base station corresponding to a small cell. The small cell here may include a metro cell, a micro cell, a pico cell, or a femto cell, or the like. These small cells have characteristics of small coverage range and low transmission power, which are applicable for providing a data transmission service with high speed.

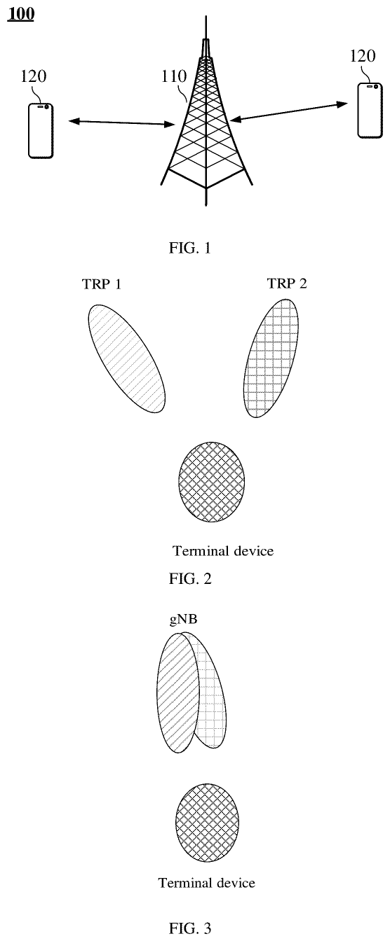

For example, a communication system 100 to which the embodiments of the present application are applied is shown in FIG. 1. The communication system 100 may include a network device 110, the network device 110 may be a device for communicating with a terminal device 120 (also referred to as a communication terminal or a terminal). The network device 110 may provide communication coverage for a specific geographical area and may communicate with terminal devices located within the coverage area.

FIG. 1 exemplarily shows a network device and two terminal devices. In some embodiments, the communication system 100 may include multiple network devices, and each of which may have a coverage area within which other number of terminal devices are located, which is not limited in the embodiments of the present application.

In some embodiments, the communication system 100 may further include other network entities such as a network controller and a mobility management entity, which are not limited in the embodiments of the present application.

It should be understood that, in the embodiments of the present application, a device with communication functions in a network/system may be referred to as a communication device. Taking the communication system 100 shown in FIG. 1 as an example, the communication device may include a network device 110 with communication functions and a terminal device 120 with communication functions. The network device 110 and the terminal device 120 may be the specific devices as described above, which will not be repeated here. The communication device may further include other devices in the communication system 100, such as a network controller, a mobility management entity, and other network entities, which are not limited in the embodiments of the present application.

It should be understood that the terms “system” and “network” are often used interchangeably herein. The term “and/or” herein is only an association relationship to describe associated objects, which indicates that there may be three kinds of relationships. For example, “A and/or B” may represent: A exists alone, both A and B exist, and B exists alone. In addition, a character “/” herein generally indicates that related objects before and after the character “/” are in an “or” relationship.

It should be understood that a first communication device and a second communication device are involved herein. The first communication device may be a terminal device, such as a mobile phone, a machine facility, a customer premise equipment (CPE), a industrial equipment, or a vehicle. The second communication device may be a peer communication device of the first communication device, such as a network device, a mobile phone, an industrial equipment, or a vehicle. In the embodiments of the present application, the first communication device may be a terminal device, and the second communication device may be a network device (i.e., uplink communication or downlink communication); alternatively, the first communication device may be a first terminal, and the second communication device may be a second terminal (i.e., sidelink communication).

Terms used in the implementation section of the present application are only used to explain specific embodiments of the present application and are not intended to limit the present application. The terms such as “first”, “second”, “third”, and “fourth” in the specification, claims and drawings of the present application are used to distinguish different objects rather than to describe a specific order. In addition, the terms “include,” “comprise,” and “have,” and any variations thereof, are intended to cover a non-exclusive inclusion.

It should be understood that, “indicate” mentioned in the embodiments of the present application may mean a direct indication or an indirect indication, or represent that there is an association relationship. For example, A indicating B may mean that A directly indicates B, for example, B may be obtained through A; alternatively, A indicating B may mean that A indirectly indicates B, for example, A indicates C, and B may be obtained through C; alternatively, A indicating B may mean that there is an association relationship between A and B.

In the description of the embodiments of the present application, the term “correspond” may mean that there is a direct correspondence or an indirect correspondence between two elements, or may mean that there is an association between two elements, or may mean a relationship of indicating and being indicated, or configuring and being configured, or the like.

In the embodiment of the present application, “pre-defined” or “pre-configured” may be achieved by pre-storing corresponding codes, tables or other modes that may be used to indicate relevant information in a device (e.g., including a terminal device and a network device), and its specific implementation is not limited in the present application. For example, “pre-defined” may refer to that defined in the protocol.

In the embodiments of the present application, the term “protocol” may refer to a standard protocol in the field of communication, for example, “protocol” may be an evolution of an existing LTE protocol, a NR protocol, a Wi-Fi protocol, or a protocol related to other communication systems, which are not be limited in the present application.

To facilitate understanding of the technical solutions of the embodiments of the present application, the technical solutions of the present application will be described in detail below through specific embodiments. The following relevant technologies, as optional solutions, may be arbitrarily combined with the technical solutions of the embodiments of the present application, and those combined solutions all fall within the protection scope of the embodiments of the present application. The embodiments of the present application include at least part of the following contents.

To facilitate a better understanding of the embodiments of the present application, a multi-beam system involved in the present application will be described.

A design goal of a NR system or a 5G system is large bandwidth communication over a high-band (e.g., bands above 6 GHz). In a case where operating frequency becomes higher, a path loss generated during the transmission will increase, which affects coverage capability of a high-frequency system. In order to effectively ensure coverage of a high-frequency band NR system, an effective technical solution is to use multiple beams (or hybrid beams) technology based on massive antenna arrays (e.g., multiple inputs multiple outputs, MIMO) to improve the coverage capability.

In a typical system, a wider beam is used in a cell (sector) to cover the entire cell. Therefore, at any time, a UE located within the coverage area of the cell always has an opportunity to obtain transmission resources allocated by the system.

A multi-beam system of the NR system or the 5G system covers an entire cell with different beams, that is, each beam covers a small area, and time sweeping can be used to achieve an effect of multiple beams covering the entire cell. Currently, different beams are identified through different signals carried by the different beams.

Some of the different beams are used to transmit different synchronization signal blocks (SSB), and the UE may identify different beams through the different SSBs. The SSBs may also be called synchronization signal/physical broadcast channel blocks (SS/PBCH blocks).

Some of the different beams are used to transmit different channel state information reference signals (CSI-RS), and the UE identifies different beams through the CSI-RS signals/CSI-RS resources.

In a multi-beam system, a physical downlink control channel (PDCCH) and the physical downlink shared channel (PDSCH) may be transmitted through different downlink transmit beams.

For systems below 6G, at the UE side, there is generally no analog beam, so an omnidirectional antenna (or a nearly omnidirectional antenna) is used to receive signals transmitted by a base station through different downlink transmit beams.

For a millimeter wave system, at the UE side, there may be an analog beam, and a corresponding downlink receive beam is required to receive a signal transmitted by a corresponding downlink transmit beam. In this case, corresponding beam indication information is required to assist the UE to determine transmit beam related information at the network side or receive beam related information corresponding to the UE side.

In a NR protocol, beam indication information does not directly indicate a beam itself, but rather indicates a quasi-co-located (QCL) type between signals (e.g., QCL type D (QCL-TypeD)). At the UE side, the decision to receive a corresponding channel/signal is also based on a QCL quasi-co-location assumption. The QCL quasi-co-location assumption is indicated through a TCI state (TCI-state), that is, the network configures and/or indicates the corresponding transmission configuration indicator (TCI) state through relevant signaling (such as radio resource control (RRC), and/or a media access control control element (MAC CE), and/or downlink control information (DCI)).

To facilitate a better understanding of the embodiments of the present application, multi-transmission reception point (TRP)/antenna panel/beam transmission involved in the present application will be explained.

The multi-TRP (mTRP or M-TRP) transmission refers to that multiple TRPs may communicate with a terminal simultaneously on the same carrier. In a NR system, the multiple TRPs, multiple panels or multiple beams may adopt the same scheme to perform transmission with one terminal simultaneously, so descriptions related to them are often not distinguished (e.g., referred to as a multi-TRP transmission, a mTRP transmission, or a M-TRP transmission), which may be expressed as the multi-TRP/panel/beam transmission.

The following two types of solutions are included in solutions for multiple TRPs or multiple antenna panels or multiple beams to transmit downlink data to a UE simultaneously:

Solution 1: single-PDCCH based scheme, in this solution, the UE detects only one PDCCH, and DCI detected in the control channel PDCCH indicates indication information relevant to data transmitted simultaneously by multiple TRPs/panels/beams (in the perspective of the protocol layer, the multiple TRPs/panels/beams are not reflected, but only that one transmission needs to correspond to multiple TCI-states is reflected. That is, the multi-TRP/panel/beam transmission is implicitly supported through the multiple TCI-states).

Solution 2: multiple-PDCCH based scheme, in this solution, the UE receives different PDCCHs from different TRPs/panels/beams, and DCI detected on each control channel PDCCH indicates indication information relevant to a corresponding data transmission (in the perspective of the protocol layer, the multiple TRPs/panels/beams are not reflected, but only that a control resource set (CORESET) corresponding to DCI for scheduling data may be associated to different CORESET pool indexes, that is, corresponds to different CORESET pool indexes. That is, the multi-TRP/panel/beam transmission is implicitly supported through multiple different CORESET pool indexes).

Specifically, a multi-TRP transmission may be shown in FIG. 2, and a multi-beam transmission may be shown in FIG. 3.

For Solution 1, the UE only needs to detect one PDCCH, so complexity of detecting control channel may be lower than that of Solution 2. Solution 1 requires fast information exchange between different panels/TRPs/beams.

For Solution 2, the UE needs to detect multiple PDCCHs on the same carrier simultaneously, which may increase complexity, but flexibility and robustness may be improved.

Possible application scenarios of Solution 2 include at least one of the following:
S1-1: multiple TRPs belong to the same cell, and connection (backhaul) between TRPs is ideal (i.e., TRPs are capable of performing fast and dynamic information exchange);
S1-2: the multiple TRPs belong to the same cell, and the connection (backhaul) between the TRPs is non-ideal (i.e., the TRPs cannot exchange information quickly and only can perform relatively slow data exchange);
S1-3: the multiple TRPs belong to different cells, and the connection (backhaul) between the TRPs is ideal;
S1-4: the multiple TRPs belong to different cells, and the connection (backhaul) between the TRPs is not ideal;
S2-1, S2-2, S2-3, S2-4: if the TRPs in the above scenarios are replaced with beams, four corresponding multi-beam application scenarios are obtained.

Solution 1 is generally considered to be only applicable to ideal backhaul scenarios (i.e., S1-1 and S1-3).

In release 16 (R16), a multi-TRP transmission of downlink data transmission is supported. In release 17 (R17), a multi-TRPs transmission of physical downlink control channel (PDCCH), physical uplink shared channel (PUSCH), and physical uplink control channel (PUCCH) is supported to increase transmission reliability of corresponding channels.

In order to match the channel states of different TRPs, the sounding reference signal (SRS) resources and the precoding matrixes for codebook transmission used to transmit PUSCHs to two TRPs may be different. Therefore, single DCI scheduling (for PUSCHs dynamically scheduled by DCI) supports that one DCI indicates two SRS resource indicators (SRIs)/transmit precoding matrix indicators (TPMIs), that is, the PUSCHs corresponding to the two TRPs are indicated through two independent SRI domains and two independent TPMI domains.

Different from the dynamically scheduled PUSCH (e.g., in each transmission, the PUSCH is dynamically scheduled by the DCI), some parameters for transmitting a configured grant (CG) PUSCH (that is, no dynamic scheduling is required, and no DCI is required for dynamic scheduling) are configured by RRC signaling, rather than dynamically indicated by the DCI. NR supports a Type1 CG PUSCH (CG Type1 PUSCH) and a Type2 CG PUSCH (CG Type2 PUSCH). For the Type1 CG PUSCH, all the parameters required for transmitting the PUSCH are semi-statically configured by RRC, which include time-frequency domain resources, a demodulation reference signal (DMRS), open-loop power control, and a modulation and coding scheme (MCS). For the Type2 CG PUSCH, RRC is used to configure a portion of semi-static parameters including a period of time domain resources, power control, a repetition number, and one DCI is used to activate time-frequency resources, a DMRS, a MCS and other parameters which are also indicated in the same DCI. In R17, the two types of CG PUSCHs are enhanced based on multiple TRPs. R17 specifies that a set of P0-PUSCH-Alpha and power control loop to use (powerControlLoopToUse) are added to the CG configuration (ConfiguredGrantConfig) for power control of the second TRP. For Type2 CG PUSCH, R17 specifies that the original first set of power control values are associated with a first SRS resource set, and that a second set of power control values are associated with a second SRS resource set. Whether to use the first set of power control, the second set of power control, or both the first set of power control and the second set of power control depends on a newly added 2-bit field in the DCI, which is used to indicate dynamic switch between single TRP and multiple TRPs. For the Type1 CG PUSCH, a set of fields including a path loss reference index (pathlossReferenceIndex) field, an SRS resource indicator (srs-ResourceIndicator) field, and a precoding and number of layers (precodingAndNumberOfLayers) field is added to RRC configured uplink grant (rrc-ConfiguredUplinkGrant) to indicate a path loss reference signal, an SRI and a TPMI that are corresponding to the second TRP. It should be noted that, unlike DCI signaling which has a high overhead requirement, the RRC signaling has a relatively low overhead requirement. Therefore, the srs-ResourceIndicator field and precodingAndNumberOfLayers field that are associated with the second SRS resource set and indicated by RRC occupy the same number of bits as the srs-ResourceIndicator field and precodingAndNumberOfLayers field that are associated with the first SRS resource set.

It should be noted that configured grant (CG) may also be referred to as schedule free or dynamic schedule free.

It should be noted that for the multiple TRPs system, transmission schemes discussed above are aimed at the same carrier case. For example, for the multiple-PDCCH based scheme, the terminal detects multiple DCIs on the same carrier (the existing protocol supports two DCIs), each DCI may schedule a corresponding PDSCH, and multiple PDSCHs are also on the same carrier or cell. Similarly, multi-TRP transmission in the uplink is aimed at transmissions on the same carrier.

In order to facilitate a better understanding of the embodiments of the present application, TCI states involved in the present application will be explained.

When the terminal receives a signal, the terminal may improve a reception algorithm based on characteristics of the transmission environment corresponding to data transmission to improve reception performance. For example, a statistical characteristic of a channel may be used to optimize the design and parameters of a channel estimator. In the NR system, the characteristics corresponding to data transmission are represented by Quasi-co-located (QCL) information (QCL-Info).

If downlink transmissions comes from different TRPs/panels/beams, the characteristics of the transmission environment corresponding to data transmission may also change. Therefore, in the NR system, in a case where the network side transmits a downlink control channel or a data channel, the network side will indicate the corresponding QCL state information to the terminal through the TCI state.

A TCI state may include the following configurations:
a TCI state identity (Identity, ID) used to identify the TCI state;
QCL information 1;
QCL information 2 (optional).

One QCL information includes the following information:
QCL type configuration, which may be one of QCL type A, QCL type B, QCL type C, and QCL type D;
QCL reference signal configuration including a cell ID where a reference signal is located, a bandwidth part (BWP) ID, and a reference signal identifier (which may be a CSI-RS resource ID or a SSB index).

If the QCL information 1 and the QCL information 2 are both configured, the QCL type of at least one QCL information must be one of typeA, typeB and typeC, and the QCL type of the other QCL information (if configured) must be QCL type D.

Configurations of different QCL types are defined as follows:
‘QCL-TypeA’: {Doppler shift, Doppler spread, average delay, delay spread};
‘QCL-TypeB’: {Doppler shift, Doppler spread};
‘QCL-TypeC’: {Doppler shift, average delay};
‘QCL-TypeD’: {spatial rx parameter}.

Specifically, for example, semantic fields of the TCI state may be described as follows:

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, |

```
-- Need R
    ...
  }
```

| QCL-Info ::= | SEQUENCE { | |
|---|---|---|
| cell | ServCellIndex | OPTIONAL, -- |

Need R

| | | |
|---|---|---|
| bwp-Id | BWP-Id | OPTIONAL, |

-- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, |

```
typeD},
    ...
  }
```

In the NR system, the network side may indicate a corresponding TCI state for a downlink signal or a downlink channel.

If the network side configures a QCL reference signal of a target downlink channel or a target downlink signal as a reference SSB or a reference CSI-RS resource through the TCI state, and the QCL type is configured as typeA, typeB or typeC, the terminal may assume that a large-scale parameter of the target downlink signal is the same as that of the reference SSB or the reference CSI-RS resource, and the large-scale parameter is determined according to the QCL type configuration.

Similarly, if the network side configures the QCL reference signal of the target downlink channel or the target downlink signal as the reference SSB or the reference CSI-RS resource through the TCI state, and the QCL type is configured as type D, the terminal may use the same reception beam (i.e., the spatial rx parameter) as that for receiving the reference SSB or reference CSI-RS resource to receive the target downlink signal. Typically, at the network side, the target downlink channel (or downlink signal) and its reference SSB or reference CSI-RS resource are transmitted by the same TRP, panel or beam. If transmission TRPs, transmission panels or transmission beams of two downlink signals or downlink channels are different, different TCI states are usually configured.

For a downlink control channel, RRC signaling or RRC signaling+MAC signaling may be used to indicate the TCI state of the corresponding CORESET.

For a downlink data channel, an available TCI state set is indicated through the RRC signaling, a portion of TCI states in the set are activated by media access control (MAC) layer signaling, and finally, a TCI state indication field in DCI indicates one or two TCI states from these activated TCI states, which will be used for the PDSCH scheduled by the DCI. The two-TCI state case is mainly aimed at scenarios similar to multiple TRPs. Specifically, for example, as shown in FIG. 4, the network device indicates N candidate TCI states through the RRC signaling, activates K TCI states through the MAC signaling, and finally indicates 1 or 2 TCI states to use from the activated TCI states through the TCI state indication field in the DCI.

To facilitate a better understanding of the embodiments of the present application, a unified TCI state involved in the present application will be described.

The indication mechanism of TCI state is only applicable to downlink channels and downlink signals and has many limitations when applied to the NR system. In order to provide a more unified uplink and downlink beam management mechanism to the NR system, the unified TCI state concept is proposed, and its newly added important functions are listed as follows:
two unified TCI state modes are designed, namely Mode 1 and Mode 2 in below;
a downlink channel (a portion of PDCCH, PDSCH) and a downlink signal (aperiodic CSI-RS) use the same downlink transmit indicator beam and use a downlink TCI state or a joint TCI state. This type of TCI state is referred to as a separate TCI state;
an uplink channel (e.g., PUCCH or PUSCH) and an uplink signal (e.g., SRS) use the same uplink transmit beam and use an uplink TCI state (UL TCI state) or the joint TCI state;
a unified TCI state may be dynamically updated and indicated by using a MAC CE and/or DCI;
applicable to a carrier aggregation scenario, and beam indication on a single component carrier (CC) may be applied to multiple different CCs;
uplink beam indication may be given together with uplink power control parameters through a UL TCI state or a joint TCI state;
a inter-cell beam management function is supported.

Mode 1: including one type of TCI state, which may be applied to uplink and downlink channels and signals and is referred to as the joint TCI state.

Mode 2: including two types of TCI states, which are the DL TCI state only applicable to downlink channels and signals and the UL TCI state only applicable to uplink channels and signals.

CORESETs on each CC may be roughly categorized into the following four types:
CORESET A: only associated with an UE-specific search space. Therefore, the CORESET A may be considered as an UE-specific downlink control channel resource and must follow an indicated unified TCI state.
CORESET B: only associated with a common search space of a cell. Whether the CORESET B can follow the unified TCI state indicated by NW depends on the RRC configuration of the network device.
CORESET C: associated with the UE-specific search space and a common search space of a cell. Whether the CORESET C can follow a unified TCI state indicated by the network device depends on the RRC configuration of the network device.
CORESET 0: which must be associated with a common search space of a cell and may be further associated with the UE-specific search space. Whether CORESET 0 can follow a unified TCI state indicated by the network device depends on the RRC configuration of the network device.

At present, in the unified TCI state mechanism, the multi-TRP transmission scenario is not considered, and only the single TRP scenario is supported.

It should be noted that when a TCI state is mentioned in below without specifying the specific type of the TCI state, the TCI state may be any TCI state mentioned in the foregoing. That is, the TCI state may be the joint TCI state, the separate TCI state, the DL TCI state, the UL TCI state or a combination thereof (i.e., including multiple different types of TCI states). If RRC parameter “TCI-State” (with a hyphen between the two words) is mentioned, the TCI state generally refers to the DL TCI state and/or the joint TCI state. If RRC parameter “downlink or joint TCI state (DLorJointTCIState)” is mentioned, the TCI state generally refers to the DL TCI state and/or the joint TCI state. If RRC parameter “uplink TCI state (UL-TCIState or TCI-UL-State or UL-TCI-State)” is mentioned, the TCI state generally refers to the uplink TCI state and/or the joint TCI state.

In order to facilitate a better understanding of the embodiments of the present application, the problem solved by the present application will be explained.

For PUSCH repetition in the multi-TRP transmission system, there is still a lack of complete solutions and specific details on how to configure and indicate the unified TCI state.

In the light of the above problem, the present application proposes a solution for configuring or indicating unified TCI state, and particularly provides a solution for configuring, indicating and determining a unified TCI state for the PUSCH transmission scheme in the multi-transmission reception point (M-TRP)/antenna panel/beam transmission scenario.

The technical solution of the present application will be described in detail through specific embodiments below.

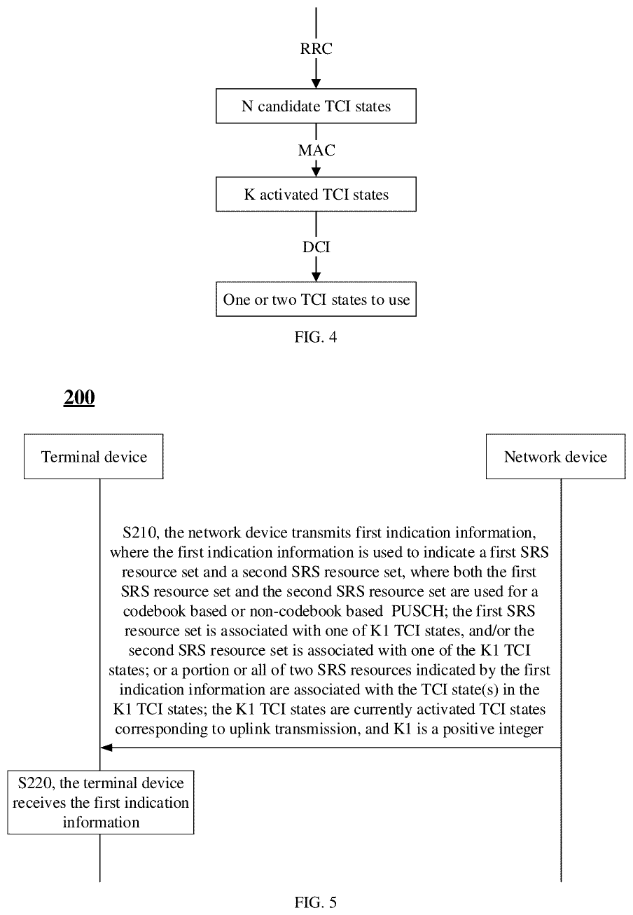

FIG. 5 is a schematic flowchart of a wireless communication method 200 according to the embodiments of the present application. As shown in FIG. 5, the wireless communication method 200 may include at least part of the following contents.

In S210, a network device transmits first indication information, which is used to indicate a first SRS resource set and a second SRS resource set. Both the first SRS resource set and the second SRS resource set are used for a codebook based (codebook-based) or non-codebook based (non-codebook-based) PUSCH. The first SRS resource set is associated with one of K1 TCI states, and/or the second SRS resource set is associated with one of the K1 TCI states. Alternatively, a portion or all of two SRS resources indicated by the first indication information are associated with the TCI state(s) in the K1 TCI states, and the K1 TCI states are currently activated TCI states corresponding to uplink transmission, where K1 is a positive integer.

In S220, a terminal device receives the first indication information.

In the embodiments of the present application, the first SRS resource set is associated with one of K1 TCI states, and/or the second SRS resource set is associated with one of the K1 TCI states. That is, the embodiments of the present application clarify TCI state(s) associated with the first SRS resource set and/or the second SRS resource set, thus an uplink transmit spatial filter or a spatial relation corresponding to a PUSCH associated with the first SRS resource set may be determined based on the first SRS resource set and the TCI state associated with the first SRS resource, and/or an uplink transmit spatial filter or a spatial relation corresponding to a PUSCH associated with the second SRS resource set may be determined based on the second SRS resource set and the TCI state associated with the second SRS resource. Alternatively, in the embodiments of the present application, a portion or all of the two SRS resources are associated with TCI state(s) in the K1 TCI states, in other words, the embodiments of the present application clarify an association between a portion or all of the two SRS resources and TCI state(s), so that an uplink transmit spatial filter or a spatial relation corresponding to a PUSCH associated with an SRS resource may be determined based on the SRS resource and a TCI state associated with the SRS resource.

In the embodiments of the present application, K1 TCI states are currently activated (active or activated) TCI states corresponding to the uplink transmission, or may also be expressed as that K1 TCI states are currently applied TCI states corresponding to the uplink transmission.

In some embodiments, for the terminal device, the K1 TCI states are used to determine the uplink transmission; and for the network device, the K1 TCI states are used to indicate the uplink transmission.

In some embodiments, TCI state(s) in the K1 TCI states are joint TCI state(s), or TCI state(s) in the K1 TCI states are uplink TCI state(s).

In some embodiments, the TCI state described in the embodiments of the present application is the unified TCI state. Specifically, the network device may indicate that a type of the unified TCI state is the joint TCI state through one piece of indication information, that is, the TCI state(s) in the K1 TCI states are the joint TCI state(s). Alternatively, the network device may specifically indicate that the type of the unified TCI state is the separate TCI state through one piece of indication information, that is, the TCI state(s) in the K1 TCI states are the uplink TCI state(s) (UL TCI states).

In some embodiments, the first indication information may be carried by one of the following: RRC signaling, DCI signaling, and MAC CE signaling.

In some embodiments, the first indication information is used to indicate the first SRS resource set and the second SRS resource set. In other words, the first indication information is used to indicate two SRS resource sets. For example, the one with the smaller SRS resource set ID among the two SRS resource sets is defined as the first SRS resource set, and the one with the larger SRS resource set ID is defined as the second SRS resource set. As another example, the one with the larger SRS resource set ID among the two SRS resource sets is defined as the first SRS resource set, and the one with the smaller SRS resource set ID is defined as the second SRS resource set.

In some embodiments, the first SRS resource set and the second SRS resource set are both used for a codebook based or non-codebook based PUSCH. In other words, the usage of the two SRS resource sets indicated by the first indication information is for the codebook based PUSCH, or the usage of the two SRS resource sets indicated by the first indication information is for the non-codebook based PUSCH. That is, the RRC parameters “usage” of SRS-ResourceSet in the configuration information of the two SRS resource sets indicated by the first indication information are both set to “codebook” or “nonCodebook”.

In some embodiments, the first SRS resource set and the second SRS resource set are configured by an RRC parameter, and the RRC parameter is SRS resource set to add or modify a list (srs-ResourceSetToAddModList) or SRS resource set to add or modify a list DCI-0-2 (srs-ResourceSetToAddModListDCI-0-2).

In some embodiments, configuration information of the first SRS resource set indicates a followed unified TCI state, and configuration information of the second SRS resource set indicates a followed unified TCI state.

Specifically, for example, a first parameter or a second parameter is configured by configuration signaling corresponding to the first SRS resource set; alternatively, the first parameter in the configuration signaling corresponding to the first SRS resource set is enabled; alternatively, the second parameter in the configuration signaling corresponding to the first SRS resource set is enabled. The first parameter is an SRS following a unified TCI state (followUnifiedTCIstateSRS), the second parameter is the followed unified TCI state (followUnifiedTCIstate).

Specifically, for example, a first parameter or a second parameter is configured by configuration signaling corresponding to the second SRS resource set; alternatively, the first parameter in the configuration signaling corresponding to the second SRS resource set is enabled; alternatively, the second parameter in the configuration signaling corresponding to the second SRS resource set is enabled. The first parameter is an SRS following a unified TCI state (followUnifiedTCIstateSRS), the second parameter is the followed unified TCI state (followUnifiedTCIstate).

For example, the enabled semantic field of the followUnifiedTCIstateSRS may be as follows:
followUnifiedTCIstateSRS-r17 ENUMERATED {enabled}.

In some embodiments, in a case where the first SRS resource set is associated with one of the K1 TCI states, and/or the second SRS resource set is associated with one of the K1 TCI states, and K1 is greater than 1 (K1>1), the first SRS resource set is associated with a first TCI state of the K1 TCI states, and the second SRS resource set is associated with a second TCI state of the K1 TCI states. That is, in the case where K1 is greater than 1 (K1>1), the first SRS resource set is associated with the first TCI state, and the second SRS resource set is associated with the second TCI state.

In some embodiments, in a case where the first SRS resource set is associated with one of the K1 TCI states, and/or the second SRS resource set is associated with one of the K1 TCI states, and the K1 TCI states only include a first TCI state, the first SRS resource set and the second SRS resource set are associated with the first TCI state; or the first SRS resource set is associated with the first TCI state, and the second SRS resource set is not associated with any TCI state. That is, in a case where K1 is equal to 1 (K1=1), both the first SRS resource set and the second SRS resource set are associated with the first TCI state, or the first SRS resource set is associated with the first TCI state, and the second SRS resource set is not associated with any TCI state.

In some embodiments, in a case where a portion or all of the two SRS resources indicated by the first indication information are associated with TCI state(s) in the K1 TCI states and K1 is greater than 1 (K1>1), one of the two SRS resources is associated with one TCI state in the K1 TCI states, and another of the two SRS resources is associated with another TCI state in the K1 TCI states.

In some embodiments, in a case where a portion or all of the two SRS resources indicated by the first indication information are associated with TCI state(s) in the K1 TCI states and K1 is equal to 1 (K1=1), the two SRS resources are associated with the TCI state in the K1 TCI states, or one of the two SRS resources is associated with a TCI state in the K1 TCI states and another of the two SRS resources is not associated with any TCI state.

In some embodiments, one of the two SRS resources belongs to the first SRS resource set, and the other of the two SRS resources belongs to the second SRS resource set.

Optionally, as Example 1, the terminal device receives seventh indication information transmitted by the network device, and the seventh indication information may be used to indicate that the unified TCI state type is a joint TCI state. Specifically, the joint TCI state may be applied to uplink operation (UL operation) or uplink transmission (UL transmission), and may also be applied to downlink operation (DL operation) or downlink transmission/reception (DL transmission/reception). Optionally, the seventh indication information is indicated by RRC information element (IE) parameter “unified TCI state type (unifiedTCI-StateType)”, which has a value “Joint”. Optionally, the seventh indication information is configured for a serving cell. Optionally, the seventh indication information is indicated in RRC information element (IE) parameter “serving cell configuration (ServingCellConfig)”.

Optionally, as Example 1, the terminal device receives eighth indication information transmitted by the network device, and the eighth indication information is used to configure or indicate a set of TCI states (for convenience of description, denoted as a first TCI state set) including a plurality of TCI states. Optionally, the first TCI state set may be used for the uplink operation or the uplink transmission, or may be used for the downlink operation or the downlink transmission. Optionally, the eighth indication information is configured through an RRC parameter. Optionally, the eighth indication information is configured by RRC information element (IE) parameter “PDSCH configuration (PDSCH-Config)”. Optionally, the eighth indication information is indicated by RRC information element (IE) parameter “downlink or joint TCI state list (dl-OrJoint-TCIStateList)”.

Optionally, as Example 2, the terminal device receives seventh indication information transmitted by the network device, and the seventh indication information may be used to indicate that the unified TCI state type is a separate TCI state. Specifically, an uplink TCI state may be used for the uplink operation (UL operation) or the uplink transmission (UL transmission), and a downlink TCI state may be used for the downlink operation (DL operation) or the downlink transmission/reception (DL transmission/reception). Optionally, the seventh indication information is indicated by RRC information element (IE) parameter “unified TCI state type (unifiedTCI-StateType)”, which has a value “separate”. Optionally, the seventh indication information is configured for a serving cell. Optionally, the seventh indication information is indicated by RRC information element (IE) parameter “serving cell configuration (ServingCellConfig)”.

Optionally, as Example 2, the terminal device receives ninth indication information transmitted by the network device, and the ninth indication information is used to configure or indicate a second TCI state set including one or more DL TCI states. Optionally, the second TCI state set is applied to the downlink operation or the downlink transmission. Optionally, the ninth indication information is configured by an RRC parameter. Optionally, the ninth indication information is configured by RRC information element (IE) parameter “PDSCH configuration (PDSCH-Config)”. Optionally, the ninth indication information is configured by RRC information element (IE) parameter “downlink or joint TCI state list (dl-OrJoint-TCIStateList)”.

Optionally, as Example 2, the terminal device receives tenth indication information transmitted by the network device, and the tenth indication information is used to configure or indicate a third TCI state set including one or more UL TCI states. Optionally, the third UL TCI state set is applied to the uplink operation or the uplink transmission. Optionally, the tenth indication information is configured by an RRC parameter. Optionally, the tenth indication information is configured by RRC IE parameter “target uplink BWP (BWP-UplinkDedicated)”. Optionally, the tenth indication information is indicated in RRC IE parameter “uplink TCI to add or modify list (ul-TCI-ToAddModList)”.

In some embodiments, the terminal device receives second indication information transmitted by the network device. The second indication information is indication information that is transmitted by the network device to at least indicate or activate the TCI states.

In some embodiments, the second indication information is carried by first MAC CE signaling. The first MAC CE signaling further includes at least one of the following: serving cell indication information, downlink BWP indication information, uplink BWP indication information, one or more TCI number indication fields, one or more TCI type indication fields, or one or more TCI state indication fields. Specifically, the MAC CE signaling has a lower delay of using than the RRC signaling, and also has better transmission reliability, which facilitates the network to quickly indicate UE to perform corresponding operations.

Specifically, the serving cell indication information, for example, may be a serving cell identity (serving cell ID), indicates a corresponding serving cell, and the first MAC CE signaling is applied to the serving cell. Optionally, the length of the information field corresponding to the serving cell indication information is 5 bits.

Specifically, downlink bandwidth part (DL BWP) indication information, for example, may be a DL BWP ID, indicates a corresponding DL BWP, and the first MAC CE signaling is applied to the DL BWP. Optionally, the length of the information field corresponding to the downlink bandwidth part (DL BWP) indication information is 2 bits.

Specifically, uplink bandwidth part (UL BWP) indication information, for example, may be a UL BWP ID, indicates a corresponding UL BWP, and the first MAC CE signaling is applied to the UL BWP. Optionally, the length of the information field corresponding to the uplink bandwidth part (UL BWP) indication information is 2 bits.

Specifically, each TCI number indication field in the one or more TCI number indication fields indicates that a codepoint corresponds to one or more TCI states.

Specifically, each TCI type indication field in the one or more TCI type indication fields is used to indicate that a corresponding TCI state is a downlink TCI state, an uplink TCI state, or a joint TCI state.

Specifically, each TCI state indication field in the one or more TCI state indication fields indicates one TCI state, and the one TCI state belongs to the above first TCI state set.

Specifically, each TCI state indication field in the one or more TCI state indication fields indicates whether the corresponding TCI state exists. Optionally, the TCI state indication field and another TCI state indication field are in the same octet (Oct).

Specifically, each TCI number indication field in the one or more TCI number indication fields indicates that a codepoint corresponds to N TCI states. Therefore, the total number of uplink TCI states and downlink TCI states may be indicated, which may reduce the number of bits and overhead of the MAC CE signaling. Optionally, each TCI number indication field occupies 2 or 3 bits.

Optionally, each TCI number indication field indicates that one codepoint corresponds to one or two joint TCI states. This embodiment may specifically correspond to the above Example 1.

Optionally, a value of N may be 1, 2, 3, or 4, which may allow for simpler protocol design and system implementation, most of the performance gains of multiple TRPs (M-TRP), and more flexible network configuration and scheduling. Optionally, the number of the downlink TCI states is less than or equal to 2. Optionally, the number of the uplink TCI states is less than or equal to 2. This embodiment may specifically correspond to the above Example 2.

Optionally, the value of N may be 1, 2, 3, 4, 5, or 6, which may support more TRPs for performing downlink transmission, improve downlink performance in some scenarios and provide greater freedom for network optimization. Optionally, the number of the downlink TCI states is less than or equal to 4. Optionally, the number of the uplink TCI states is less than or equal to 2. This embodiment may specifically correspond to the above Example 2.

Optionally, the value of N may be 1, 2, 3, 4, 5, 6, 7, or 8, which may support more TRPs for performing downlink transmission and uplink transmission, improve the downlink performance and uplink performance in some scenarios and provide greater freedom for the network optimization. Optionally, the number of the downlink TCI states is less than or equal to 4. Optionally, the number of the uplink TCI states is less than or equal to 4. This embodiment may specifically correspond to the above Example 2.

Optionally, each TCI number indication field indicates that one codepoint corresponds to 1, 2, 3, or 4 joint TCI states, which may support more TRPs for performing downlink transmission and uplink transmission, improve the downlink performance and uplink performance in some scenarios and provide greater freedom for the network optimization. Optionally, the number of TCI number indication fields is 8 or 16. This embodiment may specifically correspond to the above Example 1.

Specifically, a TCI state type indication field in the one or more TCI type indication fields is used to indicate that a corresponding TCI state is a downlink TCI state, an uplink TCI state, or a joint TCI state.

Optionally, the TCI state type indication field is used to indicate that the TCI state indication information in the same octet with the TCI state type indication field indicates a downlink TCI state, a joint TCI state, or an uplink TCI state.

Optionally, the TCI state type indication field is used to indicate that the TCI state indication information in the same octet with the TCI state type indication field indicates a TCI state in the above second TCI state set or a TCI state in the above third TCI state set.

Specifically, for the TCI state indication information (i.e., the second indication information), optionally, if the TCI state indication information is used to indicate a downlink TCI state or a joint TCI state, the length of the TCI state indication information is 7 bits.

Specifically, for the TCI state indication information (i.e., the second indication information), optionally, if the TCI state indication information is used to indicate an uplink TCI state, the length of the TCI state indication information is 7 bits. Therefore, the TCI state indication information can indicate more uplink TCI states, thereby improving flexibility in network scheduling.

Specifically, for the TCI state indication information (i.e., the second indication information), optionally, if the TCI state indication information is used to indicate an uplink TCI state, the most significant bit in the TCI state indication information is a reserved bit, and the remaining 6 bits indicate the UL TCI state.

Optionally, the first MAC CE signaling may further includes indication information for indicating the number of TCI state subsets (or DCI codepoints). The value that the indication information can indicate is a positive integer within a range of 1 to S, and S may be the number of the TCI number indication fields. Therefore, the UE may be allowed to read/parse less information of some bits, which may reduce complexity of terminal implementation. Optionally, the value may be the number of codepoints in a first field of the DCI corresponding to a TCI state indicated in a second MAC CE. Optionally, the first field is the transmission configuration indication field in the DCI.

In some embodiments, the largest number of TCI states indicated by the first MAC CE is 32, 48 or 64; alternatively, the largest number of TCI states activated by the first MAC CE is 32, 48 or 64. That is, the largest number of TCI states indicated by the second indication information is 32, 48 or 64.

In a case where the largest number is 32, at most 2 TRPs for uplink transmission and 2 TRPs for downlink transmission are supported, (2+2)*8=32.

In a case where the largest number is 48, at most 4 TRPs for downlink transmission and 2 TRPs for uplink transmission are supported, which may improve downlink transmission performance, also improve flexibility in network configuration and scheduling, and control UE implementation complexity within a certain range.

In a case where the largest number is 64, at most 4 TRPs for downlink transmission and 4 TRPs for uplink transmission are supported, which may improve downlink and uplink transmission performance, as well as flexibility in network configuration and scheduling, at the expense of UE implementation complexity.

In some embodiments, in a case where K1 is greater than 1 (K1>1), the first TCI state is determined based on TCI state identities of the K1 TCI states, and/or the second TCI state is determined based on the TCI state identities of the K1 TCI states. That is, the TCI state corresponding to the first SRS resource set and the first TCI state corresponding to the second SRS resource set may be determined based on a preset rule (i.e., TCI state identity), which may effectively reduce complexity of product implementation.

Specifically, for example, the first TCI state is a TCI state with the smallest identity among the K1 TCI states, and/or the second TCI state is a TCI state with the largest identity among the K1 TCI states.

Specifically, as another example, the first TCI state is the TCI state with the largest identity among the K1 TCI states, and/or the second TCI state is the TCI state with the smallest identity among the K1 TCI states.

It should be noted that a TCI state identity may also be called a TCI state index or a TCI state number, which is not limited in the present application.

In some embodiments, in a case where K1 is greater than 1 (K1>1), the first TCI state is determined based on position information of the K1 TCI states in second indication information, and/or the second TCI state is determined based on the position information of the K1 TCI states in the second indication information. The second information is indication information transmitted by the network device and used at least to indicate or activate TCI states, and TCI states indicated or activated by the second indication information include at least the K1 TCI states. That is, TCI states corresponding to the first SRS resource set and the second SRS resource set may be determined based on a preset rule (i.e., position information of the K1 TCI states in the second indication information), which may effectively reduce the complexity of the product implementation.

Specifically, for example, the first TCI state is a TCI state among the K1 TCI states with the most forward position in the second indication information, and/or the second TCI state is a TCI state among the K1 TCI states with the most rearward position in the second indication information.

Specifically, as another example, the first TCI state is the TCI state among the K1 TCI states with the most rearward position in the second indication information, and/or the second TCI state is the TCI state among the K1 TCI states with the most forward position in the second indication information.

In some embodiments, in a case where K1 is greater than 1 (K1>1), the first TCI state is indicated by the network device through third indication information, and/or the second TCI state is indicated by the network device through fourth indication information. That is, the network device may indicate the first TCI state from the K1 TCI states through the third indication information, and/or the network device may indicate the second TCI state from the K1 TCI states through the fourth indication information.

In some embodiments, the third indication information is used to indicate that the first TCI state is the TCI state with the smallest identity among the K1 TCI states, or the third indication information is used to indicate that the first TCI state is the TCI state with the largest identity among the K1 TCI states, or the third indication information is used to indicate that the first TCI state is the TCI state among the K1 TCI states with the most forward position in second indication information, or the third indication information is used to indicate that the first TCI state is the TCI state among the K1 TCI states with the most rearward position in the second indication information. The second indication information is indication information transmitted by the network device and used at least to indicate or activate TCI states, and the TCI states indicated or activated by the second indication information include at least the K1 TCI states. Therefore, the TCI state corresponding to the first SRS resource set may be determined based on the third indication information, which may reduce signaling overhead.

In some embodiments, the fourth indication information is used to indicate that the second TCI state is the TCI state with the smallest identity among the K1 TCI states, or the fourth indication information is used to indicate that the second TCI state is the TCI state with the largest identity among the K1 TCI states, or the fourth indication information is used to indicate that the second TCI state is the TCI state among the K1 TCI states with the most forward position in second indication information, or the fourth indication information is used to indicate that the second TCI state is the TCI state among the K1 TCI states with the most rearward position in the second indication information. The second indication information is indication information transmitted by the network device and used at least to indicate or activate TCI states, and the TCI states indicated or activated by the second indication information include at least the K1 TCI states. Therefore, the TCI state corresponding to the second SRS resource set may be determined based on the fourth indication information, which may reduce the signaling overhead.

Specifically, for example, the third indication information is used to indicate that the first TCI state is the TCI state with the smallest identity among the K1 TCI states, and the fourth indication information is used to indicate that the second TCI state is the TCI state with the largest identity among the K1 TCI states.

Specifically, as another example, the third indication information is used to indicate that the first TCI state is the TCI state with the largest identity among the K1 TCI states, and the fourth indication information is used to indicate that the second TCI state is the TCI state with the smallest identity among the K1 TCI states.

Specifically, for example, the third indication information is used to indicate that the first TCI state is the TCI state among the K1 TCI states with the most forward position in the second indication information, and the fourth indication information is used to indicate that the second TCI state is the TCI state among the K1 TCI states with the most rearward position in the second indication information.

Specifically, as another example, the third indication information is used to indicate that the first TCI state is the TCI state among the K1 TCI states with the most rearward position in the second indication information, and the fourth indication information is used to indicate that the second TCI state is the TCI state among the K1 TCI states with the most forward position in the second indication information.

In some embodiments, in a case where the terminal device fails to obtain the third indication information, or in a case where the network device does not configure the third indication information, the first TCI state is the TCI state with the smallest identity among the K1 TCI states; and/or in a case where the terminal device has obtained the third indication information, or in a case where the network device has configured the third indication information, the first TCI state is the TCI state with the largest identity among the K1 TCI states. Therefore, the TCI state corresponding to the first SRS resource set may be determined based on whether the third indication information is obtained, or based on whether the network device has configured the third indication information, which may reduce the signaling overhead.

In some embodiments, in the case where the terminal device fails to obtain the third indication information, or in the case where the network device does not configure the third indication information, the first TCI state is the TCI state with the largest identity among the K1 TCI states; and/or in the case where the terminal device has obtained the third indication information, or in the case where the network device has configured the third indication information, the first TCI state is the TCI state with the smallest identity among the K1 TCI states. Therefore, the TCI state corresponding to the first SRS resource set may be determined based on whether the third indication information is obtained, or based on whether the network device has configured the third indication information, which may reduce the signaling overhead.

In some embodiments, in a case where the terminal device fails to obtain the fourth indication information, or in a case where the network device does not configure the fourth indication information, the second TCI state is the TCI state with the smallest identity among the K1 TCI states; and/or in a case where the terminal device has obtained the fourth indication information, or in a case where the network device has configured the fourth indication information, the second TCI state the the TCI state with the largest identity among the K1 TCI states. Therefore, the TCI state corresponding to the second SRS resource set may be determined based on whether the fourth indication information is obtained, or based on whether the network device has configured the fourth indication information, which may reduce the signaling overhead.

In some embodiments, in the case where the terminal device fails to obtain the fourth indication information, or in the case where the network device does not configure the fourth indication information, the second TCI state is the TCI state with the largest identity among the K1 TCI states; and/or in the case where the terminal device has obtained the fourth indication information, or in the case where the network device has configured the fourth indication information, the second TCI state is the TCI state with the smallest identity among the K1 TCI states. Therefore, the TCI state corresponding to the second SRS resource set may be determined based on whether the fourth indication information is obtained, or based on whether the network device has configured the fourth indication information, which may the reduce signaling overhead.

Specifically, for example, in a case where the terminal device fails to obtain the third indication information and the fourth indication information, or in a case where the network device does not configure the third indication information and the fourth indication information, the first TCI state is the TCI state with the smallest identity among the K1 TCI states, and the second TCI state is the TCI state with the largest identity among the K1 TCI states; and in a case where the terminal device has obtained the third indication information and the fourth indication information, or in a case where the network device has configured the third indication information and the fourth indication information, the first TCI state is the TCI state with the largest identity among the K1 TCI states, and the second TCI state is the TCI state with the smallest identity among the K1 TCI states.

Specifically, as another example, in a case where the terminal device fails to obtain the third indication information and the fourth indication information, or in a case where the network device does not configured the third indication information and the fourth indication information, the first TCI state is the TCI state with the largest identity among the K1 TCI states, and the second TCI state is the TCI state with the smallest identity among the K1 TCI states; and in a case where the terminal device has obtained the third indication information and the fourth indication information, or in a case where the network device has configured the third indication information and the fourth indication information, the first TCI state is the TCI state with the smallest identity among the K1 TCI states, and the second TCI state is the TCI state with the largest identity among the K1 TCI states.

In some embodiments, in a case where the third indication information has a first value, the first TCI state is the TCI state with the smallest identity among the K1 TCI states; and/or in a case where the third indication information has a second value, the first TCI state is the TCI state with the largest identity among the K1 TCI states. Therefore, the TCI state corresponding to the first SRS resource set may be determined based on the third indication information, which allows for a flexible signaling structure, and facilitates expansion to the case where K1 is greater than 2 (K1>2) in the future.

In some embodiments, in the case where the third indication information has the first value, the first TCI state is the TCI state with the largest identity among the K1 TCI states; and/or in the case where the third indication information has the second value, the first TCI state is the TCI state with the smallest identity among the K1 TCI states. Therefore, the TCI state corresponding to the first SRS resource set may be determined based on the third indication information, which allows for a flexible signaling structure, and facilitates expansion to the case where K1 is greater than 2 (K1>2) in the future.

In some embodiments, in a case where the fourth indication information has a first value, the second TCI state is the TCI state with the smallest identity among the K1 TCI states; and/or in a case where the fourth indication information has a second value, the second TCI state is the TCI state with the largest identity among the K1 TCI states. Therefore, the TCI state corresponding to the second SRS resource set may be determined based on the fourth indication information, which allows for a flexible signaling structure, and facilitates expansion to the case where K1 is greater than 2 (K1>2) in the future.

In some embodiments, in the case where the fourth indication information has the first value, the second TCI state is the TCI state with the largest identity among the K1 TCI states; and/or in the case where the fourth indication information has the second value, the second TCI state is the TCI state with the smallest identity among the K1 TCI states. Therefore, the TCI state corresponding to the second SRS resource set may be determined based on the fourth indication information, which allows for a flexible signaling structure, and facilitates expansion to the case where K1 is greater than 2 (K1>2) in the future.

Specifically, for example, in a case where the third indication information has the first value and the fourth indication information has the first value, the first TCI state is the TCI state with the smallest identity among the K1 TCI states, and the second TCI state is the TCI state with the largest identity among the K1 TCI states; and in a case where the third indication information has the second value and the fourth indication information has the second value, the first TCI state is the TCI state with the largest identity among the K1 TCI states, and the second TCI state is the TCI state with the smallest identity among the K1 TCI states.

Specifically, as another example, in a case where the third indication information has the first value and the fourth indication information has the first value, the first TCI state is the TCI state with the largest identity among the K1 TCI states, and the second TCI state is the TCI state with the smallest identity among the K1 TCI states; and in a case where the third indication information has the second value and the fourth indication information has the second value, the first TCI state is the TCI state with the smallest identity among the K1 TCI states, and the second TCI state is the TCI state with the largest identity among the K1 TCI states.

In some embodiments, the one with a smaller SRS resource set ID in the two SRS resource sets (i.e., the first SRS resource set and the second SRS resource set) corresponds to the TCI state with a smaller identity (ID) in the K1 (K1=2) TCI states, and the one with a larger SRS resource set ID in the two SRS resource sets (i.e., the first SRS resource set and the second SRS resource set) corresponds to the TCI state with a larger identity (ID) in the K1 (K1=2) TCI states.

In some embodiments, the one with the larger SRS resource set ID in the two SRS resource sets (i.e., the first SRS resource set and the second SRS resource set) corresponds to the TCI state with the smaller identity (ID) in the K1 (K1=2) TCI states, and the one with the smaller SRS resource set ID in the two SRS resource sets (i.e., the first SRS resource set and the second SRS resource set) corresponds to the TCI state with the larger identity (ID) in the K1 (K1=2) TCI states.

In some embodiments, the one with the smaller SRS resource set ID in the two resource sets (i.e., the first SRS resource set and the second SRS resource set) corresponds to one of the K1 (K1=2) TCI states having a more forward position in the second indication information, and one with the larger SRS resource set ID in the two resource sets (i.e., the first SRS resource set and the second SRS resource set) corresponds to one of the K1 (K1=2) TCI states having a more rearward position in the second indication information.

In some embodiments, the one with the larger SRS resource set ID in the two resource sets (i.e., the first SRS resource set and the second SRS resource set) corresponds to one of the K1 (K1=2) TCI states with a more forward position in second indication information, and the one with the smaller SRS resource set ID in the two resource sets (i.e., the first SRS resource set and the second SRS resource set) corresponds to one of the K1 (K1=2) TCI states with a more rearward position in the second indication information.

In some embodiments, the third indication information is included in configuration information of the first SRS resource set, and/or the fourth indication information is included in configuration information of the second SRS resource set.

In some embodiments, in a case where the configuration information of the first SRS resource set includes the third indication information, the configuration information of the first SRS resource set does not include a followUnifiedTCIstateSRS or a followUnifiedTCIstate, or the configuration information of the first SRS resource set includes a disabled followUnifiedTCIstateSRS or a disabled followUnifiedTCIstate, or the terminal device ignores a followUnifiedTCIstateSRS or a followUnifiedTCIstate included in the configuration information of the first SRS resource set.

In some embodiments, in a case where the configuration information of the second SRS resource set includes the fourth indication information, the configuration information of the second SRS resource set does not include a followUnifiedTCIstateSRS or a followUnifiedTCIstate, or the configuration information of the second SRS resource set includes a disabled followUnifiedTCIstateSRS or a disabled followUnifiedTCIstate, or the terminal device ignores a followUnifiedTCIstateSRS or a followUnifiedTCIstate included in the configuration information of the second SRS resource set.

In some embodiments, in a case where K1 is greater than 1 (K1>1), an uplink transmit spatial filter or a spatial relation corresponding to the first SRS resource set is determined based on the first TCI state, and/or an uplink transmit spatial filter or a spatial relation corresponding to the second SRS resource set is determined based on the second TCI state.

In some embodiments, in the case where K1 is greater than 1 (K1>1), an uplink transmit spatial filter (UL TX spatial filter) or a spatial relation corresponding to a PUSCH associated with the first SRS resource set is determined based on the first TCI state and/or the first SRS resource set. For example, the uplink transmit spatial filter or spatial relation corresponding to the PUSCH associated with the first SRS resource set is determined based on the first TCI state and the first SRS resource set.

In some embodiments, in a case where TCI state(s) in the K1 TCI states are joint TCI state(s), the uplink transmit spatial filter or the spatial relation corresponding to the PUSCH associated with the first SRS resource set is determined based on the first SRS resource set and a reference signal corresponding to typeD (Type D) and indicated in the first TCI state.

In some embodiments, in a case where TCI state(s) in the K1 TCI states are uplink TCI state(s) (UL TCI state), the uplink transmit spatial filter or the spatial relation corresponding to the PUSCH associated with the first SRS resource set is determined based on the first SRS resource set and the reference signal indicated in the first TCI state.

In some embodiments, in the case where K1 is greater than 1 (K1>1), an uplink transmit spatial filter (UL TX spatial filter) or a spatial relation corresponding to a PUSCH associated with the second SRS resource set is determined based on the second TCI state and/or the second SRS resource set. For example, the uplink transmit spatial filter or spatial relation corresponding to the PUSCH associated with the second SRS resource set is determined based on the second TCI state and the second SRS resource set.

In some embodiments, in the case where TCI state(s) in the K1 TCI states are the joint TCI state(s), the uplink transmit spatial filter or the spatial relation corresponding to the PUSCH associated with the second SRS resource set is determined based on the second SRS resource set and the reference signal corresponding to typeD (Type D) and indicated in the second TCI state

In some embodiments, in the case where TCI state(s) in the K1 TCI states are the uplink TCI state(s) (UL TCI state), the uplink transmit spatial filter or spatial relation corresponding to the PUSCH associated with the second SRS resource set is determined based on the second SRS resource set and the reference signal indicated in the second TCI state.

In some embodiments, in a case where K1 is equal to 1 (K1=1), uplink transmit spatial filters or spatial relations respectively corresponding to the first SRS resource set and the second SRS resource set are both determined based on the first TCI state. Specifically, for example, in a case where K1 is equal to 1 (K1=1), and the first SRS resource set and the second SRS resource set are both associated with the first TCI state, the uplink transmit spatial filters or spatial relations respectively corresponding to the first SRS resource set and the second SRS resource set are determined based on the first TCI state.

In some embodiments, in the case where K1 is equal to 1 (K1=1), the uplink transmit spatial filter or spatial relation corresponding to the first SRS resource set is determined based on the first TCI state, and the second SRS resource set is not considered in the current PUSCH transmission. Specifically, for example, in the case where K1 is equal to 1 (K1=1), if the first SRS resource set is associated with the first TCI state, and the second SRS resource set is not associated with any TCI state, the uplink transmit spatial filter or spatial relation corresponding to the first SRS resource set is determined based on the first TCI state, and the second SRS resource set is not considered in the current PUSCH transmission.

In some embodiments, in the case where K1 is equal to 1 (K1=1), the uplink transmit spatial filters or spatial relations respectively corresponding to the PUSCH associated with the first SRS resource set and the PUSCH associated with the second SRS resource set are both determined based on the first TCI state and/or the first SRS resource set. Specifically, for example, in the case where K1 is equal to 1 (K1=1), if the first SRS resource set and the second SRS resource set are both associated with the first TCI state, the uplink transmit spatial filters or spatial relations respectively corresponding to the PUSCH associated with the first SRS resource set and the second SRS resource set are determined based on the first TCI state and/or the first SRS resource set.

In some embodiments, the uplink transmit spatial filter or spatial relation corresponding to the PUSCH associated with the first SRS resource set is determined based on the first TCI state and the first SRS resource set, and the second SRS resource set is not considered in the current PUSCH transmission. Specifically, for example, in the case where K1 is equal to 1 (K1=1), if the first SRS resource set is associated with the first TCI state and the second SRS resource set is not associated with any TCI state, the uplink transmit spatial filter or the spatial relation corresponding to the PUSCH associated with the first SRS resource set is determined based on the first TCI state and the first SRS resource set, and the second SRS resource set is not considered in the current PUSCH transmission.

In some embodiments, the K1 TCI states belong to N TCI states;
where at least a portion of the N TCI states are activated TCI states corresponding to the uplink transmission, the N TCI states are configured or indicated by the network device, N is a positive integer, and K1 is less than or equal to N (K1≤N).

Optionally, for the terminal device, at least the portion of the N TCI states are used to determine the uplink transmission; for the network device, at least the portion of the N TCI states are used to indicate the uplink transmission.

Specifically, for example, K1 TCI states in the N TCI states are used for the uplink transmission, and K2 TCI states in the N TCI states are used for the downlink transmission. K1 is equal to or greater than 0 and equal to or less than N (0≤0≤N), K2 is equal to or greater than 0 and equal to or less than N (0≤K2≤N). For example, K1 is equal to K2 (K1=K2); or K1 is equal to N (K1=N), and K2 is equal to 0 (K2=0); or other combinations.

For example, K1 is equal to N (K1=N), and the N TCI states are N uplink TCI states; alternatively, K1 is equal to N (K1=N) and the N TCI states are N joint TCI states, which are used for both uplink transmission and downlink transmission.

In some embodiments, the K1 TCI states are indicated by the network device through fifth indication information. In other words, the network device may indicate the K1 TCI states from N TCI states through the fifth indication information. Therefore, in these embodiments, new indication information (i.e., the fifth indication information) is introduced to independently configure multi-TRP (M-TRP) transmission in the uplink and in the downlink, which reduces complexity of terminal implementation and facilitates more types of terminals to support this function.

In some embodiments, the fifth indication information is carried by one of the following: RRC signaling, MAC CE signaling, and DCI signaling.

It should be noted that, RRC has good reliability but high latency, DCI has low latency and low signaling overhead but poor reliability, and MAC CE has better reliability than DCI, and lower signaling overhead and latency than RRC.

In some embodiments, the fifth indication information is used to indicate that the K1 TCI states are K1 TCI states selected sequentially from the N TCI states according to a first order. Therefore, in these embodiments, the K1 TCI states may be selected from the N TCI states according to a preset rule (i.e., the first order), which may effectively reduce complexity of product implementation.

In some embodiments, the first order is an ascending order of TCI state identities, or the first order is a descending order of the TCI state identities. Certainly, the first order may also be other orders, for example, an ascending order of odd-numbered TCI state identities, or an ascending order of even-numbered TCI state identities, which are not limited in the present application.

Specifically, for example, the fifth indication information is used to indicate that the K1 TCI states are K1 TCI states selected from the N TCI states according to the ascending order of the TCI state identities.

Specifically, as another example, the fifth indication information is used to indicate that the K1 TCI states are K1 TCI states selected from the N TCI states according to the descending order of the TCI state identities.

In some embodiments, the first order may be defined in a protocol, or the first order may be configured by the network device.

In some embodiments, the fifth indication information is used to indicate that the K1 TCI states are K1 TCI states sequentially selected according to a position order of the N TCI states in second indication information. The second indication information is indication information used at least to indicate or activate TCI states transmitted by the network device, and the TCI states indicated or activated by the second indication information include at least the K1 TCI states. Therefore, in these embodiments, the K1 TCI states may be selected from N TCI states according to a preset rule (i.e., the position order of the N TCI states in the second indication information), which may effectively reduce the complexity of product implementation.

In some embodiments, the position of the N TCI states in the second indication information is a front-to-back order, or the position order of the N TCI states in the second indication information is a back-to-front order.

Specifically, for example, the fifth indication information is used to indicate that the K1 TCI states are K1 TCI states sequentially selected from the front to the back in the position order of the N TCI states in the second indication information.

Specifically, as another example, the fifth indication information is used to indicate that the K1 TCI states are K1 TCI states sequentially selected from the N TCI states in a front-to-back position order in the second indication information.

In some embodiments, the N TCI states are indicated by the network device through sixth indication information. That is, the network device may directly indicate the N TCI states, or the network device may indicate the N TCI states from a plurality of preconfigured TCI states.

In some embodiments, the N TCI states are indicated by the network device through second indication information. The second indication information is indication information used at least to indicate or activate TCI states transmitted by the network device, and the TCI states indicated or activated by the second indication information includes at least the N TCI states. That is, the network device may directly indicate the N TCI states, or the network device may indicate the N TCI states from a plurality of preconfigured TCI states. Optionally, in this case, the second indication information and the sixth indication may be the same one indication information.

In some embodiments, the N TCI states are determined based on second indication information from the TCI states indicated by the network device through the sixth indication information. The second indication information is indication information used at least to indicate or activate TCI states transmitted by the network device, and the TCI states indicated or activated by the second indication information includes at least the N TCI states. Specifically, for example, the network device may indicate a plurality of TCI states through the sixth indication information, and indicate the N TCI states among the multiple TCI states through the second indication information.

In some embodiments, the sixth indication information is carried by one of the following: RRC signaling, MAC CE signaling, and DCI signaling.

Specifically, for example, the sixth indication information may be the DCI signaling, such as the sixth indication information is transmitted through a first field in the DCI signaling, and the first field is the transmission configuration indication field in the DCI signaling.

In some embodiments, the terminal device may determine one or more of the following information according to the sixth indication information:
QCL (Quasi co-location) information corresponding to a PDSCH DMRS;
QCL information corresponding to the PDCCH DMRS, or QCL information corresponding to DMRSs corresponding to a portion of CORESETs;
QCL information corresponding to at least a portion of CSI-RSs;
an uplink transmit spatial filter (UL TX spatial filter) of a PUSCH;
uplink transmit spatial filters of at least a portion of PUCCHs;
uplink transmit spatial filters of at least a portion of SRSs.

Optionally, RRC parameters are configured in an SRS resource set corresponding to at least a portion of the SRSs “an SRS in r17 following unified TCI state (followUnifiedTCIstateSRS-r17)”.

Optionally, the sixth indication information and the second indication information may be the same one information. For example, if only one codepoint has corresponding TCI states, then no additional DCI is required to indicate activated TCI states.

Optionally, the sixth indication information is transmitted through the DCI signaling. Optionally, the sixth indication information is transmitted through the transmission configuration indication field in the DCI signaling. For example, in a case where a plurality of codepoints have corresponding TCI states, the DCI is further used to indicate a codepoint whose corresponding TCI states are to be used as the activated TCI states.

Optionally, the DCI carrying the sixth indication information is DCI format 1_1 and/or DCI format 1_2, and DCI format 1_1 or DCI format 12 may be used to schedule data or not used to schedule downlink transmission (with or without, if applicable, DL assignment).

Optionally, the DCI carrying the sixth indication information is DCI format 1_1 and/or DCI format 1_2 and/or DCI format 0_1 and/or DCI format 0_2, and DCI format 1_1/1_2 may be used to schedule data or not used to schedule downlink transmission (with or without, if applicable, DL assignment), and DCI format 0_1/0_2 may be used to schedule data or not used to schedule uplink transmission (with or without, if applicable, UL assignment).

Optionally, if the downlink transmission is not scheduled (without DL assignment), for DCI format 1_1/1_2, the terminal device may make the following assumptions (or in other words, DCI format 1_1/1_2 satisfies the following conditions):
cyclic redundancy check (CRC) of the DCI is scrambled by configured scheduling radio network temporary identity (CS-RNTI);
an information field in the DCI may be set as follows: redundancy version (RV)=all ‘1’s, modulation and coding scheme (MCS)=all ‘1’s, new data indicator (NDI)=0, frequency domain resource assignment (FDRA) type 0 all set to ‘0’s, or FDRA Type1 all set to ‘1’s, or dynamic switch(dynamicswitch) all set to ‘0’s.

If at least one TCI state (referred to as TCI state X) among the one or more TCI states indicated by the sixth indication information is different from any one of previously indicated TCI states (considering a same direction, for example, if the TCI state X is used for uplink transmission, previously indicated TCI states for the uplink transmission are considered to be different from the TCI state X; if the TCI state X is used for the downlink transmission/reception, previously indicated TCI states for the downlink transmission/reception are considered to be different from the TCI state X; if the TCI state X is used for the uplink transmission and the downlink transmission/reception, previously indicated TCI states for the uplink transmission and the downlink transmission/reception are considered to be different from the TCI state X), or if at least one TCI state (referred to as TCI state X) among the one or more TCI states indicated by the sixth indication information is different from any one of the TCI states currently activated/applied by the terminal device, the TCI state X indicated by the sixth indication information takes effect from the first slot that has an interval of at least BeamAppTime symbols with the last symbol of a first PUCCH. That is, the terminal device may determines the uplink transmission and the downlink transmission/reception and/or QCL information corresponding to the downlink transmission/reception according to the TCI state X. The first PUCCH transmission carries a hybrid automatic repeat acknowledgement (HARQ-ACK) information corresponding to the first indication information DCI.

For the above embodiments, additional examples are given in the following. In an example, one DCI may indicate at most two TCI states for the downlink transmission/reception (DL operation, or DL transmission/reception), and the other cases (TCI states for uplink, or TCI states for both uplink and downlink) may be extended in a similar way. It is assumed that the network previously indicated TCI state A1 and TCI state A2 for the downlink transmission, if the current DCI indication signal includes the TCI state X, and the TCI state X is different from TCI state A1/A2, then the above process needs to be used to determine in which cases the TCI state X can be applied. As another example, the terminal device currently uses 1 or 2 TCI states (denoted as A1 and A2) to determine QCL information corresponding to the downlink transmission. The current DCI indication signal includes the TCI state X, and the TCI state X is different from TCI state A1/A2. In this case, the above process needs to be used to determine in which cases the TCI state X can be applied.

In the embodiments of the present application, performing uplink transmission based on a certain TCI state or the TCI state being used for uplink transmission means determining, according to the TCI state, a spatial relation corresponding to the uplink transmission or a corresponding uplink transmit spatial filter. For example, if the TCI state is a UL TCI state, the spatial relation of the uplink transmission or the uplink transmit spatial filter is determined according to the reference signal indicated in the UL TCI state. As another example, if the TCI state is a joint TCI state, the spatial relation of the uplink transmission or the uplink transmit spatial filter is determined according to the reference signal corresponding to type D (typeD) and indicated in the joint TCI state.

In some embodiments, the terminal device transmits first terminal capability information;
where the first terminal capability information is used to indicate that the terminal device supports that Z1 unified TCI states are used for uplink transmission or uplink repeated transmission, or the first terminal capability information is used to indicate that the terminal device supports that one codepoint in the transmission configuration indication field activates or indicates at most Z1 unified TCI states for uplink transmission or uplink repeated transmission, or the first terminal capability information is used to indicate that the terminal device supports Z1 unified TCI states for uplink transmission or uplink repeated transmission on a CG PUSCH; and Z1 is a positive integer greater than 1.

In other words, the terminal device may report the first terminal capability information to the network device, thus the network device may activate or indicate unified TCI state(s) for uplink transmission or uplink repeated transmission based on the first terminal capability information.

Specifically, for example, Z1 is 2, or Z1 is 4.

In some embodiments, the first terminal capability information is reported according to at least one of the following granularities:
a per band granularity, a per band combination granularity, a per band per band combination granularity, a per carrier per band per band combination granularity, a per frequency range granularity, or a per terminal granularity.

Specifically, for example, the first terminal capability information is reported according to a per band granularity (per band), that is, the first terminal capability is reported for each band (that is to say, different bands may support that corresponding capability is independently reported). Therefore, in this case, independent reporting for different bands may bring greater flexibility to terminal implementation. For example, the terminal may support such function on a certain band or certain bands, but may not support such function on the other bands, which may allow more terminals to support this new function.

Specifically, for example, the first terminal capability information is reported according to a per band combination granularity (per band combination), that is, the first terminal capability is independently reported according to a band combination. Therefore, in this case, independent reporting for different band combinations may bring greater flexibility to terminal implementation. For example, the terminal may not support this function under a certain band combination, but may support this function under another band combination, which may allow more terminals to support this new function.

Specifically, for example, the first terminal capability information is reported according to a per band per band combination granularity (per band per band combination), that is, the first terminal capability is independently reported according to each band in a band combination (that is to say, bands in different band combinations may support independent reporting). Therefore, in this case, independent reporting for different band combinations may bring greater flexibility to terminal implementation. For example, the terminal may not support this function under a certain CA, but may support this function on certain bands in another CA combination, which may allow more terminals to support this new function.

Specifically, for example, the first terminal capability information is reported according to a per carrier per band per band combination granularity (per CC per band per band combination or per Feature Set Per Component-carrier), that is, the first terminal capability is reported independently according to each carrier on each band in a band combination (that is to say, different CCs on bands in different band combinations may support independent reporting). Therefore, in this case, different band combinations support independent reporting, and different carriers on a band may also support independent reporting, which may bring greater flexibility to terminal implementation, so that more terminals may support this new function.

Specifically, for example, the first terminal capability information is reported according to a per frequency range granularity (per frequency range), that is, the first terminal capability is reported according to a frequency range (FR) (that is to say, different FRs may support independent reporting; and per FR refers to reporting independently at FR1 and FR2). Therefore, in this case, independent reporting for different FRs may bring greater flexibility to terminal implementation. For example, the terminal does not support this function at low frequency (FR1), but supports this function at FR2 (high frequency), which may allow more terminals to support this new function.

Specifically, for example, the first terminal capability information is reported according to per UE granularity (per UE), that is, the first terminal capability is reported for each UE (i.e., per UE, that is to say, if a UE reports the capability, the UE supports the capability on all bands). Therefore, in this case, signaling overhead of terminal capability reporting is reduced.

In some embodiments, the first terminal capability information is carried by one of the following: RRC signaling and MAC CE signaling.

In some embodiments, the terminal device transmits second terminal capability information;
where the second terminal capability information is used to indicate that the terminal device supports a CG PUSCH.

In other words, the terminal device may report the second terminal capability information to the network device, and thus, the network device may determine that the terminal device supports the CG PUSCH based on the second terminal capability information.

In some embodiments, the second terminal capability information is reported according to at least one of the following granularities:
a per band granularity, a per band combination granularity, a per band per band combination granularity, a per carrier per band per band combination granularity, a per frequency range granularity, or a per terminal granularity.

Specifically, for example, the second terminal capability information is reported according to a per band granularity (per band), that is, the second terminal capability is reported for each band (that is to say, for different bands, corresponding capability may be independently reported). Therefore, in this case, independent reporting for different bands may bring greater flexibility to terminal implementation. For example, the terminal may support this function on a certain band or certain bands, but not support this function on the other bands, which allows more terminals to support this new function.

Specifically, for example, the second terminal capability information is reported according to a per band combination granularity (per band), that is, the second terminal capability is independently reported according to the band combination. Therefore, in this case, independent reporting for different band combinations may bring greater flexibility to terminal implementation. For example, the terminal may not support this function under a certain band combination, but may support this function under another band combination, which may allow more terminals to support this new function.

Specifically, for example, the second terminal capability information is reported according to a per band per band combination granularity (per band per band combination), that is, the second terminal capability is reported independently according to each band in a band combination (that is to say, bands in different band combinations may support independent reporting). Therefore, in this case, independent reporting for different band combination may bring greater flexibility to terminal implementation. For example, the terminal may not support this function under a certain CA, but may support this function in certain bands in another CA combination, which may allow more terminals to support this new function.

Specifically, for example, the second terminal capability information is reported according to a per carrier per band per band combination granularity (per CC per band per band combination or per FSPC), that is, the second terminal capability is independently reported according to each carrier on each band in a band combination (that is to say, different CCs on bands in band combinations may support independent reporting). Therefore, in this case, different band combinations support independent reporting, and different carriers on each band may also support independent reporting, which may bring greater flexibility to terminal implementation, so that more terminals may support this new function.

Specifically, for example, the second terminal capability information is reported according to a per frequency range granularity (per frequency range), that is, the second terminal capability is reported according to a frequency range (FR) (that is to say, different FRs may support independent reporting; and per FR refers to reporting independently at FR1 and FR2). Therefore, in this case, independent reporting for different FRs may bring greater flexibility to terminal implementation. For example, the terminal does not support this function at low frequency (FR1), but supports this function at FR2 (high frequency), which may allow more terminals to support this new function.

Specifically, for example, the second terminal capability information is reported according to a per UE granularity (per UE), that is, the second terminal capability is reported for each UE (i.e., per UE, that is to say, if a UE reports the capability, the UE supports the capability on all bands). Therefore, in this case, signaling overhead of terminal capability reporting is reduced.

It should be noted that the reporting granularity of the first terminal capability information and the reporting granularity of the second terminal capability information may be the same or different. For example, the reporting granularity of one of the terminal capability information is per band, and the reporting granularity of the other terminal capability information is per CC per band per band combination. Because uplink and downlink have different requirements on terminal capability, the apply of uplink capability and downlink capability with different options may be more conducive to terminal implementation.

In some embodiments, the second terminal capability information is carried by one of the following: RRC signaling, and MAC CE signaling.

In some embodiments, the second terminal capability information and the first terminal capability information are transmitted through the same signaling, or the second terminal capability information and the first terminal capability information are transmitted through different signaling.

In some embodiments, the terminal device transmits third terminal capability information;
where the third terminal capability information is used to indicate that the terminal device supports that Z2 unified TCI states are together used for uplink transmission or uplink repeated transmission, or the third terminal capability information is used to indicate that the terminal device supports that one codepoint in a transmission configuration indication field activates or indicates at most Z2 unified TCI states together used for uplink transmission or uplink repeated transmission, or the third terminal capability information is used to indicate that the terminal device supports Z2 unified TCI states together used for uplink transmission or uplink repeated transmission on a CG PUSCH and where Z2 is a positive integer greater than 1.

In other words, the terminal device may report the third terminal capability information to the network device, and thus, the network device may activate or indicate unified TCI states used for uplink transmission or uplink repeated transmission based on the third terminal capability information.

Specifically, for example, Z2 is 2, or Z2 is 4.

In some embodiments, the third terminal capability information is reported according to at least one of the following granularities:
a per band granularity, a per band combination granularity, a per band per band combination granularity, a per carrier per band per band combination granularity, a per frequency range granularity, or a per terminal granularity.

Specifically, for example, the third terminal capability information is reported according to a per band granularity (per band), that is, the third terminal capability is reported for each band (that is to say, different bands may support that corresponding capability is independently reported). Therefore, in this case, independent reporting for different bands may bring greater flexibility to terminal implementation. For example, the terminal may support such function on a certain band or certain bands, but may not support such function on the other bands, which may allow more terminals to support this new function.

Specifically, for example, the third terminal capability information is reported according to a per band combination granularity (per band combination), that is, the third terminal capability is independently reported according to a band combination. Therefore, in this case, independent reporting for different band combinations may bring greater flexibility to terminal implementation. For example, the terminal may not support this function under a certain band combination, but may support this function under another band combination, which may allow more terminals to support this new function.

Specifically, for example, the third terminal capability information is reported according to a per band per band combination granularity (per band per band combination), that is, the third terminal capability is reported independently according to each band in a band combination (that is to say, bands in different band combinations may support independent reporting). Therefore, in this case, independent reporting for different band combinations may bring greater flexibility to terminal implementation. For example, the terminal may not support this function under a certain CA, but may support this function on certain bands in another CA combination, which may allow more terminals to support this new function.

Specifically, for example, the third terminal capability information is reported according to a per carrier per band per band combination granularity (per CC per band per band combination or per FSPC), that is, the third terminal capability is reported independently according to each carrier on each band in a band combination (that is to say, different CCs on bands in different band combinations may support independent reporting). Therefore, in this case, different band combinations support independent reporting, and different carriers on a band may also support independent reporting, which may bring greater flexibility to terminal implementation, so that more terminals may support this new function.

For example, the third terminal capability information is reported according to a per frequency range granularity (per frequency range), that is, the third terminal capability is reported according to a frequency range (FR) (that is to say, different FRs may support independent reporting; and per FR refers to reporting independently at FR1 and FR). Therefore, in this case, independent reporting for different FRs may bring greater flexibility to terminal implementation. For example, the terminal does not support this function at low frequency (FR1), but supports this function at FR2 (high frequency), so that more terminals may support this new function.

Specifically, for example, the third terminal capability information is reported according to a per UE granularity (per UE), that is, the third terminal capability is reported for each UE (i.e., per UE, that is to say, if a UE reports the capability, the UE supports the capability on all bands). Therefore, in this case, the signaling overhead of terminal capability reporting is reduced.

It should be noted that the reporting granularity of the first terminal capability information and the reporting granularity of the third terminal capability information may be the same or different. For example, the reporting granularity of one of the terminal capability information is per band, and the reporting granularity of the other terminal capability information is per CC per band per band combination. Because uplink and downlink have different requirements on terminal capability, the apply of uplink capability and downlink capability with different option may be more conducive to terminal implementation.

In some embodiments, the third terminal capability information is carried by one of the following: RRC signaling, and MAC CE signaling.

Specifically, the difference between the first terminal capability information and the third terminal capability information may be explained through the following example.

It is assumed that the terminal device may report its support for two TCI states (denoted as A1 and A2) through the first terminal capability information. If there are multiple PUSCH repeated transmissions, one of the TCI states is applied in each PUSCH transmission, but different TCI states may be applied in different PUSCH transmissions. For example, the PUSCH is repeatedly transmitted for 4 times, and the corresponding TCI states may be A1, A2, A1 and A2, respectively. That is, A1 and A2 are not used in the same transmission, or in other words, A1 and A2 are not used together to determine one PUSCH transmission.

It is assumed that the terminal device may report its support for two TCI states (denoted as A1 and A2) through the third terminal capability information report. If there are multiple PUSCH repeated transmissions, during each transmission, the two states (i.e., A1+A2) are used to determine the PUSCH transmission. For example, PUSCH is repeatedly transmitted for 4 times, and the corresponding TCI states are A1+A2, A1+A2, A1+A2 and A1+A2, respectively.

In the following, a solution (i.e., Embodiment 1) for determining an uplink transmit spatial filter or spatial relation corresponding to a dynamically scheduled PUSCH, a solution (i.e., Embodiment 2) for determining an uplink transmit spatial filter or spatial relation corresponding to a CG Type1 PUSCH (CG PUSCH Type1), and a solution (i.e., Embodiment 3) for determining an uplink transmit spatial filter or spatial relation corresponding to a CG Type2 PUSCH (CG PUSCH Type2) that are provided by the present application will be described in detail through specific embodiments.

In Embodiment 1, the terminal device receives first DCI used to schedule a first PUSCH, and the terminal device determines an uplink transmit spatial filter or a spatial relation corresponding to the first PUSCH according to the first information, or determines transmission of the first PUSCH and the uplink transmit spatial filter or spatial relation corresponding to the first PUSCH according to the first information.

The first information is at least one of the following: a first TCI state among the K1 TCI states, a second TCI state among the K1 TCI states, the first SRS resource set, or the second SRS resource set.

In a case where K1 is greater than 1 (K1>1), the first SRS resource set is associated with the first TCI state, and the second SRS resource set is associated with the second TCI state; and
in a case where K1 is equal to 1 (K1=1) and the K1 TCI states only include the first TCI state, the first SRS resource set and the second SRS resource set are both associated with the first TCI state; or the first SRS resource set is associated with the first TCI state, and the second SRS resource set is not associated with any TCI state.

In Embodiment 1, the terminal device receives the first DCI after receiving the second indication information and/or the sixth indication information.

Optionally, the format of the first DCI may be DCI format 0_0, or the format of the first DCI may be DCI format 0_1, or the format of the first DCI may be DCI format 0_2.

In some implementations of Embodiment 1, in a case where K1 is greater than 1 (K1>1) and the first DCI is DCI format 0_0, the terminal device determines the uplink transmit spatial filter or spatial relation corresponding to the first PUSCH according to a preset TCI state in the first TCI state and the second TCI state.

For example, in a case where the format of the first DCI is DCI format 0_0, the terminal device may use a TCI state with the smallest identity (ID) in the K1 TCI states to determine the uplink transmit spatial filter or the spatial relation corresponding to the first PUSCH.

As another example, in a case where the format of the first DCI is DCI format 0_0, the terminal device may use a TCI state with the largest identity (ID) in K1 TCI states to determine the uplink transmit spatial filter or spatial relation corresponding to the first PUSCH.

As another example, in a case where the format of the first DCI is DCI format 0_0, the terminal device may use a TCI state among the K1 TCI states with the most forward position in the second indication information to determine the uplink transmit spatial filter or spatial relation corresponding to the first PUSCH.

As another example, in a case where the format of the first DCI is DCI format 0_0, the terminal device may use a TCI state among the K1 TCI states with the most rearward position in the second indication information to determine the uplink transmit spatial filter or spatial relation corresponding to the first PUSCH.

In some implementations of Embodiment 1, in a case where K1 is greater than 1 (K1>1) and the first DCI is DCI format 0_0, the terminal device determines the uplink transmit spatial filter or spatial relation corresponding to the first PUSCH based on the TCI state indicated by the network device from the first TCI state and the second TCI state. Therefore, in this embodiment, new indication information is used to achieve flexible configuration, which may improve the flexibility of the system and also bring flexibility to network optimization.

Specifically, if the first DCI is DCI format 0_0, the terminal device receives eleventh indication information transmitted by the network device. The eleventh indication information is used to indicate a TCI state from the first TCI state and the second TCI state. The terminal device determines, based on the eleventh indication information, which of the first TCI state and the second TCI state is used to determine the uplink transmit spatial filter or spatial relation corresponding to the first PUSCH.

Optionally, the eleventh indication information may be carried by one of the following: RRC signaling, MAC signaling, and DCI signaling.

Optionally, the eleventh indication information may indicate to use the TCI state with a smaller ID in the first TCI state and the second TCI state to determine the uplink transmit spatial filter or spatial relation corresponding to the first PUSCH.

Optionally, the eleventh indication information may indicate to use the TCI state with a larger ID in the first TCI state and the second TCI state to determine the uplink transmit spatial filter or spatial relation corresponding to the first PUSCH.

Optionally, the eleventh indication information may indicate to use one of the first TCI state and the second TCI state with a more forward position in the second indication information to determine the uplink transmit spatial filter or spatial relation corresponding to the first PUSCH.

Optionally, the eleventh indication information may indicate that use one of the first TCI state and the second TCI state with a more rearward position in the second indication information to determine the uplink transmit spatial filter or spatial relation corresponding to the first PUSCH.

In some implementations of Embodiment 1, in a case where K1 is greater than 1 (K1>1) and the first DCI is DCI format 0_1 or DCI format 0_2, the terminal device determines the uplink transmit spatial filter or spatial relation corresponding to the first PUSCH and the transmission of the first PUSCH according to the first TCI state, the first SRS resource set, the second TCI state and the second SRS resource set.

In some implementations of Embodiment 1, in a case where K1 is equal to 1 (K1=1), the terminal device determines the uplink transmit spatial filter or spatial relation corresponding to the first PUSCH and the transmission of the first PUSCH according to the first SRS resource set and the first TCI state.

In some implementations of Embodiment 1, in a case where K1 is equal to 1 (K1=1), the terminal device determines the uplink transmit spatial filter or spatial relation corresponding to the first PUSCH and the transmission of the first PUSCH according to the second SRS resource set and the first TCI state.

In some implementations of Embodiment 1, if the first PUSCH needs to be repeatedly transmitted for M times (for example, the first PUSCH may be transmitted in M consecutive slots; or in another example, the first PUSCH may include M nominal repetitions), and the first transmission is the initial transmission, where M is a positive integer.

Specifically, the first DCI is DCI format 0_1 or DCI format 0_2. In a case where an SRS resource indicator field in DCI format 0_1 or DCI format 0_2 indicates a first value (e.g., the codepoint is “00”), the first SRS resource set and the corresponding first TCI state are used for the M repeated transmissions of the first PUSCH.

It should be noted that, that the first SRS resource set and the corresponding first TCI state are used for M repeated transmissions of the first PUSCH may also be expressed as that the first SRS resource set and the corresponding first TCI state are used to determine an uplink transmit spatial filter or spatial relation corresponding to the M repeated transmissions of the first PUSCH.

Specifically, the first DCI is DCI format 0_1 or DCI format 0_2. In a case where the SRS resource indicator field in DCI format 0_1 or DCI format 0_2 indicates a second value (e.g., the codepoint is “01”), the second SRS resource set and the corresponding second TCI state are used for M repeated transmissions.

It should be noted that, that the second SRS resource set and the corresponding second TCI state are used for M repeated transmissions of the first PUSCH may also be expressed as that the second SRS resource set and the corresponding second TCI state are used to determine the uplink transmit spatial filter or spatial relation corresponding to the M repeated transmissions of the first PUSCH.

Specifically, the first DCI is DCI format 0_1 or DCI format 0_2. In the case where the SRS resource indicator field in DCI format 0_1 or DCI format 0_2 indicates a third value (e.g., the codepoint is “10”):
when M is equal to 2 (M=2), the first SRS resource set and the corresponding first TCI state are used for the first transmission of the first PUSCH (e.g., the first slot in the M consecutive slots, or the first repetition in the M nominal repetitions), and the second SRS resource set and the corresponding second TCI state are used for the second transmission of the first PUSCH (e.g., the second slot of the M consecutive slots, or the second repetition of the M nominal repetitions);
when M is greater than 2 (M>2), if RRC information element “PUSCH configuration” (RRC IE PUSCH-Config) indicates a cyclic mapping (i.e., the cyclic mapping is enabled), the first SRS resource set and the corresponding first TCI state are used for the first transmission of the first PUSCH (e.g., the first slot in the M consecutive slots, or the first repetition in the M nominal repetitions), and the second SRS resource set and the corresponding second TCI state are used for the second transmission of the first PUSCH (e.g., the second slot of the M consecutive slots, or the second repetition of the M nominal repetitions). The same mapping pattern continues to the remaining slots of the M consecutive slots. For example, for the 1st to 4th repeated transmissions, the corresponding SRS resource sets are respectively the first SRS resource set, the second SRS resource set, the first SRS resource set, and the second SRS resource set;
when M is greater than 2 (M>2), if the RRC information element “PUSCH configuration (RRC IE PUSCH-Config)” indicates a sequential mapping (i.e., the sequential mapping is enabled), the first SRS resource set and the corresponding first TCI state are used for the first transmission and the second transmission of the first PUSCH (e.g., the first slot and the second slot in the M consecutive slots, or the first repetition and the second repetition in the M nominal repetitions), and the second SRS resource set and the corresponding second TCI state are used for the third transmission and the fourth transmission of the first PUSCH (e.g., the third slot and the fourth slot in the M consecutive slots, or the third repetition and the fourth repetition in the M nominal repetitions). The same mapping pattern continues to the remaining slots of the M consecutive slots. For example, for the 1st to 8th repeated transmissions, the corresponding SRS resource sets are respectively the first SRS resource set, the first SRS resource set, the second SRS resource set, the second SRS resource set, the first SRS resource set, the first SRS resource set, the second SRS resource set, and the second SRS resource set.

Specifically, the first DCI is DCI format 0_1 or DCI format 0_2. In the case where the SRS resource indicator field in DCI format 0_1 or DCI format 0_2 indicates a fourth value (e.g., the codepoint is “11”):
when M is equal to 2 (M=2), the second SRS resource set and the corresponding second TCI state are used for the first transmission of the first PUSCH (e.g., the first slot in the M consecutive slots, or the first repetition in the M nominal repetitions), and the first SRS resource set and the corresponding first TCI state are used for the second transmission of the first PUSCH (e.g., the second slot of the M consecutive slots, or the second repetition of the M nominal repetitions);
when M is greater than 2 (M>2), if the RRC IE PUSCH-Config indicates a cyclic mapping (i.e., the cyclic mapping is enabled), the second SRS resource set and the corresponding second TCI state are used for the first transmission of the first PUSCH (e.g., the first slot in the M consecutive slots, or the first repetition in the M nominal repetitions), the first SRS resource set and the corresponding first TCI state are used for the second transmission of the first PUSCH (e.g., the second slot of the M consecutive slots, or the second repetition of the M nominal repetitions), and the same mapping pattern continues to the remaining slots of the M consecutive slots. For example, for the 1st to 4th repeated transmissions, the corresponding SRS resource sets are respectively the second SRS resource set, the first SRS resource set, the second SRS resource set, and the first SRS resource set.
when M is greater than 2 (M>2), if the RRC IE PUSCH-Config indicates a sequential mapping (i.e., the sequential mapping is enabled), the second SRS resource set and the corresponding second TCI state are used for the first and second transmissions of the first PUSCH (e.g., the first slot and the second slot in the M consecutive slots, or the first repetition and the second repetition in the M nominal repetitions), the first SRS resource set and the corresponding first TCI state are used for the third and fourth transmissions of the first PUSCH (e.g., the third and fourth slots in the M consecutive slots, or the third and fourth repetitions in the M nominal repetitions), and the same mapping pattern continues to the remaining slots of the M consecutive slots. For example, for the 1st to 8th repeated transmissions, the corresponding SRS resource sets are respectively the second SRS resource set, the second SRS resource set, the first SRS resource set, the first SRS resource set, the second SRS resource set, the second SRS resource set, the first SRS resource set, and the first SRS resource set.

The above solutions may be applicable to the case of K1=2 TCI states. The above solutions may also be applicable to the case of K1=1 TCI state, and in this case, the first TCI state and the second TCI state are the same TCI state, referring to the K1=1 TCI state.

For the case of K1=1 TCI state, there may also be other solutions. For example, only the first SRS resource set and the K1=1 TCI state are used to perform the first PUSCH transmission, and an example is that the first SRS resource set and the K1=1 TCI state are used to perform M repeated transmissions of the first PUSCH.

As another example, only the second SRS resource set and the K1=1 TCI state are used to perform the first PUSCH transmission, and an example is that the second SRS resource set and the K1=1 TCI state are used to perform M repeated transmissions of the first PUSCH.

As another example, the first DCI is DCI format 0_1 or DCI format 0_2. In this case, the value of the SRS resource set indicator field in DCI format 0_1 or DCI format 0_2 is restricted, that is, the filed can only take a portion of values, and cannot take the remaining values. For example, the filed can only take the above first value (e.g., the codepoint can only be “00”), or can only take the above second value (e.g., the codepoint can only be “01”), or can only take the first value and the second value in the above (e.g., the codepoint can only be “00” or “01”).

Optionally, the first SRS resource set corresponds to an indication field “SRS resource indicator” in the first DCI, and the second SRS resource set corresponds to an indication field “second SRS resource indicator” in the first DCI. For example, an SRI indicated by the indication field “SRS resource indicator” in the first DCI corresponds to an SRS resource in the first SRS resource set, and an SRI indicated by the indication field “second SRS resource indicator” in the first DCI corresponds to an SRS resource in the second SRS resource set.

In some implementations of Embodiment 1, the terminal device receives twelfth indication information transmitted by the network device, which is used to indicate that in a single transmission of the first PUSCH, the first TCI state and the second TCI state are used together to determine the transmission of the first PUSCH. For example, according to the twelfth indication information, in each transmission of the first PUSCH (if there are multiple transmissions), the terminal device determines an uplink transmit spatial filter or spatial relation corresponding to the first PUSCH according to both the first TCI state and the second TCI state.

Optionally, the twelfth indication information may be carried by one of the following: RRC signaling, MAC CE signaling, and DCI signaling.

Optionally, the twelfth indication information may be configured for a BWP, that is, the configuration granularity of the twelfth indication information is per BWP.

Optionally, the twelfth indication information is configured through RRC parameter “PUSCH-Config”.

In Embodiment 2, the terminal device determines transmission of a second PUSCH and an uplink transmit spatial filter or spatial relation corresponding to the second PUSCH according to the second information; where
the second PUSCH is a configured grant (CG) Type1 PUSCH, the second PUSCH corresponds to a first SRS resource and/or a second SRS resource, the first SRS resource is one of the two SRS resources, and the second SRS resource is another of the two SRS resources; and
the second information is at least one of the following: a TCI state associated with the first SRS resource, a TCI state associated with the second SRS resource, the first SRS resource, or the second SRS resource.

In Embodiment 2, the network device may configure one or more configured grant configurations for the terminal device, for example, configure one or more configured grants on one BWP through the RRC signaling. For ease of description, one of the configured grant configurations (the first configured grant configuration) is taken as an example to introduce the subsequent solutions.

Optionally, the first configured grant is a configured grant Type1.

Optionally, in a case where the first configured grant is the configured grant Type1, for the first configured grant, the network device makes the RRC parameter “configured grant configuration (configuredGrantConfig)” further include an RRC uplink grant configuration (rrc-ConfiguredUplinkGrant).

Specifically, for example, the first SRS resource is indicated by RRC parameter “SRS resource indicator (srs-ResourceIndicator)” in the RRC parameter “rrc-ConfiguredUplinkGrant” corresponding to the first configured grant.

Specifically, for example, the second SRS resource is indicated by RRC parameter “SRS resource indicator 2 (srs-ResourceIndicator2)” in the RRC parameter “rrc-ConfiguredUplinkGrant” corresponding to the first configured grant.

Optionally, the network device may also configure one or more of the following information for the first configured grant (e.g., through the RRC signaling):
frequency-domain frequency-hopping indication information, such as intra-slot hopping and inter-slot hopping;
demodulation reference signal (DMRS) indication information;
resource allocation indication information, such as time-domain resource allocation and/or frequency-domain resource allocation;
power control parameter indication information;
precoding indication information; SRS resource indicator information;
repeated transmission indication information; and
hybrid automatic repeat reQuest process (HARQ process) indication information.

In Embodiment 2, besides the information configured by the first configured grant configuration, a portion or all of the following information configured by RRC parameter “pusch-Config” is used:
a. a data scrambling identity of a PUSCH (dataScramblingIdentityPUSCH);
b. transmission configuration (txConfig);
c. a codebook subset (codebookSubset);
d. a maximum rank (maxRank); and
e. scaling of uplink control information (UCI) on PUSCH (scaling of UCI-OnPUSCH).

In some implementations of Embodiment 2, if the second PUSCH corresponds to the first SRS resource and the second SRS resource, the first SRS resource is associated with the first TCI state of the K1 TCI states, and the second SRS resource is associated with a second TCI state of the K1 TCI states. Therefore, an SRS resource may be directly associated with a TCI state so as to reduce intervening association objects and association complexity.

In some implementations of Embodiment 2, if the second PUSCH corresponds to the first SRS resource and the second SRS resource respectively belonging to the first SRS resource set and the second SRS resource set, and the first and second SRS resource sets are respectively associated with the first and second TCI states of the K1 TCI states, then the first SRS resource is associated with the first TCI state, and the second SRS resource is associated with the second TCI state. Therefore, employing the association between SRS resource sets and TCI states may be conducive to maintaining consistency in processing manner for different PUSCHs and reducing protocol complexity.

In some implementations of Embodiment 2, if the second PUSCH corresponds to the first SRS resource and the second SRS resource respectively belonging to the second SRS resource set and the first SRS resource set, and the first SRS resource set and the second SRS resource set are respectively associated with the first TCI state and the second TCI state of the K1 TCI states, then the first SRS resource is associated with the second TCI state, and the second SRS resource is associated with the first TCI state. Therefore, employing the association between SRS resource sets and TCI states may be conducive to maintaining consistency in processing manner for different PUSCHs and reducing protocol complexity.

In some implementations of Embodiment 2, in the case where the second PUSCH corresponds to the first SRS resource and the second SRS resource, the terminal device determines the uplink transmit spatial filter or spatial relation corresponding to the second PUSCH and the transmission of the second PUSCH according to the first TCI state, the first SRS resource, the second TCI state and the second SRS resource.

In some implementations of Embodiment 2, if the second PUSCH corresponds to the first SRS resource, the first SRS resource is associated with the first TCI state of the K1 TCI states.

In some implementations Embodiment 2, in a case where the second PUSCH corresponds to the first SRS resource, the terminal device determines the uplink transmit spatial filter or spatial relation corresponding to the second PUSCH and the transmission of the second PUSCH according to the first TCI state and the first SRS resource.

In some implementations of Embodiment 2, in a case where K1 is equal to 1 (K1=1) and the second PUSCH corresponds to the first SRS resource and the second SRS resource, the terminal device may determine the uplink transmit spatial filter or spatial relation corresponding to the second PUSCH and the transmission of the second PUSCH according to the first SRS resource and the K1=1 TCI state.

In some implementations of Embodiment 2, in a case where K1 is equal to 1 (K1=1) and the second PUSCH corresponds to the first SRS resource and the second SRS resource, the terminal device may determine the uplink transmit spatial filter or spatial relation corresponding to the second PUSCH and the transmission of the second PUSCH according to the second SRS resource and the K1=1 TCI state.

In some implementations of Embodiment 2, if the second PUSCH needs to be repeatedly transmitted for M times (for example, the second PUSCH may be transmitted in M consecutive slots; or in another example, the second PUSCH may include M nominal repetitions):
specifically, when M is equal to 2 (M=2), the first SRS resource corresponds to the first transmission of the second PUSCH (e.g., the first slot in the M consecutive slots, or the first repetition in the M nominal repetitions), and the second SRS resource corresponds to the second transmission of the second PUSCH (e.g., the second slot in the M consecutive slots, or the second repetition in the M nominal repetitions);
specifically, when M is greater than 2 (M>2), if RRC information element (IE) “configured grant configuration (ConfiguredGrantConfig)” indicates a cyclic mapping (that is, the cyclic mapping is enabled, e.g., the value of the mapping pattern (mappingPattern) is cyclicMapping), the first SRS resource and the second SRS resource are respectively applied to the first transmission and second transmission of the second PUSCH (e.g., the first slot and the second slot in the M consecutive slots, or the first repetition and the second repetition in the M nominal repetitions), and the same mapping pattern continues to the remaining slots of M consecutive slots. For example, for the 1st to 4th repeated transmissions, the corresponding SRS resources are respectively the first SRS resource, the second SRS resource, the first SRS resource and the second SRS resource;
specifically, when M is greater than 2 (M>2), if the RRC information element (IE) “configured grant configuration (ConfiguredGrantConfig)” indicates a sequential mapping (that is, the sequential mapping is enabled, e.g., the value of the mapping pattern (mappingPattern) is sequentialMapping), the first SRS resource is applied to the first transmission and the second transmission of the second PUSCH (e.g., the first slot and the second slot in the M consecutive slots, or the first repetition and the second repetition in the M nominal repetitions), and the second SRS resource is applied to the third transmission and the fourth transmission of the second PUSCH (e.g., the third slot and the fourth slot in the M consecutive slots, or the third repetition and the fourth repetition in the M nominal repetitions). The same mapping pattern continues to the remaining slots of the M consecutive slots. For example, the 1st to 8th repeated transmissions, the corresponding SRS resources are respectively the first SRS resource, the first SRS resource, the second SRS resource, the second SRS resource, the first SRS resource, the first SRS resource, the first SRS resource, the second SRS resource and the second SRS resource.

The above solutions may be applicable to the case of K1=2 TCI states. The above solutions may also be applicable to the case of K1=1 TCI state, and in this time, the first TCI state and the second TCI state are the same TCI state, referring to the K1=1 TCI state, and the first SRS resource and the second SRS resource are used to determine the transmission of the second PUSCH.

For the case of K1=1 TCI state, there may also be other solutions.

For example, only the first SRS resource and the K1=1 TCI state are used to perform the second PUSCH transmission, and an example is that the first SRS resource and the K1=1 TCI state are used to perform M repetition transmissions of the second PUSCH. Therefore, only one of the SRS resources is used, which may reduce complexity of product implementation.

As another example, only the second SRS resource and the K1=1 TCI state are used to perform the second PUSCH transmission, and an example is that the second SRS resource and the K1=1 TCI state are used to perform M repeated transmissions of the second PUSCH. Therefore, only one of the SRS resources is used, which may reduce complexity of product implementation.

In some implementations of Embodiment 2, the first SRS resource set corresponds to an RRC parameter “srs-ResourceIndicator” in the RRC parameter “rrc-ConfiguredUplinkGrant” corresponding to the first configured grant, and the second SRS resource set corresponds to an RRC parameter “srs-ResourceIndicator2” in the RRC parameter “rrc-ConfiguredUplinkGrant” corresponding to the first configured grant. For example, the SRI indicated by the RRC parameter “srs-ResourceIndicator” in the RRC parameter “rrc-ConfiguredUplinkGrant” corresponding to the first configured grant corresponds to an SRS resource in the first SRS resource set, and the SRI indicated by the RRC parameter “srs-ResourceIndicator2” in the RRC parameter “rrc-ConfiguredUplinkGrant” corresponding to the first configured grant corresponds to an SRS resource in the second SRS resource set.

In some implementations of Embodiment 2, the terminal device receives thirteenth indication information transmitted by the network device, and the thirteenth indication information is used to indicate that in a single transmission of the second PUSCH, the first TCI state and the second TCI state are used together to determine the transmission of the second PUSCH. For example, according to the thirteenth indication information, in each PUSCH transmission with CG PUSCH type1 (if there are multiple transmissions), the terminal device determines the uplink transmit spatial filter or spatial relation corresponding to the second PUSCH according to both the first TCI state and the second TCI state.

Optionally, the thirteenth indication information may be carried by one of the following: RRC signaling, MAC CE, and DCI signaling.

Optionally, the thirteenth indication information may be configured for a BWP, that is, the configuration granularity of the thirteenth indication information is per BWP.

Optionally, the thirteenth indication information is configured for the first configured grant, that is, the configuration granularity of the thirteenth indication information is per configured grant.

Optionally, the thirteenth indication information is configured through RRC parameter “configuredGrantConfig”.

In Embodiment 3, the terminal device receives second DCI. The second DCI is used to activate a third PUSCH, and the third PUSCH is a CG Type2 PUSCH and corresponds to a third SRS resource and/or a fourth SRS resource. The third SRS resource is one of the two SRS resources, and the fourth SRS resource is another of the two SRS resources. The terminal device may further determine an uplink send spatial filter or spatial relation corresponding to the third PUSCH and t transmission of the third PUSCH according to third information. The third information is at least one of the following: a TCI state associated with the third SRS resource, a TCI state associated with the fourth SRS resource, the third SRS resource, and the fourth SRS resource.

In Embodiment 3, the network device may configure one or more configured grant configurations for the terminal device, for example, configure one or more configured grants on one BWP through the RRC signaling. For ease of description, one of the configured grant configurations (the first configured grant configuration) is taken as an example to introduce the subsequent solutions.

Optionally, the first configured grant is a configured grant Type2.

Optionally, in a case where the first configured grant is the configured grant Type2, for the first configured grant, the network device makes the RRC parameter “configured grant configuration (configuredGrantConfig)” exclude the RRC uplink grant configuration (rrc-ConfiguredUplinkGrant).

Specifically, for example, the third SRS resource is indicated by RRC parameter “SRS resource indicator (srs-ResourceIndicator)” in the RRC parameter “rrc-ConfiguredUplinkGrant” corresponding to the first configured grant.

Specifically, for example, the fourth SRS resource is indicated by RRC parameter “SRS resource indicator 2” (srs-ResourceIndicator2) in the RRC parameter “rrc-ConfiguredUplinkGrant” corresponding to the first configured grant.

Optionally, the network device may also configure one or more of the following information for the first configured grant (e.g., through the RRC signaling):
frequency-domain frequency-hopping indication information, such as intra-slot hopping and inter-slot hopping;
demodulation reference signal (DMRS) indication information;
resource allocation indication information, such as time-domain resource allocation and/or frequency-domain resource allocation;
power control parameter indication information;
precoding indication information; SRS resource indicator information;
repeated transmission indication information; and
HARQ process indication information.

In Embodiment 3, in a case where DCI format 0_0 or DCI format 0_1 is used to activate the first configured grant, besides the information configured by the first configured grant configuration, a portion or all of the following information configured by RRC parameter “pusch-Config” is used for the transmission of the third PUSCH or the third PUSCH corresponding to the first configured grant configuration:
a. a data scrambling identity of a PUSCH (dataScramblingIdentityPUSCH);
b. transmission configuration (txConfig);
c. a codebook subset (codebookSubset);
d. a maximum rank (maxRank); and
e. scaling of UCI on PUSCH (scaling of UCI-OnPUSCH).

In Embodiment 3, in a case where DCI format 0_2 is used to activate the first configured grant, besides the information configured by the first configured grant configuration, a portion or all of the following information configured by RRC parameter “pusch-Config” is used for the transmission of the third PUSCH:
a. a data scrambling identity of a PUSCH (dataScramblingIdentityPUSCH);
b. transmission configuration (txConfig);
c. a codebook subset DCI-0-2 (codebookSubsetDCI-0-2);
d. a maximum rank DCI-0-2 (maxRankDCI-0-2);
e. scaling of UCI on PUSCH (scaling of UCI-OnPUSCH), a granularity of resource allocation Type1 DCI-0-2 (resourceAllocationType1GranularityDCI-0-2).

In Embodiment 3, the second DCI may be DCI format 0_0, DCI format 0_1, or DCI format 0_2.

In Embodiment 3, the second DCI meets one or more of the following conditions:
CRC used for the second DCI is scrambled by the following parameters: a configured scheduling radio network temporary identity (CS-RNTI) configured by a parameter cs-RNTI, or a group configured scheduling radio network temporary identity (G-CS-RNTI) configured by a parameter g-cs-RNTI;
the new data indication field in the second DCI is set to 0;
if the second DCI includes the configured grant downlink feedback information (CG-DFI) indication field, this field is set to 0;
the time-domain resource allocation indication field in the second DCI indicates that the second DCI corresponds to a row indicated by the start and length indicator value (SLIV).

Optionally, in a case where there is only one first configured grant, as shown in Table 1, some domains in the DCI for activating the first configured grant are specified as follows.

TABLE 1

| | DCI format | DCI format | |
|---|---|---|---|
| | 0_0/0_1/0_2 | 1_0/1_2/4_1 | DCI format 1_1/4_2 |
| HARQ process number | Set to all ‘0’s | Set to all ‘0’s | Set to all ‘0’s |
| RV | Set to all ‘0’s | Set to all ‘0’s | Enabled transport |
| | | | block: set to all ‘0’s |

Optionally, in a case where there are a plurality of first configured grants, as shown in Table 2, some domains in the DCI for activating the first configured grants are specified as follows.

TABLE 2

| | DCI format | DCI format | |
|---|---|---|---|
| | 0_0/0_1/0_2 | 1_0/1_2/4_1 | DCI format 1_1/4_2 |
| RV | Set to all ‘0’s | Set to all ‘0’s | Enabled transport |
| | | | blocks: set to all ‘0’s |

In some implementations of Embodiment 3, the third SRS resource is specified by a first SRS resource indicator field in the second DCI, and/or the fourth SRS resource is specified by a second SRS resource indicator field in the second DCI. Therefore, according to a preset rule, a fixed field in DCI may be used to determine an SRS resource, so as to reduce the complexity of product implementation.

In some implementations of Embodiment 3, in a case where the second DCI is DCI format 0_0, the third PUSCH corresponds to the third SRS resource.

In some implementations of Embodiment 3, in a case where the second DCI is DCI format 0_1 or DCI format 0_2, and the SRS resource set indicator field in the second DCI indicates a first value, the third PUSCH corresponds to the third SRS resource; or
in a case where the second DCI is DCI format 0_1 or DCI format 0_2, and the SRS resource set indicator field in the second DCI indicates a second value, the third PUSCH corresponds to the fourth SRS resource; or
in a case where the second DCI is DCI format 0_1 or DCI format 0_2, and the SRS resource set indicator field in the second DCI indicates a third value, the third PUSCH corresponds to the third SRS resource and the fourth SRS resource, where the third SRS resource is specified by the first SRS resource indicator field in the second DCI, and the fourth SRS resource is specified by the second SRS resource indicator field in the second DCI; or
in a case where the second DCI is DCI format 0_1 or DCI format 0_2, and the SRS resource set indicator field in the second DCI indicates a fourth value, the third PUSCH corresponds to the third SRS resource and the fourth SRS resource, where the third SRS resource is specified by the second SRS resource indicator field in the second DCI, and the fourth SRS resource is specified by the first SRS resource indicator field in the second DCI.

Optionally, in a case where the second DCI is DCI format 0_1 or DCI format 0_2, if the indication field, i.e., the SRS resource set indicator, in the second DCI indicates the first value (e.g., the codepoint is “00”), the third PUSCH corresponds to the third SRS resource.

Optionally, in a case where the second DCI is DCI format 0_1 or DCI format 0_2, if the indication field, i.e., the SRS resource set indicator, in the second DCI indicates the second value (e.g., the codepoint is “01”), the third PUSCH corresponds to the fourth SRS resource.

Optionally, in a case where the second DCI is DCI format 0_1 or DCI format 0_2, if the indication field, i.e., the SRS resource set indicator, in the second DCI indicates the third value (e.g., the codepoint is “10”), the third PUSCH corresponds to the third SRS resource and the fourth SRS resource, and the third SRS resource and the fourth SRS resource are respectively specified by the indication fields “SRS resource indicator” and “Second SRS resource indicator” in the second DCI.

Optionally, in a case where the second DCI is DCI format 0_1 or DCI format 0_2, if the indication field, i.e., SRS resource set indicator, in the second DCI indicates the fourth value (e.g., the codepoint is “11”), the third PUSCH corresponds to the third SRS resource and the fourth SRS resource, and the fourth SRS resource and the third SRS resource are respectively specified by the indication fields “SRS resource indicator” and “Second SRS resource indicator” in the second DCI.

Therefore, the SRS resource corresponding to the third PUSCH may be determined based on the SRS resource set indicator field in the second DCI so as to increase the flexibility of the system.

In some implementations of Embodiment 3, in a case where the second DCI is DCI format 0_1 or DCI format 0_2, and the SRS resource set indicator field in the second DCI indicates a first value, the third PUSCH corresponds to the third SRS resource; or
in a case where the second DCI is DCI format 0_1 or DCI format 0_2, and the SRS resource set indicator field in the second DCI indicates a second value, the third PUSCH corresponds to the fourth SRS resource; or
in a case where the second DCI is DCI format 0_1 or DCI format 0_2, and the SRS resource set indicator field in the second DCI indicates a third value, the third PUSCH corresponds to the third SRS resource and the fourth SRS resource, where the third SRS resource is specified by the first SRS resource indicator field in the second DCI, and the fourth SRS resource is specified by the second SRS resource indicator field in the second DCI; or
in a case where the second DCI is DCI format 0_1 or DCI format 0_2, and the SRS resource set indicator field in the second DCI indicates a fourth value, the third PUSCH corresponds to the third SRS resource and the fourth SRS resource, where the third SRS resource is specified by the first SRS resource indicator field in the second DCI, and the fourth SRS resource is specified by the second SRS resource indicator field in the second DCI.

Optionally, in a case where the second DCI is DCI format 0_1 or DCI format 0_2, if the indication field, i.e., the SRS resource set indicator, in the second DCI indicates the first value (e.g., the codepoint is “00”), the third PUSCH corresponds to the third SRS resource.

Optionally, in a case where the second DCI is DCI format 0_1 or DCI format 0_2, if the indication field, i.e., the SRS resource set indicator, in the second DCI indicates the second value (e.g., the codepoint is “01”), the third PUSCH corresponds to the fourth SRS resource.

Optionally, in a case where the second DCI is DCI format 0_1 or DCI format 0_2, if the indication field, i.e., the SRS resource set indicator, in the second DCI indicates the third value (e.g., the codepoint is “10”), the third PUSCH corresponds to the third SRS resource and the fourth SRS resource, and the third SRS resource and the fourth SRS resource are respectively specified by the indication fields “SRS resource indicator” and “Second SRS resource indicator” in the second DCI.

Optionally, in a case where the second DCI is DCI format 0_1 or DCI format 0_2, if the indication field, i.e., the SRS resource set indicator, in the second DCI indicates the fourth value (e.g., the codepoint is “11”), the third PUSCH corresponds to the third SRS resource and the fourth SRS resource, and the third SRS resource nd the fourth SRS resource are respectively specified by the indication fields “SRS resource indicator” and “Second SRS resource indicator” in the second DCI.

Therefore, the SRS resources corresponding to the third PUSCH may be determined based on the SRS resource set indicator field in the second DCI so as to increase the flexibility of the system.

In some implementations of Embodiment 3, if the third PUSCH corresponds to the third SRS resource and the fourth SRS resource, the third SRS resource is associated with a first TCI state of the K1 TCI states, and the fourth SRS resource is associated with a second TCI state of the K1 TCI states. Therefore, an SRS resource may be directly associated with a TCI state so as to reduce intervening association objects and association complexity.

In some implementations of Embodiment 3, if the third PUSCH corresponds to the third SRS resource and the fourth SRS resource respectively belonging to the first SRS resource set and the second SRS resource set, and the first SRS resource set and the second SRS resource set are respectively associated with the first and second TCI states of the K1 TCI states, then the third SRS resource is associated with the first TCI state, and the fourth SRS resource is associated with the second TCI state. Therefore, employing the association between SRS resource sets and TCI states may be conducive to maintaining consistency in processing manner for different PUSCHs and reducing protocol complexity.

In some implementations of Embodiment 3, if the third PUSCH corresponds to the third SRS resource and the fourth SRS resource respectively belonging to the second SRS resource set, and the first SRS resource set, and the first SRS resource set and the second SRS resource set are respectively associated with the first TCI state and the second TCI state of the K1 TCI states, then the third SRS resource is associated with the second TCI state, and the fourth SRS resource is associated with the first TCI state. Therefore, employing the association between SRS resource sets and TCI states may be conducive to maintaining consistency in processing manner for different PUSCHs and reducing protocol complexity.

In some implementations of Embodiment 3, in the case where the third PUSCH corresponds to the third SRS resource and the fourth SRS resource, the terminal device determines the uplink transmit spatial filter or spatial relation corresponding to the third PUSCH and the transmission of the third PUSCH according to the first TCI state, the third SRS resource, the second TCI state and the fourth SRS resource.

In some implementations of Embodiment 3, if the third PUSCH corresponds to the third SRS resource, the third SRS resource is associated with the first TCI state of the K1 TCI states.

In some implementations of Embodiment 3, if the third PUSCH corresponds to the third SRS resource, the terminal device determines the uplink transmit spatial filter or spatial relation corresponding to the third PUSCH and the transmission of the third PUSCH according to the first TCI state and the third SRS resource.

In some implementations of Embodiment 3, in a case where K1 is equal to 1 (K1=1) and the third PUSCH corresponds to the third SRS resource and the fourth SRS resource, the terminal device determines the uplink transmit spatial filter or spatial relation corresponding to the third PUSCH and the transmission of the third PUSCH according to the third SRS resource and the K1=1 TCI state.

In some implementations of Embodiment 3, in a case where K1 is equal to 1 (K1=1) and the third PUSCH corresponds to the third SRS resource and the fourth SRS resource, the terminal device determines the uplink transmit spatial filter or spatial relation corresponding to the third PUSCH and the transmission of the third PUSCH according to the fourth SRS resource and the K1=1 TCI state.

In some implementations of Embodiment 3, if the third PUSCH needs to be repeatedly transmitted for M times (for example, the third PUSCH may be transmitted in M consecutive slots; or in another example, the third PUSCH may include M nominal repetitions):
in some implementations, in a case where the second DCI is DCI format 0_1 or DCI format 0_2, when the indication field “SRS resource set indicator” in DCI format 0_1 or DCI format 0_2 indicates a first value (e.g., the codepoint is “00”), the first SRS resource set and the corresponding first TCI state are used for M repeated transmissions of the third PUSCH;
in some implementations, in a case where the second DCI is DCI format 0_1 or DCI format 0_2, when the indication field “SRS resource set indicator” in DCI format 0_1 or DCI format 0_2 indicates a second value (e.g., the codepoint is “01”), the second SRS resource set and the corresponding second TCI state are used for M repeated transmissions of the third PUSCH;
in some implementations, in a case where the second DCI is DCI format 0_1 or DCI format 0_2, when the indication field “SRS resource set indicator” in DCI format 0_1 or DCI format 0_2 indicates a third value (e.g., the codepoint is “10”), according to different values of M, there may be the following cases:
   when M is equal to 2 (M=2), the first SRS resource set and the corresponding first TCI state are used for the first transmission of the third PUSCH (e.g., the first slot in the M consecutive slots, or the first repetition in the M nominal repetitions), and the second SRS resource set and the corresponding second TCI state are used for the second transmission of the third PUSCH (e.g., the second slot in the M consecutive slots, or the second repetition in the M nominal repetitions);
   when M is greater than 2 (M>2), if the RRC IE PUSCH-Config indicates a cyclic mapping (i.e., the cyclic mapping is enabled), the first SRS resource set and the corresponding first TCI state are used for the first transmission of the third PUSCH (e.g., the first slot in the M consecutive slots, or the first repetition in the M nominal repetitions), and the second SRS resource set and corresponding the second TCI state are used for the second transmission of the third PUSCH (e.g., the second slot in the M consecutive slots, or the second repetition in the M nominal repetitions). The same mapping pattern continues to the remaining slots of the M consecutive slots. For example, for the 1st to 4th repeated transmissions, the corresponding SRS resource sets are respectively the first SRS resource set, the second SRS resource set, the first SRS resource set, and the second SRS resource set;
   when M is greater than 2 (M>2), if the RRC IE PUSCH-Config indicates a sequential mapping (i.e., the sequential mapping is enabled), the first SRS resource set and the corresponding first TCI state are used for the first transmission and second transmission of the third PUSCH (e.g., the first slot and the second slot in the M consecutive slots, or the first repetition and the second repetition in the M nominal repetitions), and the second SRS resource set and the corresponding second TCI state are used for the third transmission and fourth transmission of the third PUSCH (e.g., the third slot and fourth slot in M consecutive slots, or the third repetition and fourth repetition in M nominal repetitions). The same mapping pattern continues to the remaining slots of the M consecutive slots. For example, for the 1st to 8th repeated transmissions, the corresponding SRS resource sets are respectively the first SRS resource set, the first SRS resource set, the second SRS resource set, the second SRS resource set, the first SRS resource set, the first SRS resource set, the second SRS resource set, and the second SRS resource set.

In some implementations, in a case where the second DCI is DCI format 0_1 or DCI format 0_2, when the indication field “SRS resource set indicator” in DCI format 0_1 or DCI format 0_2 indicates a fourth value (e.g., the codepoint is “11”), according to different values of M, there may be the following cases:
when M is equal to 2 (M=2), the second SRS resource set and the corresponding second TCI state are used for the first transmission of the third PUSCH (e.g., the first slot in the M consecutive slots, or the first repetition in the M nominal repetitions), and the first SRS resource set and the corresponding first TCI state are used for the second transmission of the third PUSCH (e.g., the second slot in the M consecutive slots, or the second repetition in the M nominal repetitions);
when M is greater than 2 (M>2), if the RRC IE PUSCH-Config indicates a cyclic mapping (i.e., the cyclic mapping is enabled), the second SRS resource set and the corresponding second TCI state are used for the first transmission of the third PUSCH, and the first SRS resource set and the corresponding first TCI state are used for the second transmission of the third PUSCH. The same mapping pattern continues to the remaining slots of the M consecutive slots. For example, for the 1st to 4th repeated transmissions, the corresponding SRS resource sets are respectively the second SRS resource set, the first SRS resource set, the second SRS resource set, and the first SRS resource set;
when M is greater than 2 (M>2), if the RRC IE PUSCH-Config indicates a sequential mapping (i.e., the sequential mapping is enabled), the second SRS resource set and the corresponding second TCI state are used for the first transmission and second transmission of the third PUSCH, and the first SRS resource set and the corresponding first TCI state are used for the third transmission and fourth transmission of the third PUSCH. The same mapping pattern continues to the remaining slots of the M consecutive slots. For example, for the 1st to 8th repeated transmissions, the corresponding SRS resource sets are respectively the second SRS resource set, the second SRS resource set, the first SRS resource set, the first SRS resource set, the second SRS resource set, the second SRS resource set, the first SRS resource set, and the first SRS resource set.

The above solutions may be applicable to the case of K1=2 TCI states. The above solutions may also be applicable to the case of K1=1 TCI state, and in this time, the first TCI state and the second TCI state are the same TCI state, referring to the K1=1 TCI state, and the third SRS resource and the fourth SRS resource are used to determine the transmission of the third PUSCH.

For the case of K1=1 TCI state, there may also be other solutions.

For example, only the third SRS resource and the K1=1 TCI state are used to perform a third PUSCH transmission, and an example is that the third SRS resource and the K1=1 TCI state are used to perform M repetition transmissions of the third PUSCH. Therefore, only one of the SRS resources is used, which may reduce complexity of product implementation.

As another example, only the fourth SRS resource and the K1=1 TCI state are used to perform the third PUSCH transmission, and an example is that the fourth SRS resource and the K1=1 TCI state are used to perform M repeated transmissions of the third PUSCH. Therefore, only one of the SRS resources is used, which may reduce complexity of product implementation.

Optionally, the first SRS resource set corresponds to the indication field “SRS resource indicator” in the second DCI, and the second SRS resource set corresponds to the indication field “Second SRS resource indicator” in the second DCI. For example, an SRI indicated by the indication field “SRS resource indicator” in the second DCI corresponds to an SRS resource in the first SRS resource set, and an SRI indicated by the indication field “Second SRS resource indicator” in the second DCI corresponds to an SRS resource in the second SRS resource set.

In some implementations of Embodiment 3, the terminal device receives fourteenth indication information transmitted by the network device, and the fourteenth indication information indicates that in a single transmission of the third PUSCH, the first TCI state and the second TCI state are used together to determine the transmission of the third PUSCH. For example, according to the fourteenth indication information, in each PUSCH transmission with CG PUSCH type2 (if there are multiple transmissions), the terminal device determines the uplink transmit spatial filter or spatial relation corresponding to the third PUSCH according to both the first TCI state and the second TCI state.

Optionally, the fourteenth indication information may be carried by one of the following: RRC signaling, MAC CE, and DCI signaling.

Optionally, the fourteenth indication information is configured for a BWP, that is, the configuration granularity of the fourteenth indication information is per BWP.

Optionally, the fourteenth indication information is configured for the first configured grant, that is, the configuration granularity of the fourteenth indication information is per configured grant.

Optionally, the fourteenth indication information is configured through RRC parameter “configuredGrantConfig”.

Optionally, the thirteenth indication information and the fourteenth indication information correspond to the same RRC parameter.

In some embodiments, the terminal device determines the uplink transmission, according to the first SRS resource set and/or the second SRS resource set, and the TCI state(s) corresponding to the SRS resource set(s) (e.g., the first TCI state and/or the second TCI state) that are determined based on the above solutions.

In some embodiments, the terminal device determines the uplink transmission, according to the first SRS resource and/or the second SRS resource, and the TCI state(s) corresponding to the SRS resource(s) (e.g., the first TCI state and/or the second TCI state) that are determined based on the above solutions.

In some embodiments, the terminal device determines the uplink transmission, according to the third SRS resource and/or the fourth SRS resource, and the TCI state(s) corresponding to the SRS resource(s) (e.g., the first TCI state and/or the second TCI state) that are determined based on the above solutions.

Therefore, in the embodiments of the present application, the first SRS resource set is associated with one of K1 TCI states, and/or the second SRS resource set is associated with one of K1 TCI states, in other words, TCI state(s) associated with the first SRS resource set and/or the second SRS resource set are clarified, so that an uplink transmit spatial filter or spatial relation corresponding to a PUSCH associated with the first SRS resource set may be determined based on the first SRS resource set and the TCI state associated with the first SRS resource, and/or an uplink transmit spatial filter or spatial relation corresponding to a PUSCH associated with the second SRS resource set may be determined based on the second SRS resource set and the TCI state associated with the second SRS resource.

Alternatively, in the embodiments of the present application, a portion or all of two SRS resources are associated with TCI state(s) in K1 TCI states, in other words, an association between the portion or all of the two SRS resources and TCI state(s) is clarified, so that an uplink transmit spatial filter or spatial relation corresponding to a PUSCH associated with an SRS resource may be determined based on the SRS resource and the TCI state associated with the SRS resource.

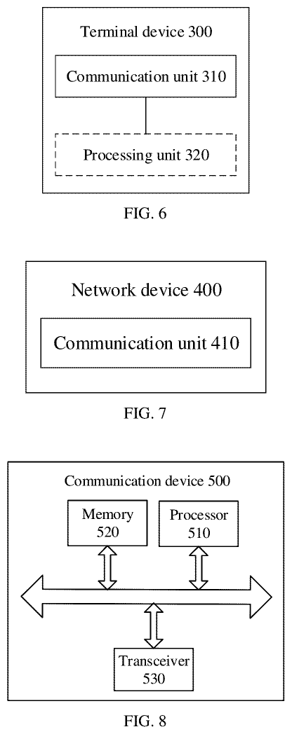

With reference to FIG. 5, the method embodiments of the present application are described in detail above. The device embodiments of the present application will be described in detail below with reference to FIGS. 6 to 10. It should be understood that the device embodiments and the method embodiments correspond to each other, and similar descriptions may refer to the method embodiments.

FIG. 6 shows a schematic block diagram of a terminal device 300 according to the embodiments of the present application. As shown in FIG. 6, the terminal device 300 includes:
a communication unit 310 configured to receive first indication information, where the first indication information is used to indicate a first sounding reference signal (SRS) resource set and a second SRS resource set, and both the first SRS resource set and the second SRS resource set are used for a codebook based or non-codebook based physical uplink shared channel (PUSCH);
where the first SRS resource set is associated with one of K1 transmission configuration indicator (TCI) states, and/or the second SRS resource set is associated with one of the K1 TCI states; or a portion or all of two SRS resources indicated by the first indication information are associated with TCI state(s) in the K1 TCI states;
where the K1 TCI states are currently activated TCI states corresponding to uplink transmission, and K1 is a positive integer.

In some embodiments, in a case where the first SRS resource set is associated with one of the K1 TCI states, and/or the second SRS resource set is associated with one of the K1 TCI states, and K1 is greater than 1 (K1>1), the first SRS resource set is associated with a first TCI state of the K1 TCI states, and the second SRS resource set is associated with a second TCI state of the K1 TCI states; and/or
in a case where the first SRS resource set is associated with one of the K1 TCI states, and/or the second SRS resource set is associated with one of the K1 TCI states, and the K1 TCI states only include a first TCI state, the first SRS resource set and the second SRS resource set are associated with the first TCI state, or the first SRS resource set is associated with the first TCI state and the second SRS resource set is not associated with any TCI state.

In some embodiments, in a case where the portion or all of the two SRS resources indicated by the first indication information are associated with TCI state(s) in the K1 TCI states, and K1 is greater than 1 (K1>1), one of the two SRS resources is associated with one TCI state in the K1 TCI states, and another of the two SRS resources is associated with another TCI state in the K1 TCI states; and/or
in a case where the portion or all of the two SRS resources indicated by the first indication information are associated with TCI state(s) in the K1 TCI states, and K1 is equal to 1 (K1=1), the two SRS resources are associated with the first TCI state of the K1 TCI states, or one of the two SRS resources is associated with one TCI state in the K1 TCI states and another of the two SRS resources is not associated with any TCI state.

In some embodiments, in a case where K1 is greater than 1 (K1>1), the first TCI state is determined based on TCI state identities of the K1 TCI states, and/or the second TCI state is determined based on the TCI state identities of the K1 TCI states.

In some embodiments, the first TCI state is a TCI state with the smallest identity among the K1 TCI states, and/or the second TCI state is a TCI state with the largest identity among the K1 TCI states; or
the first TCI state is the TCI state with the largest identity among the K1 TCI states, and/or the second TCI state is the TCI state with the smallest identity among the K1 TCI states.

In some embodiments, in a case where K1 is greater than 1 (K1>1), the first TCI state is determined based on position information of the K1 TCI states in second indication information, and/or the second TCI state is determined based on the position information of the K1 TCI states in the second indication information;
where the second information is indication information transmitted by a network device and used at least to indicate or activate TCI states, and TCI states indicated or activated by the second indication information include at least the K1 TCI states.

In some embodiments, the first TCI state is a TCI state among the K1 TCI states with the most forward position in the second indication information, and/or the second TCI state is a TCI state among the K1 TCI states with the most rearward position in the second indication information; or
the first TCI state is the TCI state among the K1 TCI states with the most rearward position in the second indication information, and/or the second TCI state is the TCI state among the K1 TCI states with the most forward position in the second indication information.

In some embodiments, in a case where K1 is greater than 1 (K1>1), the first TCI state is indicated by the network device through third indication information, and/or the second TCI state is indicated by the network device through fourth indication information.

In some embodiments, the third indication information is used to indicate that the first TCI state is the TCI state with the smallest identity among the K1 TCI states, or the third indication information is used to indicate that the first TCI state is the TCI state with the largest identity among the K1 TCI states, or the third indication information is used to indicate that the first TCI state is the TCI state among the K1 TCI states with the most forward position in second indication information, or the third indication information is used to indicate that the first TCI state is the TCI state among the K1 TCI states with the most rearward position in the second indication information;
where the second indication information is indication information transmitted by the network device and used at least to indicate or activate TCI states, and the TCI states indicated or activated by the second indication information include at least the K1 TCI states.

In some embodiments, the fourth indication information is used to indicate that the second TCI state is the TCI state with the smallest identity among the K1 TCI states, or the fourth indication information is used to indicate that the second TCI state is the TCI state with the largest identity among the K1 TCI states, or the fourth indication information is used to indicate that the second TCI state is the TCI state among the K1 TCI states with the most forward position in second indication information, or the fourth indication information is used to indicate that the second TCI state is the TCI state among the K1 TCI states with the most rearward position in the second indication information;
where the second indication information is indication information transmitted by the network device and used at least to indicate or activate TCI states, and the TCI states indicated or activated by the second indication information include at least the K1 TCI states.

In some embodiments, in a case where the terminal device fails to obtain the third indication information, or in a case where the network device does not configure the third indication information, the first TCI state is the TCI state with the smallest identity among the K1 TCI states; and/or in a case where the terminal device has obtained the third indication information, or in a case where the network device has configured the third indication information, the first TCI state is the TCI state with the largest identity among the K1 TCI states; or
in the case where the terminal device fails to obtain the third indication information, or in a case where the network device does not configure the third indication information, the first TCI state is the TCI state with the largest identity among the K1 TCI states; and/or in the case where the terminal device has obtained the third indication information, or in the case where the network device has configured the third indication information, the first TCI state is the TCI state with the smallest identity among the K1 TCI states.

In some embodiments, in a case where the terminal device fails to obtain the fourth indication information, or in a case where the network device does not configure the fourth indication information, the second TCI state is the TCI state with the smallest identity among the K1 TCI states; and/or in a case where the terminal device has obtained the fourth indication information, or in a case where the network device has configured the fourth indication information, the second TCI state is the TCI state with the largest identity among the K1 TCI states; or
in the case where the terminal device fails to obtain the fourth indication information, or in the case where the network device does not configure the fourth indication information, the second TCI state is the TCI state with the largest identity among the K1 TCI states; and/or in a case where the terminal device has obtained the fourth indication information, or in the case where the network device has configured the fourth indication information, the second TCI state is the TCI state with the smallest identity among the K1 TCI states.

In some embodiments, in a case where the third indication information has a first value, the first TCI state is the TCI state with the smallest identity among the K1 TCI states; and/or in a case where the third indication information has a second value, the first TCI state is the TCI state with the largest identity among the K1 TCI states; or
in the case where the third indication information has the first value, the first TCI state is the TCI state with the largest identity among the K1 TCI states; and/or in the case where the third indication information has the second value, the first TCI state is the TCI state with the smallest identity among the K1 TCI states.

In some embodiments, in a case where the fourth indication information has a first value, the second TCI state is the TCI state with the smallest identity among the K1 TCI states; and/or in a case where the fourth indication information has a second value, the second TCI state is the TCI state with the largest identity among the K1 TCI states; or
in the case where the fourth indication information has the first value, the second TCI state is the TCI state with the largest identity among the K1 TCI states; and/or in the case where the fourth indication information has the second value, the second TCI state is the TCI state with the smallest identity among the K1 TCI states.

In some embodiments, the third indication information is included in configuration information of the first SRS resource set, and/or the fourth indication information is included in configuration information of the second SRS resource set.

In some embodiments, in a case where the configuration information of the first SRS resource set includes the third indication information, the configuration information of the first SRS resource set does not include an SRS following a unified TCI state followUnifiedTCIstateSRS, or the configuration information of the first SRS resource set includes a disabled followUnifiedTCIstateSRS, or the terminal device ignores a followUnifiedTCIstateSRS included in the configuration information of the first SRS resource set; and/or
in a case where the configuration information of the second SRS resource set includes the fourth indication information, the configuration information of the second SRS resource set does not include a followUnifiedTCIstateSRS, or the configuration information of the second SRS resource set includes a disabled followUnifiedTCIstateSRS, or the terminal device ignores a followUnifiedTCIstateSRS included in the configuration information of the second SRS resource set.

In some embodiments, in a case where K1 is greater than 1 (K1>1), an uplink transmit spatial filter or spatial relation corresponding to the first SRS resource set is determined based on the first TCI state, and/or an uplink transmit spatial filter or spatial relation corresponding to the second SRS resource set is determined based on the second TCI state; and/or
in the case where K1 is greater than 1 (K1>1), an uplink transmit spatial filter or spatial relation corresponding to a PUSCH associated with the first SRS resource set is determined based on the first TCI state and/or the first SRS resource set, and/or an uplink transmit spatial filter or spatial relation corresponding to a PUSCH associated with the second SRS resource set is determined based on the second TCI state and/or the second SRS resource set.

In some embodiments, in a case where K1 is equal to 1 (K1=1), uplink transmit spatial filters or spatial relations respectively corresponding to the first SRS resource set and the second SRS resource set are both determined based on the first TCI state; or the uplink transmit spatial filter or spatial relation corresponding to the first SRS resource set is determined based on the first TCI state, and the second SRS resource set is not considered in the current PUSCH transmission; and/or
in the case where K1 is equal to 1 (K1=1), the uplink transmit spatial filters or spatial relations respectively corresponding to the PUSCH associated with the first SRS resource set and the PUSCH associated with the second SRS resource set are both determined based on the first TCI state and/or the first SRS resource set; and/or the uplink transmit spatial filter or spatial relation corresponding to the PUSCH associated with the first SRS resource set is determined based on the first TCI state and the first SRS resource set, and the second SRS resource set is not considered in the current PUSCH transmission.

In some embodiments, the K1 TCI states belong to N TCI states;
where at least a portion of the N TCI states are activated TCI states corresponding to the uplink transmission, the N TCI states are configured or indicated by the network device, N is a positive integer, and K1 is less than or equal to N (K1≤N).

In some embodiments, the K1 TCI states are indicated by the network device through fifth indication information.

In some embodiments, the fifth indication information is used to indicate that the K1 TCI states are K1 TCI states sequentially selected from the N TCI states according to a first order.

In some embodiments, the first order is an ascending order of TCI state identities, or the first order is a descending order of TCI state identities.

In some embodiments, the fifth indication information is used to indicate that the K1 TCI states are K1 TCI states sequentially selected according to a position order of the N TCI states in second indication information;
where the second indication information is indication information used at least to indicate or activate TCI states transmitted by the network device, and the TCI states indicated or activated by the second indication information include at least the K1 TCI states.

In some embodiments, the position order of the N TCI states in the second indication information is a front-to-back order, or the position order of the N TCI states in the second indication information is a back-to-front order.

In some embodiments, the fifth indication information is carried by one of the following: radio resource control (RRC) signaling, media access control layer control element (MAC CE) signaling, and downlink control information (DCI) signaling.

In some embodiments, the N TCI states are indicated by the network device through sixth indication information; or
the N TCI states are indicated by the network device through second indication information; or
the N TCI states are determined based on the second indication information from the TCI states indicated by the network device through the sixth indication information;
where the second indication information is indication information used at least to indicate or activate TCI states transmitted by the network device, and the TCI states indicated or activated by the second indication information include at least the N TCI states.

In some embodiments, the sixth indication information is carried by one of the following: RRC signaling, MAC CE signaling, and DCI signaling.

In some embodiments, the second indication information is carried by first MAC CE signaling;
where the first MAC CE signaling further includes at least one of the following: serving cell indication information, downlink bandwidth part (BWP) indication information, uplink BWP indication information, one or more TCI number indication fields, one or more TCI type indication fields, or one or more TCI state indication fields.

In some embodiments, the terminal device 300 further includes a processing unit 320;
the communication unit 310 is further configured to receive first DCI, where the first DCI is used to schedule a first PUSCH; and
the processing unit 320 is used to determine the uplink transmit spatial filter or spatial relation corresponding to the first PUSCH according to the first information; or used to determine the uplink transmit spatial filter or spatial relation corresponding to the first PUSCH and transmission of the first PUSCH according to the first information;
where the first information is at least one of the following: a first TCI state among the K1 TCI states, a second TCI state among the K1 TCI states, the first SRS resource set, or the second SRS resource set;
in a case where K1 is greater than 1 (K1>1), the first SRS resource set is associated with the first TCI state, and the second SRS resource set is associated with the second TCI state; and
in a case where K1 is equal to 1 (K1=1) and the K1 TCI states only include the first TCI state, the first SRS resource set and the second SRS resource set are both associated with the first TCI state; or the first SRS resource set is associated with the first TCI state, and the second SRS resource set is not associated with any TCI state.

In some embodiments, in the case where K1 is greater than 1 (K1>1), the processing unit 320 is specifically configured to:
in a case where the first DCI is DCI format 0_0, determine the uplink transmit spatial filter or spatial relation corresponding to the first PUSCH according to a preset TCI state in the first TCI state and the second TCI state; or
in a case where the first DCI is DCI format 0_0, determine the uplink transmit spatial filter or spatial relation corresponding to the first PUSCH, according to a TCI state indicated by a network device from the first TCI state and the second TCI state.

In some embodiments, in a case where K1 is greater than 1 (K1>1), the processing unit 320 is specifically configured to:
in a case where the first DCI is DCI format 0_1 or DCI format 0_2, determine, the uplink transmit spatial filter or spatial relation corresponding to the first PUSCH and the transmission of the first PUSCH, according to the first TCI state, the first SRS resource set, the second TCI state and the second SRS resource set.

In some embodiments, in a case where K1 is equal to 1 (K1=1), the processing unit 320 is specifically configured to:
determine the uplink transmit spatial filter or spatial relation corresponding to the first PUSCH and the transmission of the first PUSCH, according to the first SRS resource set and the first TCI state; or
determine the uplink transmit spatial filter or spatial relation corresponding to the first PUSCH and the transmission of the first PUSCH, according to the second SRS resource set and the first TCI state.

In some embodiments, the terminal device 300 further includes a processing unit 320;
the processing unit 320 is configured to determine an uplink transmit spatial filter or spatial relation corresponding to a second PUSCH and transmission of the second PUSCH according to second information;
where the second PUSCH is a configured grant (CG) Type1 PUSCH, the second PUSCH corresponds to a first SRS resource and/or a second SRS resource, the first SRS resource is one of the two SRS resources, and the second SRS resource is another of the two SRS resources; and
the second information is at least one of the following: a TCI state associated with the first SRS resource, a TCI state associated with the second SRS resource, the first SRS resource, or the second SRS resource.

In some embodiments, if the second PUSCH corresponds to the first SRS resource and the second SRS resource, the first SRS resource is associated with a first TCI state of the K1 TCI states, and the second SRS resource is associated with a second TCI state of the K1 TCI states; or
if the second PUSCH corresponds to the first SRS resource and the second SRS resource, the first SRS resource belongs to the first SRS resource set, the second SRS resource belongs to the second SRS resource set, the first SRS resource set is associated with the first TCI state of the K1 TCI states, and the second SRS resource set is associated with the second TCI state of the K1 TCI states, then the first SRS resource is associated with the first TCI state, and the second SRS resource is associated with the second TCI state; or
if the second PUSCH corresponds to the first SRS resource and the second SRS resource, the first SRS resource belongs to the second SRS resource set, the second SRS resource belongs to the first SRS resource set, the first SRS resource set is associated with the first TCI state of the K1 TCI states, and the second SRS resource set is associated with the second TCI state of the K1 TCI states, then the first SRS resource is associated with the second TCI state, and the second SRS resource is associated with the first TCI state.

In some embodiments, the processing unit 320 is specifically configured to:
determine the uplink transmit spatial filter or spatial relation corresponding to the second PUSCH and the transmission of the second PUSCH, according to the first TCI state, the first SRS resource, the second TCI state and the second SRS resource.

In some embodiments, if the second PUSCH corresponds to the first SRS resource, the first SRS resource is associated with a first TCI state of the K1 TCI states.

In some embodiments, the processing unit 320 is specifically configured to:
determine the uplink transmit spatial filter or spatial relation corresponding to the second PUSCH and the transmission of the second PUSCH, according to the first TCI state and the first SRS resource.

In some embodiments, in a case where K1 is equal to 1 (K1=1) and the second PUSCH corresponds to the first SRS resource and the second SRS resource, the processing unit 320 is specifically configured to:
determine the uplink transmit spatial filter or spatial relation corresponding to the second PUSCH and the transmission of the second PUSCH, according to the first SRS resource and the K1=1 TCI state; or
determine the uplink transmit spatial filter or spatial relation corresponding to the second PUSCH and the transmission of the second PUSCH, according to the second SRS resource and the K1=1 TCI state.

In some embodiments, the terminal device 300 further includes a processing unit 320;
the communication unit 310 is further configured to receive second DCI, where the second DCI is used to activate a third PUSCH, the third PUSCH is a CG Type2 PUSCH, the third PUSCH corresponds to a third SRS resource and/or a fourth SRS resource, the third SRS resource is one of the two SRS resources, and the fourth SRS resource is another of the two SRS resources; and
the processing unit 320 is configured to determine an uplink transmit spatial filter or spatial relation corresponding to the third PUSCH and transmission of the third PUSCH according to third information;
where the third information is at least one of the following: a TCI state associated with the third SRS resource, a TCI state associated with the fourth SRS resource, the third SRS resource, or the fourth SRS resource.

In some embodiments, the third SRS resource is specified by a first SRS resource indicator field in the second DCI, and/or the fourth SRS resource is specified by a second SRS resource indicator field in the second DCI.

In some embodiments, in a case where the second DCI is DCI format 0_0, the third PUSCH corresponds to the third SRS resource.

In some embodiments, in a case where the second DCI is DCI format 0_1 or DCI format 0_2, and an SRS resource set indicator field in the second DCI indicates a first value, the third PUSCH corresponds to the third SRS resource; or
in a case where the second DCI is DCI format 0_1 or DCI format 0_2, and the SRS resource set indicator field in the second DCI indicates a second value, the third PUSCH corresponds to the fourth SRS resource; or
in a case where the second DCI is DCI format 0_1 or DCI format 0_2, and the SRS resource set indicator field in the second DCI indicates a third value, the third PUSCH corresponds to the third SRS resource and the fourth SRS resource; where the third SRS resource is specified by the first SRS resource indicator field in the second DCI, and the fourth SRS resource is specified by the second SRS resource indicator field in the second DCI; or
in a case where the second DCI is DCI format 0_1 or DCI format 0_2, and the SRS resource set indicator field in the second DCI indicates a fourth value, the third PUSCH corresponds to the third SRS resource and the fourth SRS resource; where the third SRS resource is specified by the second SRS resource indicator field in the second DCI, and the fourth SRS resource is specified by the first SRS resource indicator field in the second DCI.

In some embodiments, in a case where the second DCI is DCI format 0_1 or DCI format 0_2, and an SRS resource set indicator field in the second DCI indicates a first value, the third PUSCH corresponds to the third SRS resource; or
in a case where the second DCI is DCI format 0_1 or DCI format 0_2, and the SRS resource set indicator field in the second DCI indicates a second value, the third PUSCH corresponds to the fourth SRS resource; or
in a case where the second DCI is DCI format 0_1 or DCI format 0_2, and the SRS resource set indicator field in the second DCI indicates a third value, the third PUSCH corresponds to the third SRS resource and the fourth SRS resource; where the third SRS resource is specified by the first SRS resource indicator field in the second DCI, and the fourth SRS resource is specified by the second SRS resource indicator field in the second DCI; or
in a case where the second DCI is DCI format 0_1 or DCI format 0_2, and the SRS resource set indicator field in the second DCI indicates a fourth value, the third PUSCH corresponds to the third SRS resource and the fourth SRS resource; where the third SRS resource is specified by the first SRS resource indicator field in the second DCI, and the fourth SRS resource is specified by the second SRS resource indicator field in the second DCI.

In some embodiments, if the third PUSCH corresponds to the third SRS resource and the fourth SRS resource, the third SRS resource is associated with a first TCI state of the K1 TCI states, and the fourth SRS resource is associated with a second TCI state of the K1 TCI states; or
if the third PUSCH corresponds to the third SRS resource and the fourth SRS resource, the third SRS resource belongs to the first SRS resource set, the fourth SRS resource belongs to the second SRS resource set, the first SRS resource set is associated with the first TCI state of the K1 TCI states, and the second SRS resource set is associated with the second TCI state of the K1 TCI states, then the third SRS resource is associated with the first TCI state, and the fourth SRS resource is associated with the second TCI state; or
if the third PUSCH corresponds to the third SRS resource and the fourth SRS resource, the third SRS resource belongs to the second SRS resource set, the fourth SRS resource belongs to the first SRS resource set, the first SRS resource set is associated with the first TCI state of the K1 TCI states, and the second SRS resource set is associated with the second TCI state of the K1 TCI states, then the third SRS resource is associated with the second TCI state, and the fourth SRS resource is associated with the first TCI state.

In some embodiments, the processing unit 320 is specifically configured to:
determine the uplink transmit spatial filter or spatial relation corresponding to the third PUSCH and the transmission of the third PUSCH, according to the first TCI state, the third SRS resource, the second TCI state and the fourth SRS resource.

In some embodiments, if the third PUSCH corresponds to the third SRS resource, the third SRS resource is associated with the first TCI state of the K1 TCI states.

In some embodiments, the processing unit 320 is specifically configured to:
determine the uplink transmit spatial filter or spatial relation corresponding to the third PUSCH and the transmission of the third PUSCH, according to the first TCI state and the third SRS resource.

In some embodiments, in a case where K1 is equal to 1 (K1>1) and the third PUSCH corresponds to the third SRS resource and the fourth SRS resource, the processing unit 320 is specifically configured to:
determine the uplink transmit spatial filter or spatial relation corresponding to the third PUSCH and the transmission of the third PUSCH, according to the third SRS resource and the K1=1 TCI state; or
determine the uplink transmit spatial filter or spatial relation corresponding to the third PUSCH and the transmission of the third PUSCH, according to the fourth SRS resource and the K1=1 TCI state.

In some embodiments, the communication unit 310 is further used to transmit first terminal capability information;
where the first terminal capability information is used to indicate that the terminal device supports that Z1 unified TCI states are used for uplink transmission or uplink repeated transmission, or the first terminal capability information is used to indicate that the terminal device supports that one codepoint in a transmission configuration indication field activates or indicates at most Z1 unified TCI states for uplink transmission or uplink repeated transmission, or the first terminal capability information is used to indicate that the terminal device supports Z1 unified TCI states for uplink transmission or uplink repeated transmission on a CG PUSCH; and Z1 is a positive integer greater than 1.

In some embodiments, the first terminal capability information is reported according to at least one of the following granularities:
a per band granularity, a per band combination granularity, a per band per band combination granularity, a per carrier per band per band combination granularity, a per frequency range granularity, or a per terminal granularity.

In some embodiments, the first terminal capability information is carried by one of the following: RRC signaling, and MAC CE signaling.

In some embodiments, the communication unit 310 is further used to transmit second terminal capability information;
where the second terminal capability information is used to indicate that the terminal device supports a CG PUSCH.

In some embodiments, the second terminal capability information is reported according to at least one of the following granularities:
a per band granularity, a per band combination granularity, a per band per band combination granularity, a per carrier per band per band combination granularity, a per frequency range granularity, or a per terminal granularity.

In some embodiments, the second terminal capability information is carried by one of the following: RRC signaling, and MAC CE signaling.

In some embodiments, the second terminal capability information and the first terminal capability information are transmitted through the same signaling, or the second terminal capability information and the first terminal capability information are transmitted through different signaling;
where the first terminal capability information is used to indicate that the terminal device supports that Z1 unified TCI states are used for uplink transmission or uplink repeated transmission, or the first terminal capability information is used to indicate that the terminal device supports that one codepoint in a transmission configuration indication field activates or indicates at most Z1 unified TCI states for uplink transmission or uplink repeated transmission, or the first terminal capability information is used to indicate that the terminal device supports Z1 unified TCI states for uplink transmission or uplink repeated transmission on a CG PUSCH; and Z1 is a positive integer greater than 1.

In some embodiments, the communication unit 310 is further used to transmit third terminal capability information;
where the third terminal capability information is used to indicate that the terminal device supports that Z2 unified TCI states are together used for uplink transmission or uplink repeated transmission, or the third terminal capability information is used to indicate that the terminal device supports that one codepoint in a transmission configuration indication field activates or indicates at most Z2 unified TCI states together used for uplink transmission or uplink repeated transmission, or the third terminal capability information is used to indicate that the terminal device supports Z2 unified TCI states together used for uplink transmission or uplink repeated transmission on a CG PUSCH; and Z2 is a positive integer greater than 1.

In some embodiments, the third terminal capability information is reported according to at least one of the following granularities:
a per band granularity, a per band combination granularity, a per band per band combination granularity, a per carrier per band per band combination granularity, a per frequency range granularity, or a per terminal granularity.

In some embodiments, the third terminal capability information is carried by one of the following: RRC signaling, and MAC CE signaling.

In some embodiments, configuration information of the first SRS resource set indicates a followed unified TCI state, and configuration information of the second SRS resource set indicates a followed unified TCI state.

In some embodiments, TCI state(s) in the K1 TCI states are joint TCI state(s), or TCI state(s) in the K1 TCI states are uplink TCI state(s).

In some embodiments, the communication unit may be a communication interface or a transceiver, or an input/output interface of a communication chip or a system on chip. The processing unit mentioned above may be one or more processors.

It should be understood that the terminal device 300 in the embodiments of the present application may correspond to the terminal device in the method embodiments of the present application, and the above mentioned and other operations and/or functions of each unit in the terminal device 300 are respectively for realizing the corresponding processes of the terminal device in the method 200 shown in FIG. 5, which will not be repeated here for the sake of brevity.

FIG. 7 shows a schematic block diagram of a network device 400 according to the embodiments of the present application. As shown in FIG. 7, the network device 400 includes:
a communication unit 410, configured to transmit first indication information, where the first indication information is used to indicate a first sounding reference signal (SRS) resource set and a second SRS resource set, where both the first SRS resource set and the second SRS resource set are used for a codebook based or non-codebook based physical uplink shared channel (PUSCH);
where the first SRS resource set is associated with one of K1 transmission configuration indicator (TCI) state, and/or the second SRS resource set is associated with one of the K1 TCI states, or a portion or all of two SRS resources indicated by the first indication information are associated with the TCI state(s) in the K1 TCI states;
where the K1 TCI states are currently activated TCI states corresponding to uplink transmission, and K1 is a positive integer.

In some embodiments, in a case where the first SRS resource set is associated with one of the K1 TCI states, and/or the second SRS resource set is associated with one of the K1 TCI states, and K1 is greater than 1 (K1>1), the first SRS resource set is associated with a first TCI state of the K1 TCI states, and the second SRS resource set is associated with a second TCI state of the K1 TCI states; and/or
in a case where the first SRS resource set is associated with one of the K1 TCI states, and/or the second SRS resource set is associated with one of the K1 TCI states, and the K1 TCI states only include a first TCI state, the first SRS resource set and the second SRS resource set are associated with the first TCI state, or the first SRS resource set is associated with the first TCI state and the second SRS resource set is not associated with any TCI state.

In some embodiments, in a case where the portion or all of the two SRS resources indicated by the first indication information are associated with TCI state(s) in the K1 TCI states, and K1 is greater than 1 (K1>1), one of the two SRS resources is associated with one TCI state in the K1 TCI states, and another of the two SRS resources is associated with another TCI state in the K1 TCI states; and/or
in a case where the portion or all of the two SRS resources indicated by the first indication information are associated with TCI state(s) in the K1 TCI states, and K1 is equal to 1 (K1=1), the two SRS resources are associated with the first TCI state of the K1 TCI states, or one of the two SRS resources is associated with the one TCI state in the K1 TCI states and another of the two SRS resources is not associated with any TCI state.

In some embodiments, in a case where K1 is greater than 1 (K1>1), the first TCI state is determined based on TCI state identities of the K1 TCI states, and/or the second TCI state is determined based on the TCI state identities of the K1 TCI states.

In some embodiments, the first TCI state is a TCI state with the smallest identity among the K1 TCI states, and/or, the second TCI state is a TCI state with the largest identity among the K1 TCI states; or
the first TCI state is the TCI state with the largest identity among the K1 TCI states, and/or the second TCI state is the TCI state with the smallest identity among the K1 TCI states.

In some embodiments, in a case where K1 is greater than 1 (K1>1), the first TCI state is determined based on position information of the K1 TCI states in second indication information, and/or the second TCI state is determined based on the position information of the K1 TCI states in the second indication information; where
the second information is indication information transmitted by a network device and used at least to indicate or activate TCI states, and the TCI states indicated or activated by the second indication information include at least the K1 TCI states.

In some embodiments, the first TCI state is a TCI state among the K1 TCI states with the most forward position in the second indication information, and/or the second TCI state is a TCI state among the K1 TCI states with the most rearward position in the second indication information; or
the first TCI state is the TCI state among the K1 TCI states with the most rearward position in the second indication information, and/or the second TCI state is the TCI state among the K1 TCI states with the most forward position in the second indication information.

In some embodiments, in a case where K1 is greater than 1 (K1>1), the first TCI state is indicated by a network device through third indication information, and/or the second TCI state is indicated by the network device through fourth indication information.

In some embodiments, the third indication information is used to indicate that the first TCI state is a TCI state with the smallest identity among the K1 TCI states, or the third indication information is used to indicate that the first TCI state is a TCI state with the largest identity among the K1 TCI states, or the third indication information is used to indicate that the first TCI state is a TCI state among the K1 TCI states with the most forward position in second indication information, or the third indication information is used to indicate that the first TCI state is a TCI state among the K1 TCI states with the most rearward position in the second indication information;
where the second indication information is indication information transmitted by the network device and used at least to indicate or activate TCI states, and the TCI states indicated or activated by the second indication information include at least the K1 TCI states.

In some embodiments, the fourth indication information is used to indicate that the second TCI state is a TCI state with the smallest identity among the K1 TCI states, or the fourth indication information is used to indicate that the second TCI state is a TCI state with the largest identity among the K1 TCI states, or the fourth indication information is used to indicate that the second TCI state is a TCI state among the K1 TCI states with the most forward position in second indication information, or the fourth indication information is used to indicate that the second TCI state is a TCI state among the K1 TCI states with the most rearward position in the second indication information;
where the second indication information is indication information transmitted by the network device and used at least to indicate or activate TCI states, and the TCI states indicated or activated by the second indication information include at least the K1 TCI states.

In some embodiments, in a case where the terminal device fails to obtain the third indication information, or in a case where the network device does not configure the third indication information, the first TCI state is a TCI state with the smallest identity among the K1 TCI states; and/or, in a case where the terminal device has obtained the third indication information, or in a case where the network device has configured the third indication information, the first TCI state is a TCI state with the largest identity among the K1 TCI states; or
in a case where the terminal device fails to obtain the third indication information, or in a case where the network device does not configure the third indication information, the first TCI state is the TCI state with the largest identity among the K1 TCI states; and/or in a case where the terminal device has obtained the third indication information, or in a case where the network device has configured the third indication information, the first TCI state is the TCI state with the smallest identity among the K1 TCI states.

In some embodiments, in a case where the terminal device fails to obtain the fourth indication information, or in a case where the network device does not configure the fourth indication information, the second TCI state is a TCI state with the smallest identity among the K1 TCI states; and/or, in a case where the terminal device has obtained the fourth indication information, or in a case where the network device has configured the fourth indication information, the second TCI state is the TCI state with the largest identity among the K1 TCI states; or
in a case where the terminal device fails to obtain the fourth indication information, or in a case where the network device does not configured with the fourth indication information, the second TCI state is the TCI state with the largest identity among the K1 TCI states; and/or in a case where the terminal device has obtained the fourth indication information, or in a case where the network device has configured the fourth indication information, the second TCI state is the TCI state with the smallest identity among the K1 TCI states.

In some embodiments, in a case where the third indication information has a first value, the first TCI state is a TCI state with the smallest identity among the K1 TCI states; and/or, in a case where the third indication information has a second value, the first TCI state is a TCI state with the largest identity among the K1 TCI states; or,
in the case where the third indication information has a first value, the first TCI state is the TCI state with the largest identity among the K1 TCI states; and/or, in the case where the third indication information has the second value, the first TCI state is the TCI state with the smallest identity among the K1 TCI states.

In some embodiments, in a case where the fourth indication information has a first value, the second TCI state is a TCI state with the smallest identity among the K1 TCI states; and/or in a case where the fourth indication information has a second value, the second TCI state is a TCI state with the largest identity among the K1 TCI states; or
in the case where the fourth indication information has the first value, the second TCI state is the TCI state with the largest identity among the K1 TCI states; and/or in the case where the fourth indication information has the second value, the second TCI state is the TCI state with the smallest identity among the K1 TCI states.

In some embodiments, the third indication information is included in configuration information of the first SRS resource set, and/or the fourth indication information is included in configuration information of the second SRS resource set.

In some embodiments, in a case where the configuration information of the first SRS resource set includes the third indication information, the configuration information of the first SRS resource set does not include an SRS following a unified TCI state followUnifiedTCIstateSRS, or the configuration information of the first SRS resource set includes a disabled followUnifiedTCIstateSRS, or the terminal device ignores a followUnifiedTCIstateSRS included in the configuration information of the first SRS resource set; and/or
in a case where the configuration information of the second SRS resource set includes the fourth indication information, the configuration information of the second SRS resource set does not include a followUnifiedTCIstateSRS, or the configuration information of the second SRS resource set includes a disabled followUnifiedTCIstateSRS, or the terminal device ignores a followUnifiedTCIstateSRS included in the configuration information of the second SRS resource set.

In some embodiments, in a case where K1 is greater than 1 (K1>1), an uplink transmit spatial filter or spatial relation corresponding to the first SRS resource set is determined based on the first TCI state, and/or, the uplink transmit spatial filter or spatial relation corresponding to the second SRS resource set is determined based on the second TCI state; and/or
in a case where K1 is greater than 1 (K1>1), an uplink transmit spatial filter or spatial relation corresponding to a PUSCH associated with the first SRS resource set is determined based on the first TCI state and/or the first SRS resource set, and/or an uplink transmit spatial filter or spatial relation corresponding to the PUSCH associated with the second SRS resource set is determined based on the second TCI state and/or the second SRS resource set.

In some embodiments, in a case where K1 is equal to 1 (K1=1), uplink transmit spatial filters or spatial relations respectively corresponding to the first SRS resource set and the second SRS resource set are both determined based on the first TCI state, or an uplink transmit spatial filter or spatial relation corresponding to the first SRS resource set is determined based on the first TCI state and the second SRS resource set is not considered in the current PUSCH transmission; and/or
in the case where K1 is equal to 1 (K1=1), uplink transmit spatial filters or spatial relations respectively corresponding to a PUSCH associated with the first SRS resource set and a PUSCH associated with the second SRS resource set are both determined based on the first TCI state and/or the first SRS resource set, and/or an uplink transmit spatial filter or spatial relation corresponding to the PUSCH associated with the first SRS resource set is determined based on the first TCI state and the first SRS resource set and the second SRS resource set is not considered in the current PUSCH transmission.

In some embodiments, the K1 TCI states belong to N TCI states;
where at least a portion of the N TCI states are activated TCI states corresponding to the uplink transmission, the N TCI states are configured or indicated by a network device, N is a positive integer, and K1 is less than or equal to N (K1≤N).

In some embodiments, the K1 TCI states are indicated by the network device through fifth indication information.

In some embodiments, the fifth indication information is used to indicate that the K1 TCI states are K1 TCI states sequentially selected from the N TCI states according to a first order.

In some embodiments, the first order is an ascending order of TCI state identities, or the first order is a descending order of TCI state identities.

In some embodiments, the fifth indication information is used to indicate that the K1 TCI states are K1 TCI states sequentially selected according to a position order of the N TCI states in second indication information;
where the second indication information is indication information used at least to indicate or activate TCI states transmitted by the network device, and the TCI states indicated or activated by the second indication information include at least the K1 TCI states.

In some embodiments, the position order of the N TCI states in the second indication information is a front-to-back order, or the position order of the N TCI states in the second indication information is a back-to-front order.

In some embodiments, the fifth indication information is carried by one of the following: radio resource control (RRC) signaling, media access control layer control element (MAC CE) signaling, and downlink control information (DCI) signaling.

In some embodiments, the N TCI states are indicated by the network device through sixth indication information; or
the N TCI states are indicated by the network device through second indication information; or
the N TCI states are determined based on the second indication information from the TCI states indicated by the network device through the sixth indication information;
where the second indication information is indication information used at least to indicate or activate TCI states transmitted by the network device, and the TCI states indicated or activated by the second indication information include at least the K1 TCI states.

In some embodiments, the sixth indication information is carried by one of the following: RRC signaling, a MAC CE signaling, and DCI signaling.

In some embodiments, the second indication information is carried by first MAC CE signaling;
where the first MAC CE signaling further includes at least one of the following: serving cell indication information, downlink bandwidth part (BWP) indication information, uplink BWP indication information, one or more TCI number indication fields, one or more TCI type indication fields, or one or more TCI state indication fields.

In some embodiments, the communication unit 410 is further configured to transmit first DCI, where the first DCI is used to schedule a first PUSCH;
where an uplink transmit spatial filter or spatial relation corresponding to the first PUSCH is determined according to first information; or the uplink transmit spatial filter or spatial relation corresponding to the first PUSCH, and transmission of the first PUSCH are determined according to the first information;
the first information is at least one of the following: a first TCI state among the K1 TCI states, a second TCI state among the K1 TCI states, the first SRS resource set, or the second SRS resource set;
in a case where K1 is greater than 1 (K1>1), the first SRS resource set is associated with the first TCI state, and the second SRS resource set is associated with the second TCI state; and
in a case where K1 is equal to 1 (K1=1) and the K1 TCI states only include the first TCI state, the first SRS resource set and the second SRS resource set are both associated with the first TCI state; or the first SRS resource set is associated with the first TCI state, and the second SRS resource set is not associated with any TCI state.

In some embodiments, in a case where K1 is greater than 1 (K1>1) and the first DCI is DCI format 0_0, the uplink transmit spatial filter or spatial relation corresponding to the first PUSCH is determined based on a preset TCI state in the first TCI state and the second TCI state; or
in the case where K1 is greater than 1 (K1>1) and the first DCI is DCI format 0_0, the uplink transmit spatial filter or spatial relation corresponding to the first PUSCH is determined based on the TCI state indicated by the network device from the first TCI state and the second TCI state.

In some embodiments, in a case where K1 is greater than 1 (K1>1) and the first DCI is DCI format 0_1 or DCI format 0_2, the uplink transmit spatial filter or spatial relation corresponding to the first PUSCH and the transmission of the first PUSCH are determined based on the first TCI state, the first SRS resource set, the second TCI state and the second SRS resource set.

In some embodiments, in a case where K1 is equal to 1 (K1=1), the uplink transmit spatial filter or spatial relation corresponding to the first PUSCH and the transmission of the first PUSCH are determined based on the first SRS resource set and the first TCI state; or
in a case where K1 is equal to 1 (K1=1) and the uplink transmit spatial filter or spatial relation corresponding to the first PUSCH and the transmission of the first PUSCH are determined based on the second SRS resource set and the first TCI state.

In some embodiments, an uplink transmit spatial filter or spatial relation corresponding to a second PUSCH and transmission of the second PUSCH are determined based on second information; where
the second PUSCH is a configured grant (CG) Type1 PUSCH, the second PUSCH corresponds to a first SRS resource and/or a second SRS resource, the first SRS resource is one of the two SRS resources, and the second SRS resource is another of the two SRS resources; and
the second information is at least one of the following: a TCI state associated with the first SRS resource, a TCI state associated with the second SRS resource, the first SRS resource, or the second SRS resource.

In some embodiments, if the second PUSCH corresponds to the first SRS resource and the second SRS resource, the first SRS resource is associated with a first TCI state of the K1 TCI states, and the second SRS resource is associated with a second TCI state of the K1 TCI states; or
if the second PUSCH corresponds to the first SRS resource and the second SRS resource, the first SRS resource belongs to the first SRS resource set, the second SRS resource belongs to the second SRS resource set, the first SRS resource set is associated with the first TCI state of the K1 TCI states, and the second SRS resource set is associated with the second TCI state of the K1 TCI states, then the first SRS resource is associated with the first TCI state, and the second SRS resource is associated with the second TCI state; or
if the second PUSCH corresponds to the first SRS resource and the second SRS resource, the first SRS resource belongs to the second SRS resource set, the second SRS resource belongs to the first SRS resource set, the first SRS resource set is associated with the first TCI state of K1 TCI states, and the second SRS resource set is associated with the second TCI state of K1 TCI states, then the first SRS resource is associated with the second TCI state, and the second SRS resource is associated with the first TCI state.

In some embodiments, the uplink transmit spatial filter or spatial relation corresponding to the second PUSCH and the transmission of the second PUSCH are determined based on the first TCI state, the first SRS resource, the second TCI state and the second SRS resource.

In some embodiments, if the second PUSCH corresponds to the first SRS resource, the first SRS resource is associated with a first TCI state of the K1 TCI states.

In some embodiments, the uplink transmit spatial filter or spatial relation corresponding to the second PUSCH and the transmission of the second PUSCH are determined based on the first TCI state and the first SRS resource.

In some embodiments, in a case where K1 is equal to 1 (K1=1) and the second PUSCH corresponds to the first SRS resource and the second SRS resource, the uplink transmit spatial filter or spatial relation corresponding to the second PUSCH and the transmission of the second PUSCH are determined based on the first SRS resource and the K1=1 TCI state; or
in the case where K1 is equal to 1 (K1=1) and the second PUSCH corresponds to the first SRS resource and the second SRS resource, the uplink transmit spatial filter or spatial relation corresponding to the second PUSCH and the transmission of the second PUSCH are determined based on the second SRS resource and the K1=1 TCI state.

In some embodiments, the communication unit 410 is further used to transmit second DCI, and the second DCI is used to activate a third PUSCH. The third PUSCH is a CG Type2 PUSCH, the third PUSCH corresponds to a third SRS resource and/or a fourth SRS resource, the third SRS resource is one of the two SRS resources, and the fourth SRS resource is another of the two SRS resources; where
the uplink transmit spatial filter or spatial relation corresponding to the third PUSCH and the transmission of the third PUSCH are determined based on third information; and
the third information is at least one of the following: a TCI state associated with the third SRS resource, a TCI state associated with the fourth SRS resource, the third SRS resource, or the fourth SRS resource.

In some embodiments, the third SRS resource is specified by a first SRS resource indicator field in the second DCI, and/or the fourth SRS resource is specified by a second SRS resource indicator field in the second DCI.

In some embodiments, in a case where the second DCI is DCI format 0_0, the third PUSCH corresponds to the third SRS resource.

In some embodiments, in a case where the second DCI is DCI format 0_1 or DCI format 0_2, and an SRS resource set indicator field in the second DCI indicates a first value, the third PUSCH corresponds to the third SRS resource; or
in a case where the second DCI is DCI format 0_1 or DCI format 0_2, and the SRS resource set indicator field in the second DCI indicates a second value, the third PUSCH corresponds to the fourth SRS resource; or
in a case where the second DCI is DCI format 0_1 or DCI format 0_2, and the SRS resource set indicator field in the second DCI indicates a third value, the third PUSCH corresponds to the third SRS resource and the fourth SRS resource, where the third SRS resource is specified by the first SRS resource indicator field in the second DCI, and the fourth SRS resource is specified by the second SRS resource indicator field in the second DCI; or
in a case where the second DCI is DCI format 0_1 or DCI format 0_2, and the SRS resource set indicator field in the second DCI indicates a fourth value, the third PUSCH corresponds to the third SRS resource and the fourth SRS resource; where the third SRS resource is specified by the second SRS resource indicator field in the second DCI, and the fourth SRS resource is specified by the first SRS resource indicator field in the second DCI.

In some embodiments, in a case where the second DCI is DCI format 0_1 or DCI format 0_2, and an SRS resource set indicator field in the second DCI indicates a first value, the third PUSCH corresponds to the third SRS resource; or
in a case where the second DCI is DCI format 0_1 or DCI format 0_2, and the SRS resource set indicator field in the second DCI indicates a second value, the third PUSCH corresponds to the fourth SRS resource; or
in a case where the second DCI is DCI format 0_1 or DCI format 0_2, and the SRS resource set indicator field in the second DCI indicates a third value, the third PUSCH corresponds to the third SRS resource and the fourth SRS resource; where the third SRS resource is specified by the first SRS resource indicator field in the second DCI, and the fourth SRS resource is specified by the second SRS resource indicator field in the second DCI; or
in a case where the second DCI is DCI format 0_1 or DCI format 0_2, and the SRS resource set indicator field in the second DCI indicates a fourth value, the third PUSCH corresponds to the third SRS resource and the fourth SRS resource; where the third SRS resource is specified by the first SRS resource indicator field in the second DCI, and the fourth SRS resource is specified by the second SRS resource indicator field in the second DCI.

In some embodiments, if the third PUSCH corresponds to the third SRS resource and the fourth SRS resource, the third SRS resource is associated with a first TCI state of the K1 TCI states, and the fourth SRS resource is associated with a second TCI state of the K1 TCI states; or
if the third PUSCH corresponds to the third SRS resource and the fourth SRS resource, the third SRS resource belongs to the first SRS resource set, the fourth SRS resource belongs to the second SRS resource set, the first SRS resource set is associated with the first TCI state of the K1 TCI states, and the second SRS resource set is associated with the second TCI state of the K1 TCI states, then the third SRS resource is associated with the first TCI state, and the fourth SRS resource is associated with the second TCI state; or
if the third PUSCH corresponds to the third SRS resource and the fourth SRS resource, the third SRS resource belongs to the second SRS resource set, the fourth SRS resource belongs to the first SRS resource set, the first SRS resource set is associated with the first TCI state of the K1 TCI states, and the second SRS resource set is associated with the second TCI state of the K1 TCI states, then the third SRS resource is associated with the second TCI state, and the fourth SRS resource is associated with the first TCI state.

In some embodiments, the uplink transmit spatial filter or spatial relation corresponding to the third PUSCH and the transmission of the third PUSCH are determined based on the first TCI state, the third SRS resource, the second TCI state and the fourth SRS resource.

In some embodiments, if the third PUSCH corresponds to the third SRS resource, the third SRS resource is associated with the first TCI state of the K1 TCI states.

In some embodiments, the uplink transmit spatial filter or spatial relation corresponding to the third PUSCH and the transmission of the third PUSCH are determined based on the first TCI state and the third SRS resource.

In some embodiments, in a case where K1 is equal to 1 (K1=1) and the third PUSCH corresponds to the third SRS resource and the fourth SRS resource, the uplink transmit spatial filter or spatial relation corresponding to the third PUSCH and the transmission of the third PUSCH are determined based on the third SRS resource and the K1=1 TCI state; or
in the case where K1 is equal to 1 (K1=1) and the third PUSCH corresponds to the third SRS resource and the fourth SRS resource, the uplink transmit spatial filter or spatial relation corresponding to the third PUSCH and the transmission of the third PUSCH are determined based on the fourth SRS resource and the K1=1 TCI state.

In some embodiments, the communication unit 410 is further configured to receive first terminal capability information;
where the first terminal capability information is used to indicate that the terminal device supports that Z1 unified TCI states are used for uplink transmission or uplink repeated transmission, or the first terminal capability information is used to indicate that the terminal device supports that one codepoint in the transmission configuration indication field activates or indicates at most Z1 unified TCI states for uplink transmission or uplink repeated transmission, or the first terminal capability information is used to indicate that the terminal device supports Z1 unified TCI states for uplink transmission or uplink repeated transmission on a CG PUSCH; and Z1 is a positive integer greater than 1.

In some embodiments, the first terminal capability information is reported according to at least one of the following granularities:
a per band granularity, a per band combination granularity, a per band per band combination granularity, a per carrier per band per band combination granularity, a per frequency range granularity, or a per terminal granularity.

In some embodiments, the first terminal capability information is carried by one of the following: RRC signaling, and MAC CE signaling.

In some embodiments, the communication unit 410 is further configured to receive second terminal capability information;
where the second terminal capability information is used to indicate that the terminal device supports a CG PUSCH.

In some embodiments, the second terminal capability information is reported according to at least one of the following granularities:
a per band granularity, a per band combination granularity, a per band per band combination granularity, a per carrier per band per band combination granularity, a per frequency range granularity, or a per terminal granularity.

In some embodiments, the second terminal capability information is carried by one of the following: RRC signaling, and MAC CE signaling.

In some embodiments, the second terminal capability information and first terminal capability information are transmitted through the same signaling, or the second terminal capability information and the first terminal capability information are transmitted through different signaling;
where the first terminal capability information is used to indicate that the terminal device supports that Z1 unified TCI states are used for uplink transmission or uplink repeated transmission, or the first terminal capability information is used to indicate that the terminal device supports that one codepoint in a transmission configuration indication field activates or indicates at most Z1 unified TCI states for uplink transmission or uplink repeated transmission, or the first terminal capability information is used to indicate that the terminal device supports Z1 unified TCI states for uplink transmission or uplink repeated transmission on a CG PUSCH; and Z1 is a positive integer greater than 1.

In some embodiments, the communication unit 410 is further configured to receive third terminal capability information;
where the third terminal capability information is used to indicate that the terminal device supports that Z2 unified TCI states are together used for uplink transmission or uplink repeated transmission, or the third terminal capability information is used to indicate that the terminal device supports that one codepoint in the transmission configuration indication field activates or indicates at most Z2 unified TCI states together used for uplink transmission or uplink repeated transmission, or the third terminal capability information is used to indicate that the terminal device supports Z2 unified TCI states together used for uplink transmission or uplink repeated transmission on a CG PUSCH; and Z2 is a positive integer greater than 1.

In some embodiments, the third terminal capability information is reported according to at least one of the following granularities:
a per band granularity, a per band combination granularity, a per band per band combination granularity, a per carrier per band per band combination granularity, a per frequency range granularity, or a per terminal granularity.

In some embodiments, the third terminal capability information is carried by one of the following: an RRC signaling, and MAC CE signaling.

In some embodiments, configuration information of the first SRS resource set indicates a followed unified TCI state, and configuration information of the second SRS resource set indicates a followed unified TCI state.

In some embodiments, the TCI state(s) in the K1 TCI states are joint TCI state(s), or TCI state(s) in the K1 TCI states are uplink TCI state(s).

In some embodiments, the communication unit may be a communication interface or a transceiver, or an input/output interface of a communication chip or a system on chip. The processing unit mentioned above may be one or more processors.

It should be understood that the network device 400 in the embodiments of the present application may correspond to the network device in the embodiments of the method of the present application, and the above mentioned and other operations and/or functions of each unit in the network device 400 are respectively for realizing the corresponding processes of the network device in the method 200 shown in FIG. 5, which will not be repeated here for the sake of brevity.

FIG. 8 is a schematic structural diagram of a communication device 500 provided in the embodiments of the present application. The communication device 500 shown in FIG. 8 includes a processor 510, which may call a computer program from a memory, and run the computer program, to implement the methods in the embodiments of the present application.

In some embodiments, as shown in FIG. 8, the communication device 500 may further include a memory 520. The processor 510 may call a computer from the memory 520, and run the computer program, to implement the methods in the embodiments of the present application.

The memory 520 may be a separate device independent of the processor 510, or may be integrated into the processor 510.

In some embodiments, as shown in FIG. 8, the communication device 500 may further include a transceiver 530, and the processor 510 may control the transceiver 530 to communicate with other devices, specifically, to transmit information or data to other devices, or to receive information or data transmitted by other devices.

The transceiver 530 may include a transmitter and a receiver. The transceiver 530 may further include antenna(s), and the number of the antenna(s) may be one or more.

In some embodiments, the processor 510 may implement the function of a processing unit in a terminal device, or the processor 510 may implement the function of a processing unit in a network device, which will not be described in detail herein for the sake of brevity.

In some embodiments, the transceiver 530 may implement the function of a communication unit in a terminal device, which will not be described in detail herein for the sake of brevity.

In some embodiments, the transceiver 530 may implement the function of a communication unit in a network device, which will not be described in detail herein for the sake of brevity.

In some embodiments, the communication device 500 may specifically be the network device in the embodiments of the present application, and the communication device 500 may implement the corresponding processes implemented by the network device in each method in the embodiments of the present application, which will not be described in detail herein for the sake of brevity.

In some embodiments, the communication device 500 may specifically be the terminal device in the embodiments of the present application, and the communication device 500 may implement the corresponding processes implemented by the terminal device in each method in the embodiments of the present application, which will not be described in detail herein for the sake of brevity.

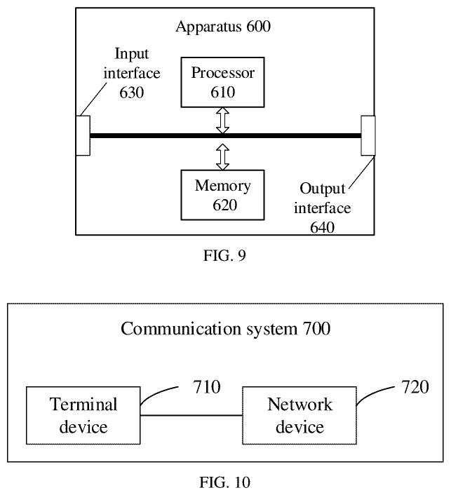

FIG. 9 is a schematic structural diagram of an apparatus according to the embodiments of the present application. The apparatus 600 shown in FIG. 9 includes a processor 610, which may call a computer program from a memory and run the computer program, to implement the methods in the embodiments of the present application.

In some embodiments, as shown in FIG. 9, the apparatus 600 may further include a memory 620. The processor 610 may call a computer program from the memory 620 and run the computer program, to implement the methods in the embodiments of the present application.

The memory 620 may be a separate device independent of the processor 610, or may be integrated into the processor 610.

In some embodiments, the apparatus 600 may further include an input interface 630.

The processor 610 may control the input interface 630 to communicate with other devices or chips, and specifically, may control the input interface 630 to obtain information or data transmitted by other devices or chips. Optionally, the processor 610 may be disposed on a chip or off a chip.

In some embodiments, the processor 610 may implement the function of a processing unit in a terminal device, or the processor 610 may implement the function of a processing unit in a network device, which will not be described in detail herein for the sake of brevity.

In some embodiments, the input interface 630 may implement the function of a communication unit in a terminal device, or the input interface 630 may implement the function of a communication unit in a network device.

In some embodiments, the apparatus 600 may further include an output interface 640. The processor 610 may control the output interface 640 to communicate with other devices or chips, and specifically, control the output interface 640 to output information or data to other devices or chips. Optionally, the processor 610 may be disposed on a chip or off a chip.

In some embodiments, the output interface 640 may implement the function of a communication unit in a terminal device, or the output interface 640 may implement the function of a communication unit in a network device.

In some embodiments, the apparatus may be applied to the network device in the embodiments of the present application, and the apparatus may implement the corresponding processes implemented by the network device in the various methods in the embodiments of the present application, which will not be described in detail herein for the sake of brevity.

In some embodiments, the apparatus may be applied to the terminal device in the embodiments of the present application, and the apparatus may implement the corresponding processes implemented by the terminal device in various methods in the embodiments of the present application, which will not be described in detail herein for the sake of brevity.

In some embodiments, the apparatus mentioned in the embodiments of the present application may be a chip. For example, it may be a system-level chip, a system chip, a chip system, or a system-on-chip chip, or the like.

FIG. 10 is a schematic block diagram of a communication system 700 provided in the embodiments of the present application. As shown in FIG. 10, the communication system 700 includes a terminal device 710 and a network device 720.

The terminal device 710 may be used to implement the corresponding functions implemented by the terminal device in the above methods, and the network device 720 may be used to implement the corresponding functions implemented by the network device in the above methods, which will not be described in detail herein for the sake of brevity.

It should be understood that the processor of the embodiments of the present application may be an integrated circuit chip with signal processing capabilities. In the implementation process, each step of the above method embodiment may be completed by an integrated logic circuit of hardware in a processor or an instruction in software form. The above mentioned processor can be a general-purpose processor, a digital signal processor (DSP), an application-specific integrated circuit (ASIC), a field programmable gate array (FPGA) or other programmable logic devices, discrete gate or transistor logic devices, and discrete hardware components. The various methods, steps and logic diagrams disclosed in the embodiments of the present application can be implemented or executed. A general purpose processor may be a microprocessor, or the processor may be any conventional processor or the like. The steps of the method disclosed in the embodiments of the present application may be directly implemented as being executed by a hardware decoding processor, or may be implemented by a combination of hardware and software modules in the decoding processor. The software module may be located in a random access memory, a flash memory, a read-only memory, a programmable read-only memory, or an electrically erasable programmable memory, a register, or other mature storage media in the art. The storage medium is located in the memory, and the processor reads the information in the memory and completes the steps of the above method in combination with its hardware.

It can be understood that the memory in the embodiments of the present application may be a volatile (transitory) memory or a non-volatile (non-transitory) memory, or may include both volatile and non-volatile memories. The non-volatile memory may be a read-only memory (ROM), a programmable ROM (PROM), an erasable programmable read-only memory (EPROM), an electrically erasable programmable read-only memory (EEPROM), or a flash memory. The volatile memory may be a random access memory (RAM), which acts as external cache memory. By way of example and not limitation, many forms of RAM are available, such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synchronous link dynamic random access memory (SLDRAM), and direct memory bus random access memory (DR RAM). It should be noted that memory of the systems and methods described herein is intended to comprise, without being limited to, these and any other suitable types of memory.

It should be understood that the above memory is exemplary but not limited illustration. For example, the memory in the embodiments of the present application may also be a static random access memory (SRAM), a dynamic random access memory (DRAM), a synchronous dynamic random access memory (SDRAM)), a double data rate synchronous dynamic random access memory (DDR SDRAM), an enhanced synchronous dynamic random access memory (ESDRAM), a synchronous link dynamic random access memory (SLDRAM), a direct Rambus random access memory (DR RAM), etc. That is, the memory in the embodiments of the present application is intended to include, but not limited to, these and any other suitable types of memories.

The embodiments of the present application further provide a non-transitory computer-readable storage medium configured to store a computer program.

In some embodiments, the non-transitory computer-readable storage medium may be applied to the network device in the embodiments of the present application, and the computer program causes a computer to execute the corresponding processes implemented by the network device in the various methods in the embodiments of the present application, which will not be described in detail herein for the sake of brevity.

In some embodiments, the non-transitory computer-readable storage medium may be applied to the terminal device in the embodiments of the present application, and the computer program causes a computer to execute the corresponding processes implemented by the terminal device in the various methods in the embodiments of the present application, which will not be described in detail herein for the sake of brevity.

The embodiments of the present application further provide a computer program product including computer program instructions.

In some embodiments, the computer program product may be applied to the network device in the embodiments of the present application, and the computer program instructions cause the computer to execute the corresponding processes implemented by the network device in the various methods in the embodiments of the present application, which will not be described in detail herein for the sake of brevity.

In some embodiments, the computer program product may be applied to the terminal device in the embodiments of the present application, and the computer program instructions cause the computer to execute the corresponding processes implemented by the terminal device in the various methods in the embodiments of the present application, which will not be described in detail herein for the sake of brevity.

The embodiments of the present application further provide a computer program.

In some embodiments, the computer program may be applied to the network device in the embodiments of the present application. When the computer program is executed on a computer, the computer program causes the computer to execute the corresponding processes implemented by the network device in the various methods in the embodiments of the present application, which will not be described in detail herein for the sake of brevity.

In some embodiments, the computer program may be applied to the terminal device in the embodiments of the present application. When the computer program runs on the computer, the computer program causes the computer to execute the corresponding processes implemented by the terminal device in the various methods in the embodiments of the present application, which will not be described in detail herein for the sake of brevity.

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the specific application and design constraints of the technical solution. Professional technicians may use different methods to implement the described functions for each specific application, but such implementation should not be considered to be beyond the scope of this application.

Those skilled in the art may clearly understand that for the convenience and brevity of the description, the specific operating processes of the system, apparatus and unit described above may refer to the corresponding procedures in the embodiments of the method above, and will not be repeated here.

In several embodiments provided in this application, it should be understood that the disclosed systems, devices and methods may be implemented in other ways. For example, the device embodiments described above are merely illustrative. For example, the division of the units is merely a logical function division. There may be other division methods in actual implementation. For example, multiple units or components may be combined or integrated into another system, or some features may be ignored or not executed. Another point is that the mutual coupling or direct coupling or communication connection shown or discussed may be an indirect coupling or communication connection through some interface, device or unit, which may be electrical, mechanical or other forms.

The units described as separate components may or may not be physically separated, and the components shown as units may or may not be physical units, that is, they may be located in one place or distributed over multiple network units. a portion or all of the units may be selected according to actual needs to achieve the purpose of the solution in this embodiment.

In addition, each functional unit in each embodiment of the present application may be integrated into one processing unit, or each unit may exist physically separately, or two or more units may be integrated into one unit.

If the functions are implemented in the form of software functional units and sold or used as independent products, they may be stored in a non-transitory computer-readable storage medium. Based on such an understanding, the technical solution of the present application may essentially be embodied in the form of a software product, or the part that contributes to the prior art, or the part of the technical solution. The computer software product is stored in a storage medium and includes a number of instructions for enabling a computer device (which may be a personal computer, a server, or a network device, or the like.) to execute all or a portion of the steps of the method described in each embodiment of the present application. The aforementioned storage media include: U disk, mobile hard disk, read-only memory (ROM), random access memory (RAM), disk or optical disk and other media that may store program code.

The foregoing descriptions are merely specific implementations of the present application, but the protection scope of the present application is not limited thereto. Any skilled person in the art could readily conceive of changes or replacements within the technical scope of the present application, which shall be all included in the protection scope of the present application. Therefore, the protection scope of the present application shall be subject to the protection scope of claims.

What is claimed is:

1. A wireless communication method, applied to a terminal device and comprising:
receiving first indication information, wherein the first indication information is used to indicate a first sounding reference signal (SRS) resource set and a second SRS resource set, wherein both the first SRS resource set and the second SRS resource set are used for a codebook based or non-codebook based physical uplink shared channel (PUSCH);
wherein the first SRS resource set is associated with one of K1 transmission configuration indicator (TCI) states, and the second SRS resource set is associated with one of the K1 TCI states; wherein the K1 TCI states are currently activated TCI states corresponding to uplink transmission, and K1 is a positive integer;
in a case where K1 is greater than 1, the first SRS resource set is associated with a first TCI state of the K1 TCI states, and the second SRS resource set is associated with a second TCI state of the K1 TCI states; and/or
in a case where the K1 TCI states only include a first TCI state, the first SRS resource set and the second SRS resource set are associated with the first TCI state.

2. The method according to claim 1, wherein
in a case where K1 is greater than 1, the first TCI state is determined based on position information of the K1 TCI states in second indication information, and/or the second TCI state is determined based on the position information of the K1 TCI states in the second indication information; wherein
the second information is indication information transmitted by a network device and used at least to indicate or activate TCI states, and TCI states indicated or activated by the second indication information include at least the K1 TCI states.

3. The method according to claim 2, wherein
the first TCI state is a TCI state among the K1 TCI states with a most forward position in the second indication information, and/or the second TCI state is a TCI state among the K1 TCI states with a most rearward position in the second indication information; or
the first TCI state is the TCI state among the K1 TCI states with the most rearward position in the second indication information, and/or the second TCI state is the TCI state among the K1 TCI states with the most forward position in the second indication information.

4. The method according to claim 1, wherein
in a case where K1 is greater than 1, an uplink transmit spatial filter or a spatial relation corresponding to the first SRS resource set is determined based on the first TCI state, and/or an uplink transmit spatial filter or spatial relation corresponding to the second SRS resource set is determined based on the second TCI state; and/or
in the case where K1 is greater than 1, an uplink transmit spatial filter or a spatial relation corresponding to a PUSCH associated with the first SRS resource set is determined based on the first TCI state and/or the first SRS resource set, and/or an uplink transmit spatial filter or spatial relation corresponding to a PUSCH associated with the second SRS resource set is determined based on the second TCI state and/or the second SRS resource set.

5. The method according to claim 2, wherein
the second indication information is carried by first MAC CE signaling;
wherein the first MAC CE signaling further includes at least one of the following: serving cell indication information, downlink bandwidth part (BWP) indication information, uplink BWP indication information, one or more TCI number indication fields, one or more TCI type indication fields, or one or more TCI state indication fields.

6. The method according to claim 1, further comprising:
receiving first DCI, wherein the first DCI is used to schedule a first PUSCH; and
determining, according to first information, an uplink transmit spatial filter or a spatial relation corresponding to the first PUSCH; or determining, according to the first information, the uplink transmit spatial filter or the spatial relation corresponding to the first PUSCH and transmission of the first PUSCH; wherein
the first information is at least one of the following: a first TCI state among the K1 TCI states, a second TCI state among the K1 TCI states, the first SRS resource set, or the second SRS resource set;
in a case where K1 is greater than 1, the first SRS resource set is associated with the first TCI state, and the second SRS resource set is associated with the second TCI state; and
in a case where K1 is equal to 1 and the K1 TCI states only include the first TCI state, the first SRS resource set and the second SRS resource set are both associated with the first TCI state; or the first SRS resource set is associated with the first TCI state, and the second SRS resource set is not associated with any TCI state.

7. The method according to claim 6, wherein determining, according to the first information, the uplink transmit spatial filter or spatial relation corresponding to the first PUSCH in the case where K1 is greater than 1 comprises:
in a case where the first DCI is DCI format 0_0, determining, according to a preset TCI state in the first TCI state and the second TCI state, the uplink transmit spatial filter or spatial relation corresponding to the first PUSCH; or
in the case where the first DCI is DCI format 0_0, determining, according to a TCI state indicated by a network device from the first TCI state and the second TCI state, the uplink transmit spatial filter or spatial relation corresponding to the first PUSCH.

8. The method according to claim 6, wherein determining, according to the first information, the uplink transmit spatial filter or spatial relation corresponding to the first PUSCH and the transmission of the first PUSCH in a case where K1 is greater than 1 comprises:
in a case where the first DCI is DCI format 0_1 or DCI format 0_2, determining, according to the first TCI state, the first SRS resource set, the second TCI state and the second SRS resource set, the uplink transmit spatial filter or spatial relation corresponding to the first PUSCH and the transmission of the first PUSCH.

9. The method according to claim 1, further comprising:
determining, according to second information, an uplink transmit spatial filter or a spatial relation corresponding to a second PUSCH and transmission of the second PUSCH; wherein
the second PUSCH is a configured grant (CG) Type1 PUSCH, the second PUSCH corresponds to a first SRS resource and/or a second SRS resource, the first SRS resource is one of the two SRS resources, and the second SRS resource is another of the two SRS resources; and
the second information is at least one of the following: a TCI state associated with the first SRS resource, a TCI state associated with the second SRS resource, the first SRS resource, or the second SRS resource.

10. The method according to claim 9, wherein
if the second PUSCH corresponds to the first SRS resource and the second SRS resource, the first SRS resource is associated with a first TCI state of the K1 TCI states, and the second SRS resource is associated with a second TCI state of the K1 TCI states; or
if the second PUSCH corresponds to the first SRS resource and the second SRS resource, the first SRS resource belongs to the first SRS resource set, the second SRS resource belongs to the second SRS resource set, the first SRS resource set is associated with a first TCI state of the K1 TCI states, and the second SRS resource set is associated with a second TCI state of the K1 TCI states, then the first SRS resource is associated with the first TCI state, and the second SRS resource is associated with the second TCI state; or
if the second PUSCH corresponds to the first SRS resource and the second SRS resource, the first SRS resource belongs to the second SRS resource set, the second SRS resource belongs to the first SRS resource set, the first SRS resource set is associated with a first TCI state of the K1 TCI states, and the second SRS resource set is associated with a second TCI state of the K1 TCI states, then the first SRS resource is associated with the second TCI state, and the second SRS resource is associated with the first TCI state.

11. The method according to claim 10, wherein determining, according to the second information, the uplink transmit spatial filter or spatial relation corresponding to the second PUSCH and the transmission of the second PUSCH comprises:
determining, according to the first TCI state, the first SRS resource, the second TCI state and the second SRS resource, the uplink transmit spatial filter or spatial relation corresponding to the second PUSCH and the transmission of the second PUSCH.

12. The method according to claim 1, further comprising:
transmitting first terminal capability information;
wherein the first terminal capability information is used to indicate that the terminal device supports that Z1 unified TCI states are used for uplink transmission or uplink repeated transmission, or the first terminal capability information is used to indicate that the terminal device supports that one codepoint in a transmission configuration indication field activates or indicates at most Z1 unified TCI states for uplink transmission or uplink repeated transmission, or the first terminal capability information is used to indicate that the terminal device supports Z1 unified TCI states for uplink transmission or uplink repeated transmission on a CG PUSCH; and Z1 is a positive integer greater than 1.

13. The method according to claim 12, wherein
the first terminal capability information is reported according to at least one of the following granularities:
a per band granularity, a per band combination granularity, a per band per band combination granularity, a per carrier per band per band combination granularity, a per frequency range granularity, or a per terminal granularity.

14. The method according to claim 12, wherein
the first terminal capability information is carried by one of the following: RRC signaling, and MAC CE signaling.

15. A wireless communication method, applied to a network device, and comprising:
transmitting first indication information, wherein the first indication information is used to indicate a first sounding reference signal (SRS) resource set and a second SRS resource set, wherein both the first SRS resource set and the second SRS resource set are used for a codebook based or non-codebook based physical uplink shared channel (PUSCH);
wherein the first SRS resource set is associated with one of K1 transmission configuration indicator (TCI) states, and the second SRS resource set is associated with one of the K1 TCI states; wherein the K1 TCI states are currently activated TCI states corresponding to uplink transmission, and K1 is a positive integer;
in a case where K1 is greater than 1, the first SRS resource set is associated with a first TCI state of the K1 TCI states, and the second SRS resource set is associated with a second TCI state of the K1 TCI states; and/or
in a case where the K1 TCI states only include a first TCI state, the first SRS resource set and the second SRS resource set are associated with the first TCI state.

16. The method according to claim 15, wherein
in a case where K1 is greater than 1, the first TCI state is determined based on position information of the K1 TCI states in second indication information, and/or the second TCI state is determined based on the position information of the K1 TCI states in the second indication information; wherein
the second information is indication information transmitted by a network device and used at least to indicate or activate TCI states, and the TCI states indicated or activated by the second indication information include at least the K1 TCI states.

17. The method according to claim 16, wherein
the first TCI state is a TCI state among the K1 TCI states with a most forward position in the second indication information, and/or the second TCI state is a TCI state among the K1 TCI states with a most rearward position in the second indication information; or
the first TCI state is the TCI state among the K1 TCI states with the most rearward position in the second indication information, and/or the second TCI state is the TCI state among the K1 TCI states with the most forward position in the second indication information.

18. The method according to claim 15, wherein
in a case where K1 is greater than 1, an uplink transmit spatial filter or a spatial relation corresponding to the first SRS resource set is determined based on the first TCI state, and/or an uplink transmit spatial filter or a spatial relation corresponding to the second SRS resource set is determined based on the second TCI state; and/or
in the case where K1 is greater than 1, an uplink transmit spatial filter or a spatial relation corresponding to a PUSCH associated with the first SRS resource set is determined based on the first TCI state and/or the first SRS resource set, and/or an uplink transmit spatial filter or a spatial relation corresponding to a PUSCH associated with the second SRS resource set is determined based on the second TCI state and/or the second SRS resource set.

19. The method according to claim 16, wherein
the second indication information is carried by first MAC CE signaling;
wherein the first MAC CE signaling further includes at least one of the following: serving cell indication information, downlink bandwidth part (BWP) indication information, uplink BWP indication information, one or more TCI number indication fields, one or more TCI type indication fields, or one or more TCI state indication fields.

20. A terminal device, comprising: a processor and a memory, wherein the memory is configured to store a computer program, and the processor is configured to call and run the computer program stored in the memory, to cause the terminal device to perform:
receiving first indication information, wherein the first indication information is used to indicate a first sounding reference signal (SRS) resource set and a second SRS resource set, wherein both the first SRS resource set and the second SRS resource set are used for a codebook based or non-codebook based physical uplink shared channel (PUSCH);
wherein the first SRS resource set is associated with one of K1 transmission configuration indicator (TCI) states, and the second SRS resource set is associated with one of the K1 TCI states; wherein the K1 TCI states are currently activated TCI states corresponding to uplink transmission, and K1 is a positive integer;
in a case where K1 is greater than 1, the first SRS resource set is associated with a first TCI state of the K1 TCI states, and the second SRS resource set is associated with a second TCI state of the K1 TCI states; and/or
in a case where the K1 TCI states only include a first TCI state, the first SRS resource set and the second SRS resource set are associated with the first TCI state.
